(19) United States
(12) Patent Application Publication
(10) Pub. No.: US 2004/0120404 A1
(43) Pub. Date: Jun. 24, 2004

(54) Variable length data encoding method, variable length data encoding apparatus, variable length encoded data decoding method, and variable length encoded data decoding apparatus

(76) Inventors: Takayuki Sugahara, Yokosuka-shi (JP); Masayoshi Nishitani, Yokosuka-shi (JP); Wataru Inoha, Yokosuka-shi (JP)

Correspondence Address: NATH & ASSOCIATES PLLC, Sixth Floor, 1030 15th Street, N.W., Washington, DC, 20005, US

(21) Appl. No.: 10/720,542

(22) Filed: Nov. 25, 2003

(30) Foreign Application Priority Data
Nov. 27, 2002 (JP) P2002-344079

(51) Int. Cl. H04N 7/12

(52) U.S. Cl. 375/240.23; 375/240.01

(57) ABSTRACT

A predetermined code word is allocated to each of data values in the number of time series data obtained by orthogonal transform of a supplied picture signal or audio signal, and a variable length coding table is obtained. From among the code words written in the variable length coding table, code words to which the same number of time series data are allocated and differ from each other are exchanged to generate an exchanged variable length coding table. Then, a coding selection signal is generated by a CPU to determine either the variable length coding table or the exchanged variable length coding table with which variable length coding is performed by a VLC unit. The coding selection signal is thereafter outputted together with a compressed and encoded signal, and a configuration of a contents signal encoding apparatus is thus realized.

### BACKGROUND OF THE INVENTION

1. Field of the Invention

The present invention relates to the compression and encoding of a digital picture signal or a digital audio signal, and the decoding of a compressed encoded signal. In particular, the present invention relates to a variable length data encoding method, a variable length data encoding apparatus, a variable length encoded data decoding method, and a variable length encoded data decoding apparatus for decoding digital data, which is not deteriorated or is only slightly deteriorated through decoding, and for supplying decoded data possessing different qualities to individual users.

2. Related Background Art

When an analog video signal is to be transferred or recorded and then reproduced, the video signal that is to be reproduced is deteriorated consonant with the quality of a transfer path or a recording medium, and the image quality slightly differs between the original video signal and the video signal reproduced by a user.

Similarly, when an analog audio signal is to be transferred or recorded and then reproduced, the audio signal to be reproduced is deteriorated consonant with the quality of a transfer path or a recording medium, and the tone quality slightly differs between the original audio signal and the audio signal reproduced by a user.

The difference in quality that occurs between that obtained by a copyright owner, one owning a video signal and/or an audio signal (hereinafter sometimes referred to as content signals), and that obtained by a user who reproduces the content signal is employed to protect the rights of the copyright owner relative to the content signal, and normal management of the content business can thus be conducted.

Recently, as digital signal processing techniques have been developed, and since, by using these techniques, the broadcasting or communication of the content signal and the supply of the content signal to a user by employing a recording medium have been performed while deterioration of the quality of the content signal has been reduced, the difference in quality is gradually being reduced between the contents owned by the copyright owner and the contents reproduced by the user. Therefore, using the contents owned by the copyright owner, an operation employing normal business management procedures has become difficult.

To solve this problem, an encryption technique for supplying contents only to a user with whom a special contract has been executed and a conditional access technique has been developed, and these techniques are used to supply the contents. By employing these techniques, either normal reproduction or non-reproduction is selected for a signal, the signal being processed using the encryption technique and the conditional access technique. Then the contents are supplied to a specific user, such as one with whom a contract has been executed.

Further, another method has been developed whereby, when the contents of the copyright owner are supplied to a user through a transfer, or by using a recording medium, and the user employs the contents secondarily, an electronic watermark is used to embed information specifically identifying the owner of the copyright for the contents. However, there is little deterioration of contents when they are employed secondarily, and actually, using an electronic watermark to protect contents is effective only for specifying the owner of the contents.

As is described above, techniques have been developed for transferring contents and for recording and reproducing contents for which there is little quality deterioration. Additionally, there is a demand for the development of a digital signal technique that includes a satisfactory copyright protection technique provided for an analog signal and that protects a copyright owner and permits a satisfactory content business to be conducted.

Relevant explanations will now be given, first, for the MPEG (Moving Picture Experts Group) video and MPEG audio techniques for content signal compression and encoding, and for decoding techniques; and second, for an encoding technique and a related content disclosure method, which provides appropriate encoding for compressed encoded signals, that are required for conducting a contents business.

First, the MPEG video technique will now be described.

A so-called MPEG video system for performing the high-efficiency encoding of moving picture signals, such as television signals, is widely employed for digital satellite broadcasting, DVDs (Digital Versatile Discs), digital tape recorders and signals to be supplied through a communication network, and it is planned to adopt the system for digital ground broadcasting in 2003.

Specifically, the MPEG video standard is an international standard, prepared as a result of deliberations held by an organization, for discussing the moving image encoding standard, that was established in 1988 by the JTC1/SC2 (Joint Technical Committee 1/Sub Committee 2) of the ISO/IEC (International Organization for Standardization/International Electrotechnical Commission).

The SC2, the consultation organization, is currently acting as SC29 and is continuing standard enactment activities related to the encoding of moving images and audio signals, and the international standards established by the relevant MPEG working group are generally called the MPEG standard.

MPEG1 (MPEG phase₁ ), the first established by the MPEG working group, is the standard used for encoding moving images that are accompanied by audio signals, and is being applied for recording media having a transfer rate of about 1.5 Mbps. MPEG1 employs the basic techniques established by JPEG (Joint Photographic Coding Experts Group) for encoding still pictures and H.261 (CCITT SGXV, standardized by the current ITU-TSG15) for compressing moving pictures used for the low transfer rate for ISDN (Integrated services digital network) video conferences and video telephones.

Then, in August, 1993, MPEG1 was established as ISO/IEC11172, and many disks have been manufactured on which data encoded using the MPEG1 standard are recorded.

Thereafter, in November, 1994, MPEG2 (MPEG phase₂) was established as ISO/IEC13818 and “H.262” in order to provide the general standards required for coping with various applications, such as communication and broadcasting.

An encoding system constituted in accordance with MPEG1 and MPEG2 employs a plurality of encoding techniques, and by applying these techniques, picture “frames”, which together form a moving picture, are divided into blocks called macro blocks of 16×16 pixels each and encoding processing is performed for each block.

The encoding processing is based on two essential picture encoding techniques: the “motion compensation prediction” technique for calculating a motion value, called a “motion vector”, between a reference picture and a target picture to be encoded, two of which, at a distance, are separated by a predetermined number of frames along the time axis into the future or into the past, and for encoding the target picture, based on the motion value, while referring to the reference picture; and the “transform coding” technique for employing a DCT (Discrete Cosine Transform), which is one of the orthogonal transform techniques to transform picture information into a set of frequency data, image data for an error signal of the motion compensation prediction, or the target picture to be encoded, and for, based on the data obtained for the frequency region, performing compression and encoding to obtain only visually effective information.

There are three modes for motion compensation prediction: prediction from the past, prediction from the future and prediction from both the past and the future, and these three modes can be switched for each macro block in which data for 16×16 pixels are included.

Further, three picture types, I (Intra-encoded), P (Predictive-encoded) and B (Bidirectionally predictive-encoded) are defined as types to be provided for a frame of an input picture.

The I picture is a picture to be encoded without motion prediction; as for the P picture, there are two modes, encoding with prediction from the past and encoding without a prediction; and as for a B picture, there are four MC (motion Compensation) modes in which intra-frame encoding is performed with prediction from the future, prediction from the past, prediction from both the past and the future, and without a prediction.

For motion compensation using a picture in the future or in the past, pattern matching is performed for each macro block in a motion area, a motion vector is obtained at an accuracy of half pel (½ of the inter-pixel distance), and the reference picture position in the future or in the past is moved in the vector direction in accordance with the obtained motion vector value, and by referring to a reference picture formed at the reference picture position, an input picture signal is encoded.

The directions of the thus obtained motion vector are the horizontal direction and the vertical direction, and the vector data are supplied together with the MC mode, as additional information for the macro block.

From among the image data for a picture frame, the I, P and B pictures are arranged and supplied in a predetermined order, beginning with the I picture, and a set of pictures (frame pictures) from the I picture to a picture preceding the next I picture is called a GOP (Group Of Pictures). Using the encoding performed for the normal recording media, the GOP is formed from about 15 pictures.

Then, for the I picture and the P and B pictures which are to be encoded as the motion compensation pictures, the DCT, i.e., an integral transform using a cosine function as the kernel, is performed as an orthogonal transform which is a discrete transform into finite space.

For this orthogonal transform, the macro block is divided into DCT blocks of 8×8 pixels and the two-dimensional DCT is performed. Generally, however, since the frequency elements of an image data includes many low frequency elements and few high frequency elements, therefore the compressed image data can be expressed by using a transform coefficient for which, through the DCT, energy is concentrated on the low frequency elements.

Then, a quantizer performs quantization on the DCT image data (DCT coefficient) after performing the DCT. That is, the quantizer obtains the DCT coefficient by performing a division using a predetermined quantization value. This quantization value can be obtained as a quantized value for which the secondary frequency of 8×8 pixels is weighted with a visual characteristic. And the value obtained by a scalar multiplication that uses a predetermined quantization scale is employed as the quantization value.

Further, when the quantization value is multiplied by an inverse quantization value that is provided during the decoding of encoded image data, the characteristic of the quantization value provided during the encoding can be canceled during the decoding process.

An explanation will now be given for the configuration of an MPEG encoder that employs the above described method for encoding and decoding.

The schematic operation of the MPEG encoder will be described while referring to FIG. 1, wherein the configuration of this encoder is shown.

An MPEG encoding apparatus 50 comprises an input terminal 51, an adder 52, a DCT unit 53, a quantizer 54, a VLC (Variable Length Coding) unit 55, a buffer 56, an amount-of-code controller 57, an inverse quantizer 61, an inverse DCT unit 62, an adder 63, a picture memory 64 and a motion compensation prediction unit 65.

First, a moving picture signal supplied to the input terminal 51 is supplied to the motion compensation prediction unit 65 and the adder 52. The adder 52 inverts a signal received from the motion compensation prediction unit 65, adds the inverted signal to the other signal, and supplies the resultant signal to the DCT unit 53.

The DCT unit 53 performs the above described discrete cosine transform on the received picture signal, and supplies the obtained DCT transform coefficient to the quantizer 54. The quantizer 54 then performs the quantization process, based on the predetermined quantization value described above, and supplies the quantized data to the inverse quantizer 61 and the VLC unit 55.

The VLC unit 55 performs variable length coding on the quantized data. And from among the quantized values, DPCM (Differential Pulse Code Modulation) is performed on the direct current (DC) element obtained through the DCT transform.

Using a zigzag scan, the alternating-current (AC) elements are obtained in order from the low frequency element data to the high frequency element data. Then, Huffman coding is performed on the obtained data so that, while a run length of zero and an effective coefficient value are regarded as a single event, codes having a small code length are allocated, in order, for the data, beginning with the highest appearance probability.

The data obtained by the Huffman coding, which is variable length coding, are temporarily stored in the buffer 56, and are then outputted as encoded data at a predetermined transfer rate.

The amount of code for each macro block of the output data is supplied to the amount-of-code controller 57. The amount-of-code controller 57 compares the received amount of code with a target amount of code that has been designated in advance, and supplies a difference between the two amounts of code to the quantizer 54. Based on the difference in the code rates, the quantizer 54 adjusts the code rate, e.g., changes the value of the quantization scale to obtain the encoded data at a predetermined transfer rate.

The image data quantized by the quantizer 54 are supplied to the inverse quantizer 61 which performs the inverse quantization. The data obtained by the inverse quantization is suppliedted to the inverse DCT unit 62, and an inverse DCT is performed for the data. Then, the data obtained by performing the inverse DCT are supplied to the adder 63.

The adder 63 adds the inverse DCT data to reference image data received from the motion compensation prediction unit 65, and supplies the obtained signal to the picture memory 64, wherein the signal is temporarily stored. The temporarily stored image data are employed by the motion compensation prediction unit 65 as data for a reference decoded picture in order to obtain a differential picture. As a result, the encoded data obtained through motion compensation are outputted by the MPEG encoding apparatus 50.

Thereafter, the thus obtained output encoded data are supplied to an MPEG decoder for decoding.

The schematic operation of an MPEG decoder will now be described while referring to FIG. 2, in which the configuration of the MPEG decoder is shown.

In FIG. 2, an MPEG decoding apparatus 70 includes an encoded data input terminal 71, a buffer 72, a VLD (Variable Length Decoding) unit 73, an inverse quantizer 74, an inverse DCT unit 75, an adder 76, a picture memory 77 and a motion compensation prediction unit 78.

The encoded data received at the input terminal 71 are temporarily stored in the buffer 72, and are then supplied, as needed, to the VLD (Variable Length Decoding) unit 73.

The VLD unit 73 performs variable length decoding on the data encoded by the VLC unit 55, and obtains data related to the direct-current (DC) element and the alternating-current (AC) element described above.

The alternating-current element data of the obtained data are quantized data that are to be arranged in a matrix of 8×8 pixels, in the zigzag scan order, from the low frequency elements to the high frequency element, as is performed by the MPEG encoding apparatus 50. The obtained quantized data are supplied to the inverse quantizer 74.

The inverse quantizer 74 performs inverse quantization based on the quantized matrix arrangement, and supplies the obtained data to the inverse DCT unit 75. The inverse DCT unit 75 performs an inverse DCT and obtains the decoded image data.

The decoded image data are temporarily stored in the picture memory 77, and are then supplied to the motion compensation prediction unit 78. The image data are employed as data for a reference decoded picture in order to obtain a differential picture for the motion compensation prediction.

In this manner, the MPEG encoding apparatus 50 encodes the picture data that form a moving picture, and supplies or records the encoded data. The MPEG decoding apparatus 70 decodes the received or reproduced encoded data, so as to obtain the moving picture information. This method is employed for both MPEG1 and MPEG2, and in either case, transmission is enabled for a video signal that is little affected by noise and non-linearity along the transmission path.

A method is available that is related to the protection of the copyright for the thus encoded picture signal (e.g., see Japanese Patent Laid-Open Publication No.2000-175162). According to this method, image data are encoded by using a plurality of types of encoding modes, whether reproduction of the encoded data should be permitted or inhibited is determined based on the input security data, and the decoding of a picture signal is performed in accordance with the determination results.

The encoding and decoding of a picture signal has been described.

An explanation will now be given for the compression and encoding of an audio signal while, as an example, MPEG-2 AAC (Advanced Audio Coding) is employed.

FIG. 3 is a diagram showing the configuration of an encoding apparatus of an MPEG-2 AAC system that compresses and encodes a digital audio signal. The operation of this encoder will now be described.

An audio signal encoding apparatus 400 in FIG. 3 includes an auditory psychological analyzer 401, an MDCT (Modified Discrete Cosine Transform) unit 402, a scale factor calculator 403, a quantizer 404, a code book selector 405, a variable length encoder 406, a smallest amount-of-code detector 407, an amount-of-code determination unit 408 and a bit stream generator 409.

In the MPEG-2 AAC audio encoding apparatus, the auditory psychological analyzer 401 performs an FFT (Fast Fourier Transform) processing on an input digital audio signal and obtains a frequency spectrum. Then, based on the frequency spectrum, a masking level provided for hearing is calculated, and a permissible quantizing noise-power is measured for each frequency band that has been designated in advance.

The MDCT unit 402 performs the MDCT process on a transmitted audio signal to obtain spectrum data, which are called an MDCT coefficient. Then, based on window selection information determined by the auditory psychological analyzer 401, a large or small transform block length is selected. Further, the MDCT computation is performed while 50% of the computation block lengths are overlapped.

When a long window is selected, 2048 samples of audio signals are transformed into 1024 MDCT coefficients, while when a short window is selected, 256 samples are transformed into 128 MDCT coefficients.

While the 1024 MDCT coefficients are regarded as a single device for each frequency band, based on the hearing characteristics of a human being, the scale factor calculator 403 divides the audio signal into a plurality of scale factor bands. The number of quantization steps (scale factors) for each scale factor band is calculated, so that the quantizing noise obtained for each scale factor band is not greater than the permissible quantizing noise power obtained by the auditory psychological analyzer 401.

A dotted area 400a in FIG. 3 represents the portion wherein the processing is performed on each scale factor band. That is, quantization is performed by the quantizer 404 on each scale factor band. Then, based on the scale factor and the total number of quantization steps that are obtained by the quantizer 404, the scale factor calculator 403 acquires an MDCT coefficient for a signal in a scale factor band, and performs the quantization process based on the MDCT coefficient. Furthermore, quantization is performed, for the MDCT coefficient, so that the total number of quantization steps is adjusted and falls within the number of bits required for quantization

The code book selector 405 selects an available Huffman code book in accordance with the maximum absolute quantization value.

FIG. 4 is a table showing Huffman code books used for the MPEG-2 AAC.

The code book selector 405 selects the Huffman code book based on the maximum absolute quantization value, and uses the selected code book to perform the variable length coding. For example, when the maximum absolute quantization value is 5, the Huffman code book of seven or greater is employed, and the selected Huffman code book is supplied to the variable length encoder 406.

The variable length encoder 406 employs the Huffman code book selected by the code book selector 405 to perform variable length coding on the quantization value of the MDCT coefficient that is transmitted from the quantizer 404. When a plurality of Huffman code books are selected, the encoding is performed by using these Huffman code books, and the results are supplied to the smallest amount-of-code detector 407. In addition, the variable length encoder 406 also performs variable length coding on the transmitted scale factor, and supplies, to the amount-of-code determination unit 408, the encoded results obtained by the reduction of the redundancy.

Based on the encoded results obtained by using the Huffman code books, the smallest amount-of-code detector 407 selects a Huffman code book for which amount of generated code is smallest, and supplies the selected Huffman code book and the encoded results to the amount-of-code determination unit 408.

The amount-of-code determination unit 408 determines whether the amount of code obtained through the encoding falls within the usable amount-of-code range. And when the amount of code is higher than the usable amount-of-code, the quantization process is repeated until the amount of code is equal to or lower than the usable amount-of-code.

The outputted encoded data that satisfy the number of available bits are supplied to the bit stream generator 409, and the bit stream generator 409 multiplexes the encoded data with coding parameters, such as a sampling frequency and a coding rate, and generates an AAC bit stream. This AAC bit stream is then output by the audio signal encoding apparatus.

An explanation will now be given for an audio signal decoding apparatus that decodes the AAC bit stream thus encoded.

FIG. 5 is a diagram showing a conventional example of MPEG-2 AAC decoder that performs decoding corresponding to the encoding performed by the MPEG-2 AAC encoder, and the audio signal decoding apparatus will be described while referring to FIG. 5.

In FIG. 5, an audio signal decoding apparatus 420 includes a bit stream analyzer 421, a variable length decoder 422, an inverse quantizer 423 and an IMDCT (Inverse Modified Discrete Cosine Transform) unit 424.

First, in the MPEG-2 AAC decoder, the bit stream analyzer 421 separates a transmitted AAC bit stream, which is a plurality of multiplexed signals, into individual signals, i.e., coding parameters, such as a sampling frequency and a coding rate, and encoded data.

The variable length decoder 422 receives a scale factor and a quantization value, which are coding parameters, and the encoded data, and performs variable length decoding based on the transmitted data. That is, the Huffman code book for the scale factor is employed, while, based on the Huffman code book number obtained by the bit stream analyzer 421 for each scale factor band unit, the Huffman code book for the quantization value is selected for decoding the quantization value.

The decoded quantization value and scale factor are then supplied to the inverse quantizer 423, whereat the inverse quantization is performed on the quantization value for each scale factor band by using the total number of quantization steps and the scale factor, which are coding parameters output by the beam stream analyzer 421. As a result, the MDCT coefficient is obtained.

The MDCT coefficient is inputted to the IMDCT unit 424, and is transformed into an audio signal through the inverse MDCT transform. The audio signal is then output by the IMDCT unit 424.

An explanation has been given for the operation wherein the digital audio signal is compressed and encoded by the audio signal encoding apparatus, and wherein the encoded signal is decoded by the audio signal decoding apparatus to obtain the digital audio signal.

In addition, an optical disk drive is disclosed (e.g., see Japanese Patent Laid-Open Publication No. 2001-312853). In the disk drive, security information, such as electronic watermark information, is embedded in a digital audio signal which is encoded by the audio signal encoding apparatus, that is recorded on an optical disk using SCMS (Serial Copy Management System). When the allowance by the security system is not obtained, only part of an encoded digital audio signal is recorded on a recording medium.

For a user, it is preferable that high-quality compressed and encoded signals of moving picture signals, such as MPEG1 and MPEG2 signals, and audio signals be employed for the transmission of content signals. However, this is not always preferable for a copyright owner in order to promote and conduct content business.

A compressing and encoding system for protecting a content business has been requested to protect contents business. In this compressing and encoding system, when a general decoding apparatus is employed to decode digital content data, the obtained data are slightly deteriorated as those obtained by an analog system. So to say, the obtained data are in a half-disclosed state. Alternatively, when a predetermined decoding apparatus is employed to decode digital content data, the obtained data are not deteriorated.

For the encoding system for protecting content business, a function is provided for preventing the unauthorized copying of contents and unauthorized reproduction of contents using an illegal reproduction device. Thereby, the contents, on which signal processing to prevent their unauthorized reproduction for security protection has been performed, are supplied to market.

Alternatively, there is a method to protect security by performing encryption processing on a bit stream which consists of encoded data obtained by compression and encoding of MPEG system, for example.

According to this method, the encrypted encoded data can be decrypted only by a specific and permitted user to obtain content data that are not deteriorated. However, a user who can not decrypt the data can not obtain any of the image or audio information in the contents.

### SUMMARY OF THE INVENTION

Therefore, according to one object of the present invention, when, for example, MPEG is used to perform an orthogonal transform for content data, and when variable length coding is performed for an encoding content signal that is obtained by the variable length coding of coefficient value data acquired through the orthogonal transform, a VLC (Variable Length Coding) table, using a so-called Huffman code, is changed and used, so that the qualities of pictures and sound signals reproduced by a common decoder differ from those by a regular decoder.

For an event having a high appearance frequency, generally, the encoding lengths differ, and when such tables are switched, the amount of code is increased and the encoding efficiency is reduced. However, especially according to another object of the invention, only the VLC encoding for events having the same length need be changed to prevent degradation in the encoding efficiency, and also to prevent the occurrence of an unreasonable error signal.

As yet another object of the invention, the VLC codes of the VLC tables using the above mentioned switch are formed, for example, of codes for the VLC code system that is defined in accordance with the MPEG video and the MPEG AAC audio standards that, on the market, are generally employed as international standards. The VLC encoding is provided by employing a method that provides better matching with a content compressing and encoding method that is frequently employed on the market.

As a still another object of the invention, a coding selection signal, for switching an event represented by VLC encoding that employs the generally used MPEG syntax, enables the transmission, using a plurality of methods, of data written in a user data recording area defined by MPEG, electronic watermark data mixed in with pictures and sounds, and additional data that are transmitted separately from picture and audio data. Further provided are a variable length data encoding method, a variable length data encoding apparatus, a variable length data decoding method and a variable length data decoding apparatus for processing desired contents while maintaining a predetermined security level.

To achieve the above objects, there is provided a variable length data encoding method for performing data transform, quantization and arrangement on a contents signal including at least any of a picture signal and a sound signal based on a predetermined method to obtain time series data, and obtaining a compressed and encoded signal by encoding the obtained time series data, the variable length data encoding method including: a first step of obtaining a variable length coding table in which predetermined code words are written and allocated to a plurality of data values for the time series data; a second step of generating an exchanged variable length coding table by exchanging, among code words written in the variable length coding table, the code words to which a same number of the time series data are allocated and differ from each other; a third step of generating a coding selection signal for specifying an encoding table from any of the variable length coding table and the exchanged variable length coding table to be used for variable length coding; and a fourth step of generating the compressed and encoded signal by the variable length coding on the time series data by use of the specified encoding table.

Moreover, to achieve the above objects, there is provided a variable length data encoding apparatus for performing data transform, quantization and arrangement on a contents signal including at least any of a picture signal and a sound signal based on a predetermined method to obtain time series data, and generating a compressed and encoded signal by encoding the obtained time series data, the variable length data encoding apparatus is configured by including: variable length coding table obtaining means for obtaining a variable length coding table in which predetermined code words are written and allocated to a plurality of data values for the time series data; exchanged variable length coding table generating means for generating an exchanged variable length coding table by exchanging, among code words written in the variable length coding table, the code words to which a same number of the time series data are allocated and differ from each other; coding selection signal generating means for generating a coding selection signal for specifying an encoding table from any of the variable length coding table and the exchanged variable length coding table to be used for variable length coding; and variable length coding means for generating the compressed and encoded signal by the variable length coding on the time series data by use of the specified encoding table.

Further, to achieve the above objects, there is provided a variable length encoded data decoding method for performing data transform, quantization and arrangement on a contents signal including at least any of a picture signal and a sound signal based on a predetermined method to obtain time series data, performing variable length coding to generate a compressed and encoded signal on which variable length decoding is performed to obtain the time series data, and decoding the obtained time series data to obtain the contents signal, wherein the compressed and encoded signal is generated by performing the variable length coding on the time series data by use of an encoding table specified by a coding selection signal for specifying the encoding table from any of two encoding tables of a variable length coding table, in which predetermined code words are written and allocated to a plurality of data values for the time series data, and an exchanged variable length coding table, in which code words which have a same number as the time series data and are different from each other among the code words written in the variable length coding table are exchanged to be written therein, the variable length encoded data decoding method including: a first step of detecting the coding selection signal; a second step of obtaining the time series data by performing the variable length decoding on the compressed and encoded signal by using the encoding table specified based on the detected coding selection signal; and a third step of obtaining the contents signal by decoding the time series data obtained in the second step.

Furthermore, to achieve the above objects, there is provided a variable length encoded data decoding method for performing data transform, quantization and arrangement on a contents signal including at least any of a picture signal and a sound signal based on a predetermined method to obtain time series data, performing variable length coding to generate a compressed and encoded signal on which variable length decoding is performed to obtain the time series data, and decoding the obtained time series data to obtain the contents signal, wherein the compressed and encoded signal is generated by performing the variable length coding on the time series data by use of an encoding table specified by a coding selection signal for specifying the encoding table from any of two encoding tables of a variable length coding table, in which predetermined code words are written and allocated to a plurality of data values for the time series data, and an exchanged variable length coding table, in which code words which have a same number as the time series data and are different from each other among the code words written in the variable length coding table are exchanged to be written therein, the variable length encoded data decoding method including: a first step of detecting the coding selection signal; a second step of selecting whether to perform the variable length decoding on the compressed and encoded signal by using the encoding table specified based on the detected coding selection signal or to perform the variable length decoding on the compressed and encoded signal by using the variable length coding table in disregard for use of the exchanged variable length coding table when the use of the table is specified by the detected coding selection signal; a third step of obtaining the time series data by performing the variable length decoding on the compressed and encoded signal by use of the encoding table in accordance with a result of the selection in the second step; and a fourth step of obtaining the contents signal by decoding the time series data obtained in the third step.

Moreover, to achieve the above objects, there is provided a variable length encoded data decoding apparatus for performing data transform, quantization and arrangement on a contents signal including at least any of a picture signal and a sound signal based on a predetermined method to obtain time series data, performing variable length coding to generate a compressed and encoded signal on which variable length decoding is performed to obtain the time series data, and decoding the obtained time series data to obtain the contents signal, wherein the compressed and encoded signal is generated by performing the variable length coding on the time series data by use of an encoding table specified by a coding selection signal for specifying the encoding table from any of two encoding tables of a variable length coding table, in which predetermined code words are written and allocated to a plurality of data values for the time series data, and an exchanged variable length coding table, in which code words which have a same number as the time series data and are different from each other among the code words written in the variable length coding table are exchanged to be written therein, the variable length encoded data decoding apparatus including: coding selection signal detecting means for detecting the coding selection signal; variable length decoding means for performing the variable length decoding on the compressed and encoded signal by use of the encoding table specified based on the detected coding selection signal to obtain the time series data; and contents signal decoding means for decoding the time series data obtain the variable length decoding means to obtain the contents signal.

Furthermore, to achieve the above objects, there is provided a variable length encoded data decoding apparatus for performing data transform, quantization and arrangement on a contents signal including at least any of a picture signal and a sound signal based on a predetermined method to obtain time series data, performing variable length coding to generate a compressed and encoded signal on which variable length decoding is performed to obtain the time series data, and decoding the obtained time series data to obtain the contents signal, wherein the compressed and encoded signal is generated by performing the variable length coding on the time series data by use of an encoding table specified by a coding selection signal for specifying the encoding table from any of two encoding tables of a variable length coding table, in which predetermined code words are written and allocated to a plurality of data values for the time series data, and an exchanged variable length coding table, in which code words which have a same number as the time series data and are different from each other among the code words written in the variable length coding table are exchanged to be written therein, the variable length encoded data decoding apparatus including: coding selection signal detecting means for detecting the coding selection signal; variable length coding table selecting means for selecting whether to perform the variable length decoding on the compressed and encoded signal by using the encoding table specified based on the detected coding selection signal or to perform the variable length decoding on the compressed and encoded signal by using the variable length coding table in disregard for use of the exchanged variable length coding table when the use of the table is specified by the detected coding selection signal; variable length decoding means for obtaining the time series data by performing the variable length decoding on the compressed and encoded signal by use of the encoding table in accordance with a result of the selection by the variable length coding table selecting means; and contents signal decoding means for obtaining the contents signal by decoding the time series data obtained by the variable length decoding means.

The nature, principle and utility of the invention will become more apparent from the following detailed description when read in conjunction with the accompanying drawings.

### BRIEF DESCRIPTION OF THE DRAWINGS

In the accompanying drawings:

FIG. 1 is a block diagram showing the configuration of a conventional MPEG encoder;

FIG. 2 is a block diagram showing the configuration of a conventional MPEG encoder;

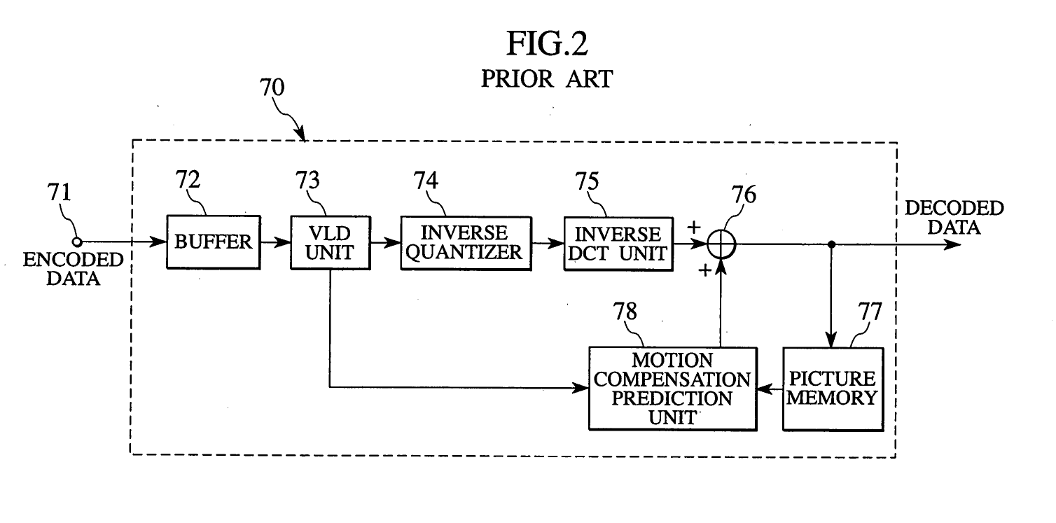

FIG. 3 is a block diagram showing the configuration of an encoding apparatus of an MPEG-2 AAC system;

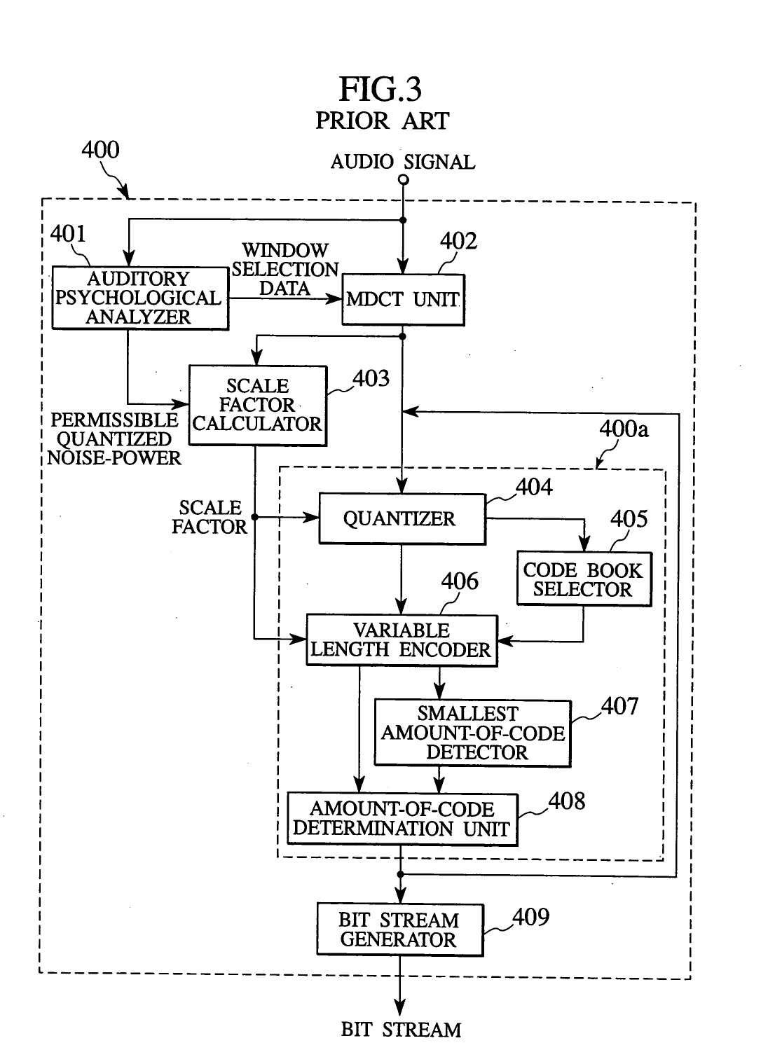

FIG. 4 is a table showing Huffman code books used for the MPEG-2 AAC;

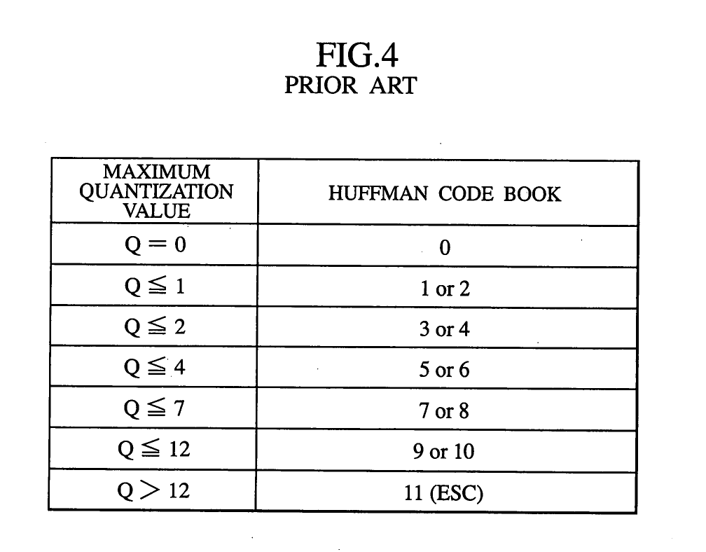

FIG. 5 is a block diagram showing the configuration of a decoding apparatus of an MPEG-2 AAC system;

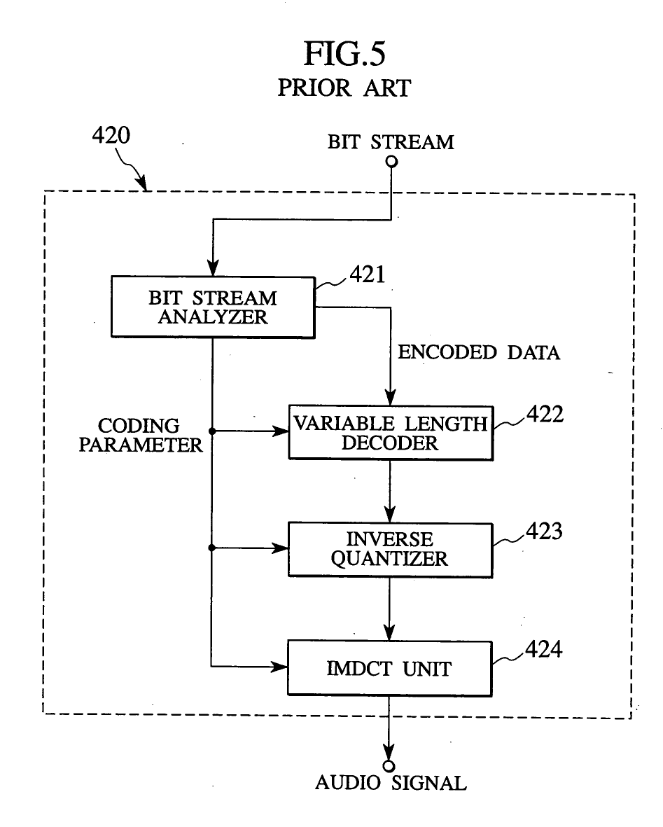

FIG. 6 is a block diagram showing the configuration of a picture signal encoding apparatus according to a first embodiment of the present invention;

FIG. 7 is a block diagram showing the configuration of a picture signal decoding apparatus according to the first embodiment of the invention;

FIG. 8 is a block diagram showing the configuration of a picture signal encoding apparatus according to a second embodiment of the invention;

FIG. 9 shows a syntax for a sequence header according to the second embodiment of the invention;

FIG. 10 shows a syntax for a GOP layer according to the second embodiment of the invention;

FIG. 11 shows a syntax for a picture layer according to the second embodiment of the invention;

FIG. 12 is a block diagram showing the configuration of a picture signal decoding apparatus according to the second embodiment of the invention;

FIG. 13 is a block diagram showing the configuration of a picture signal encoding apparatus according to a third embodiment of the invention;

FIG. 14 is a diagram showing an electronic watermark relative to macro block quantized values according to the third embodiment of the invention;

FIG. 15 is a block diagram showing the configuration of a picture signal decoding apparatus according to the third embodiment of the invention;

FIG. 16 is a block diagram showing the configuration of a picture signal encoding apparatus according to a fourth embodiment of the invention;

FIG. 17 is a diagram showing an electronic watermark relative to macro block motion vector values according to the fourth embodiment of the invention;

FIG. 18 is a block diagram showing the configuration of a picture signal decoding apparatus according to the fourth embodiment of the invention;

FIG. 19 shows a variable length coding table used by the MPEG encoding system;

FIG. 20 shows a first half of the variable length coding table used for encoding according to the fourth embodiment of the invention;

FIG. 21 shows a last half of the variable length coding table used for encoding according to the fourth embodiment of the invention;

FIG. 22 is a diagram showing image quality relationships using combinations including both a conventional encoder and decoder and the encoder and decoder of the invention according to the fourth embodiment of the invention;

FIG. 23 is a flowchart to show a flow of a computer program that performs the encoding of a picture signal;

FIG. 24 is a flowchart to show a flow of a computer program that performs the decoding of a picture signal;

FIG. 25 is a block diagram showing the configuration of a picture signal encoding apparatus according to a fifth embodiment of the invention;

FIG. 26 is a block diagram showing the configuration of a picture signal decoding apparatus according to the fifth embodiment of the invention;

FIG. 27 is a flowchart showing a picture encoding operation according to the fifth embodiment of the invention;

FIG. 28 shows a flowchart of a picture decoding operation according to the fifth embodiment of the invention;

FIG. 29 is a block diagram showing the configuration of an audio signal encoding apparatus according to a sixth embodiment of the invention;

FIG. 30 is a diagram showing a relationship between a scale factor band and a scale factor according to the sixth embodiment of the invention;

FIG. 31 shows a part of Huffman codebook used by the MPEG AAC encoding system;

FIG. 32 is a diagram showing a method for exchanging Huffman codebook indexes according to the sixth embodiment of the invention;

FIG. 33 is a diagram showing examples of variable length coding and variable length decoding for scale factors according to the sixth embodiment of the invention;

FIG. 34 is a block diagram showing the configuration of an audio signal decoding apparatus according to the sixth embodiment of the invention;

FIG. 35 is a block diagram showing the configuration of an audio signal encoding apparatus according to a seventh embodiment of the invention;

FIG. 36 shows a part of a spectrum Huffman codebook employed by the MPEG AAC encoding system;

FIG. 37 is a diagram showing an exchange of code words for a spectrum Huffman codebook according to the seventh embodiment of the invention;

FIGS. 38A and 38B are diagrams for explaining an exchange of code words according to the seventh embodiment of the invention;

FIG. 39 is a block diagram showing the configuration of an audio signal decoding apparatus according to the seventh embodiment of the invention;

FIG. 40 is a block diagram showing the configuration of a picture signal encoding apparatus according to an eighth embodiment of the invention;

FIG. 41 is a block diagram showing the configuration of a picture signal decoding apparatus according to the eighth embodiment of the invention;

FIG. 42 is a block diagram showing the configuration of a picture signal decoding apparatus according to a ninth embodiment of the invention;

FIG. 43 is a block diagram showing the configuration of a picture signal encoding apparatus according to a tenth embodiment of the invention;

FIG. 44 is a block diagram showing the configuration of a picture signal decoding apparatus according to the tenth embodiment of the invention;

FIG. 45 is a block diagram showing the configuration of a picture signal decoding apparatus according to an eleventh embodiment of the invention;

FIG. 46 is a block diagram showing the configuration of a picture signal recording apparatus according to a twelfth embodiment of the invention;

FIG. 47 is a block diagram showing the configuration of a picture signal reproduction apparatus according to the twelfth embodiment of the invention;

FIG. 48 is a block diagram showing the configuration of a picture signal reproduction apparatus according to a thirteenth embodiment of the invention;

FIG. 49 is a block diagram showing the configuration of a picture signal recording apparatus according to a fourteenth embodiment of the invention;

FIG. 50 is a block diagram showing the configuration of a picture signal reproduction apparatus according to the fourteenth embodiment of the invention; and

FIG. 51 is a block diagram showing the configuration of a picture signal reproduction apparatus according to a fifteenth embodiment of the invention.

### DESCRIPTION OF THE PREFERRED EMBODIMENTS

An explanation will now be given for a variable length data encoding method, a variable length data encoding apparatus, a variable length encoded data decoding method and a variable length encoded data decoding apparatus according to the preferred embodiments of the present invention.

Signals to be encoded are content signals that include at the least any one of a picture signal and an audio signal. First, the fundamental embodiment for an encoding method for a content signal as an image will be described.

### First Embodiment

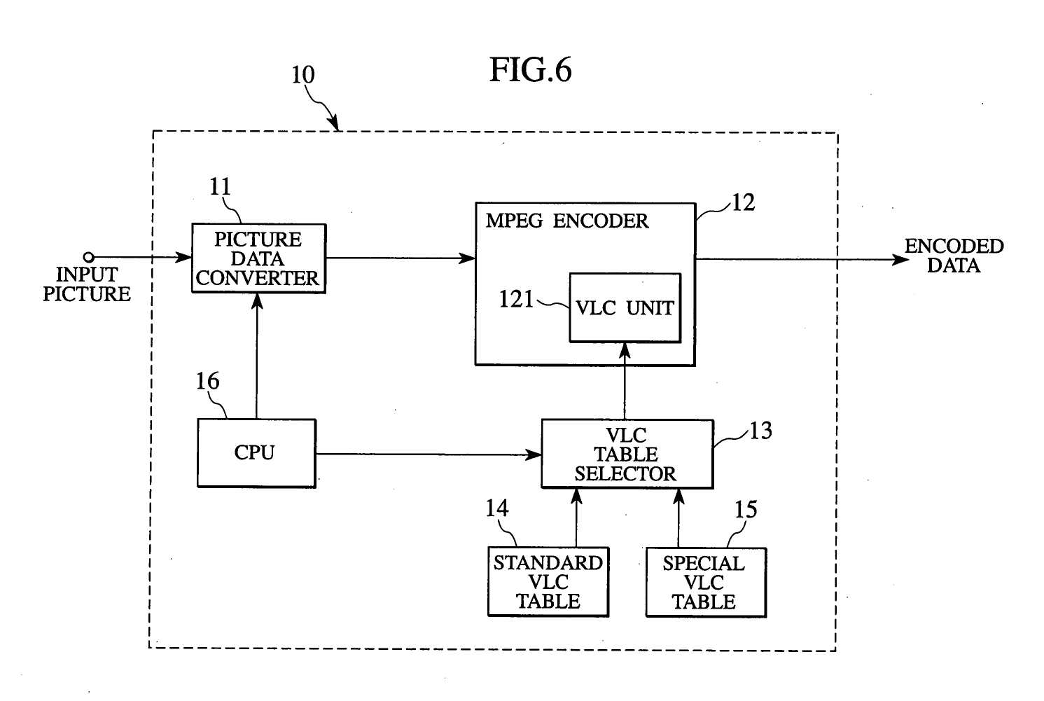

FIG. 6 is a block diagram showing the configuration of a picture signal encoding apparatus (hereinafter may be referred to simply as an encoding apparatus) according to a first embodiment of the present invention. Herein, the apparatus employs the coding method for a picture signal. The picture signal encoding apparatus will be described referring to FIG. 6.

A picture signal encoding apparatus 10 in FIG. 6 includes a picture data converter 11, an MPEG encoder 12, a VLC table selector 13, a standard VLC table 14, a special VLC table 15, and a CPU 16. The MPEG encoder 12 includes a VLC unit 121.

The operation of the picture signal encoding apparatus 10 will now be explained.

First, an input picture signal to be encoded by the MPEG encoder 12 is supplied to the picture data converter 11. The picture data converter 11 is also supplied with a coding selection signal, which is a VLC table switch signal to be described later, from the CPU 16, as electronic watermark information. The coding selection signal is embedded in the picture signal.

The coding selection signal to be embedded in the picture signal is outputted by the CPU 16, and also supplied to the VLC table selector 13. The VLC table selector 13 select one of VLC tables supplied from the standard VLC table 14 and the special VLC table 15 according to the coding selection signal and supplies the selected VLC table to the VLC unit 121. The VLC table is temporarily stored in the VLC unit 121, and based on this VLC table, the MPEG encoder 12 performs compression and coding.

That is, the picture signal in which the coding selection signal is embedded as the electronic watermark is supplied to the MPEG encoder 12. Then, the VLC table specified by the coding selection signal is employed to compress and encode the picture signal.

In this manner, when the coding selection signal supplied from the CPU 16 is “0,” for example, the standard VLC table 14 is selected and is used for coding, and when the coding selection signal is “1,” the special VLC table 15 is selected and is used for coding. The coding selection signal is embedded, using an electronic watermarking method, in a picture signal to be converted by the picture data converter 11, e.g. a picture signal located at a first position at a predetermined interval. As a result, data compressed and encoded by the MPEG is generated.

The operation for decoding the encoded data thus generated will now be described.

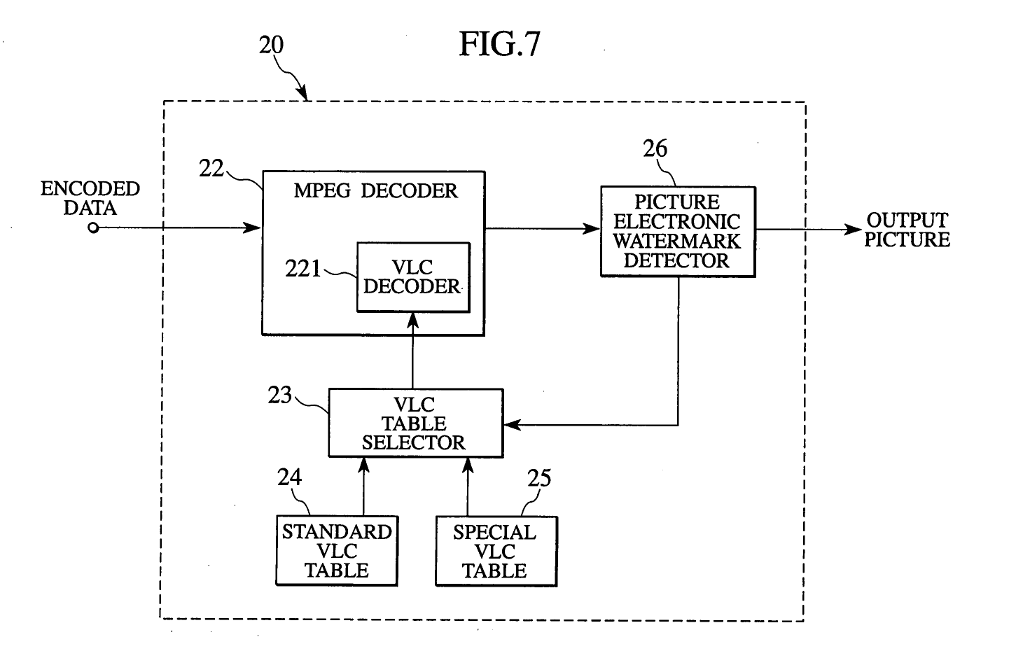

FIG. 7 is a block diagram showing the configuration of a picture signal decoding apparatus (hereinafter may be referred to simply as a decoding apparatus) according to the first embodiment. Herein, the apparatus employs the decoding method for the encoded data. The picture signal decoding apparatus will now be described referring to FIG. 7.

A picture signal decoding apparatus 20 in FIG. 7 includes an MPEG decoder 22, a VLC table selector 23, a standard VLC table 24, a special VLC table 25, and a picture electronic watermark detector 26. The MPEG decoder 22 includes a VLC decoder 221.

Next, the operation of the picture signal decoding apparatus 20 will be described.

First, data compressed and encoded by the picture signal encoding apparatus 10 is supplied to the MPEG decoder 22. The MPEG decoder 22 decodes the signal, which has been compressed and encoded, by using the value of the VLC table temporarily stored in the VLC decoder 221. The obtained picture signal thus decoded is then inputted to the picture electronic watermark detector 26.

The picture electronic watermark detector 26 detects the coding selection signal that has been embedded as the electronic watermark by the picture data converter 11, which will be described later, and supplies the detected coding selection signal to the VLC table selector 23.

The VLC table selector 23 employs the supplied coding selection signal, i.e. the coding selection signal supplied by the CPU 16, to select the information stored either in the standard VLC table 24 or in the special VLC table 25, and supplies the selected VLC table to the VLC decoder 221. The value of the VLC table is temporarily stored in the VLC decoder 221.

Then, the MPEG decoder 22 decodes the supplied encoded data by using the VLC table that is temporarily stored in the VLC decoder 221, which is the same VLC table as is temporarily stored in the VLC unit 121 of the MPEG encoder 12. As a result, a high quality decoded picture signal can be obtained.

In the above described manner, the picture signal encoding apparatus 10 and the picture signal decoding apparatus 20 of the first embodiment respectively perform the compression and coding of data, and the decoding of the compressed and encoded data by employing the VLC table specified by the coding selection signal that is embedded using the picture electronic watermarking method. As a result, a high quality picture signal can be reproduced.

When a picture signal decoding apparatus does not include a function for detecting picture electronic watermark information, or when a picture signal decoding apparatus does not include information on a special VLC table, the standard VLC table mounted in the common MPEG decoder is employed for the data decoding. As a result, the reproduced picture signal is a picture signal that includes a distortion component that is based on a difference between the special VLC table and the standard VLC table.

By using the above described method, a holder of content copyright can supply picture signals having different qualities to a special decoder for which a contract has been executed and a general decoder for which no contract has been executed. That is, the picture electronic watermark detector and the special VLC table are mounted for the special decoder, so that picture signals having different qualities can be supplied to a general user and to a special user.

Even when a general user has a picture signal decoding apparatus for which the special VLC table has been mounted, the electronic watermark information embedded in the encoded data can be decoded only by a special user who is given information related to the electronic watermark embedding method. Thus, only a special user who has entered into a contact can acquire a picture signal with no deterioration in the quality.

The electronic watermark signal that includes predetermined information provides means whereby, for example, specific information can be embedded and hidden in an image. Although there are a plurality of methods for embedding information, a predesignated electronic watermarking method is employed by both the picture signal encoding apparatus and the picture signal decoding apparatus for the transmission of the coding selection signal.

As an example of suggested electronic watermarking methods, a “Method For Embedding Copyright Information In Digital Moving Pictures Using DCT” was presented by Nippon Telegraph and Telephone Corporation (NTT) at SCIS '97 (The 1997 Symposium on Cryptography and Information Security). This method is proposed as an information embedding method where information to be embedded is embedded especially based on a DCT (Discrete Cosine Transform) coefficient, a motion vector and a change in a quantization characteristic when coding by use of MPEG (Moving Picture Experts Group).

Meanwhile, “Watermark Signing Method For Pictures Using A PN Sequence” was presented by the National Defence Academy at SCIS '97-26B. This method is proposed as a method for synthesizing signature information and an image by distributing picture signals using a PN (Pseudo Noise) sequence in accordance with a direct distribution method.

Either of these proposed electronic watermarking methods can be used for the transmission of a coding selection signal, and this signal transmission can also be realized by using another electronic watermarking method whereby the coding selection signal is embedded by the encryption process to be transmitted.

Hereinbefore, there have been described the configuration and the operation of the picture signal encoding apparatus and the decoding apparatus. Herein, an encoded signal, generated by the picture signal encoding apparatus based on the coding selection signal transmitted according to the electronic watermarking method, etc., is transmitted to the picture signal decoding apparatus, thereby enabling individual users to obtain images having different qualities.

As for picture signals transmitted with the coding selection signal being embedded, the standard VLC table, for example, is employed for coding a first moving picture of a GOP (Group of Pictures) or a first moving picture at each predetermined interval. Meanwhile, the transmitted VLC table written in accordance with the electronic watermarking method is employed for coding second and following pictures. There is another method in which the VLC table information, which is written using the electronic watermark, is recorded at a location, for example, where program software is started. Herein, the VLC table information is encoded by use of the standard VLC table during a predetermined period of time.

As another method, there is a method for transmitting electronic watermark information related to the VLC table depending on the location to which the DC element of a picture block, which is obtained by DCT transform of the picture signal, is transmitted. For normal coding, the DC element is usually quantized in accordance with a fixed bit length (for example, 8 bits) regardless of the quantization value. Therefore, the redundancy in that portion is large. Accordingly, by defining the “even number” of the DC elements on an entire screen as 0, and the “odd number” of the DC elements as 1, the electronic watermark data can be transmitted.

The coding selection signal is transmitted using the above described method. Thereafter, when the VLC table employed for decoding is the same as the one used for coding, an image is reproduced with no deterioration. By contrast, when different VLC tables are employed, an image is reproduced with slight deterioration. However, even when different VLC tables are employed, the reproduced picture will not be broken or the like.

An explanation has been given of the configuration and the operation of the picture signal encoding apparatus and the picture signal decoding apparatus according to the first embodiment, through which a coding selection signal is transmitted by use of electronic watermarking method.

### Second Embodiment

Next, an explanation will be given of a method whereby a user defines a coding selection signal and writes this signal in a transmittable user data write area to transmit the coding selection signal.

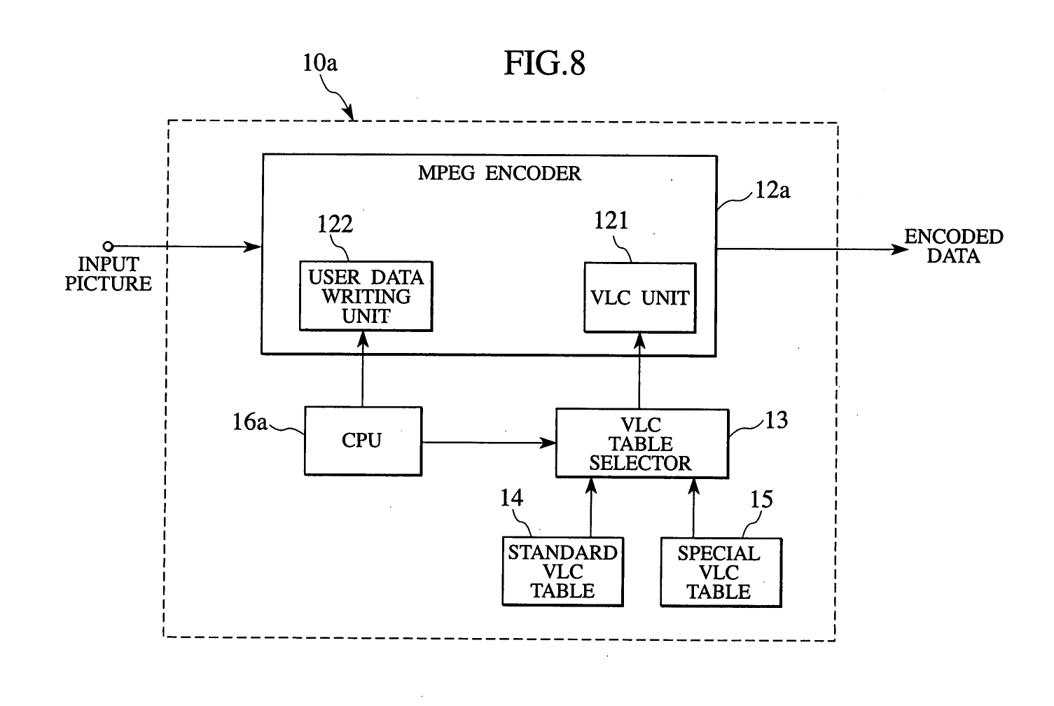

FIG. 8 is a block diagram showing the configuration of a picture signal encoding apparatus according to a second embodiment of the present invention that employs the picture signal coding method. The configuration for the second embodiment will be described referring to FIG. 8.

A picture signal encoding apparatus 10a in FIG. 8 includes an MPEG encoder 12a, a VLC table selector 13, a standard VLC table 14, a special VLC table 15, and a CPU 16a. A VLC unit 121 and a user data writing unit 122 are included in the MPEG encoder 12a. In FIG. 8, the same reference numerals as are used for the first embodiment are attached to blocks having the same functions.

An explanation will now be given for the operation of the picture signal encoding apparatus 10a thus arranged which differs from the operation of the first embodiment.

Specifically, in picture signal encoding apparatus 10a, the CPU 16a supplies a coding selection signal to the user data writing unit 122 in the MPEG encoder 12a and the supplied coding selection signal is written in a user data area in the user data writing unit 122.

Meanwhile, a VLC table based on the coding selection signal supplied from the CPU 16a is supplied by the VLC table selector 13 to the VLC unit 121. The input picture data is compressed and encoded based on the coding selection signal supplied from the CPU 16a, and the resultant data is outputted by the picture signal encoding apparatus 10a as encoded data for which the coding selection signal has been written in the user data write area.

The writing of the coding selection signal in the user data area will now be described.

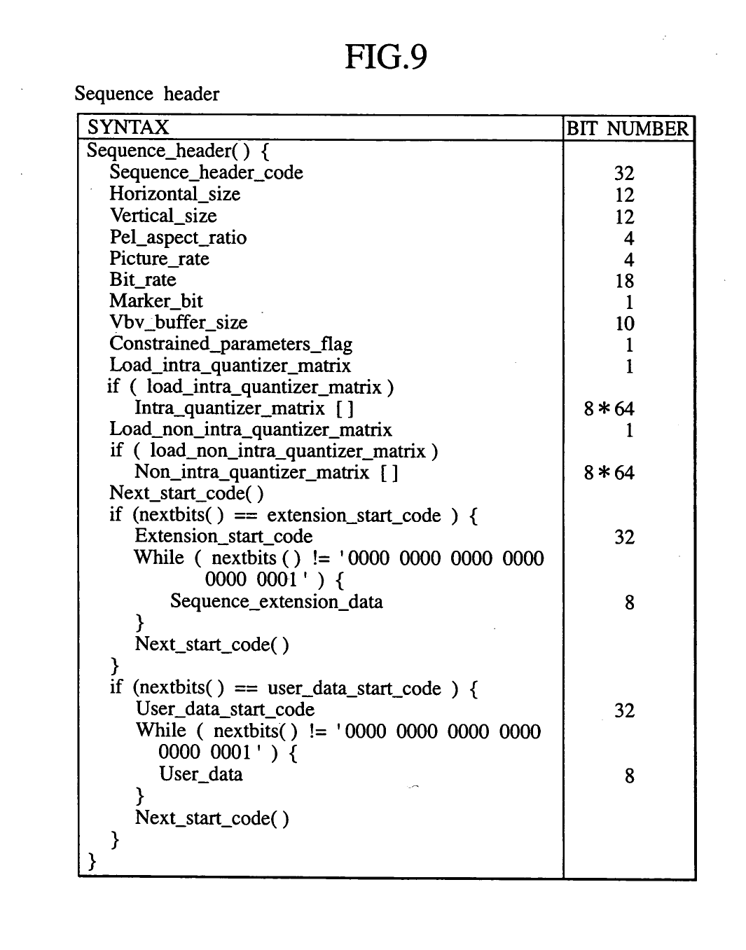

FIG. 9 is a diagram for explaining a description format for the sequence header of the encoded data.

The description syntax for the sequence header is shown in FIG. 9. The 32-bit sequence header code, the 12-bit horizontal picture size and the 12-bit vertical picture size are written in this order in the sequence header. The user data can be written in a halftone-dotted User_data portion at and after nextbits( )==user_data_start_code.

The user data can also be written in the GOP layer.

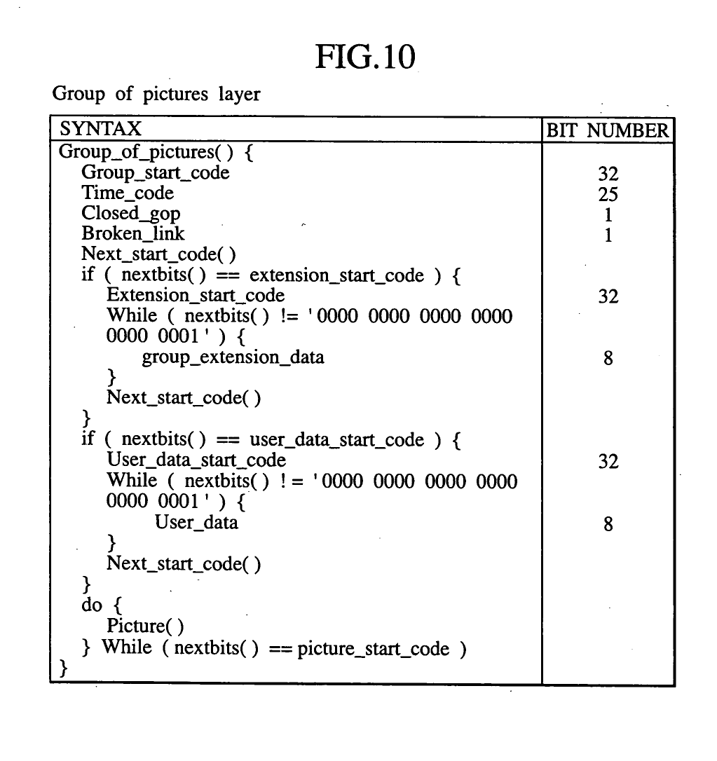

FIG. 10 is a diagram showing a description format for the GOP layer of encoded data.

In FIG. 10, the portion where the user data is written is shown by using half-dots as in FIG. 9. That the user data can be written in the User_data portion at and after nextbits( )==user_data_start_code.

Such user data can also be written in the picture layer.

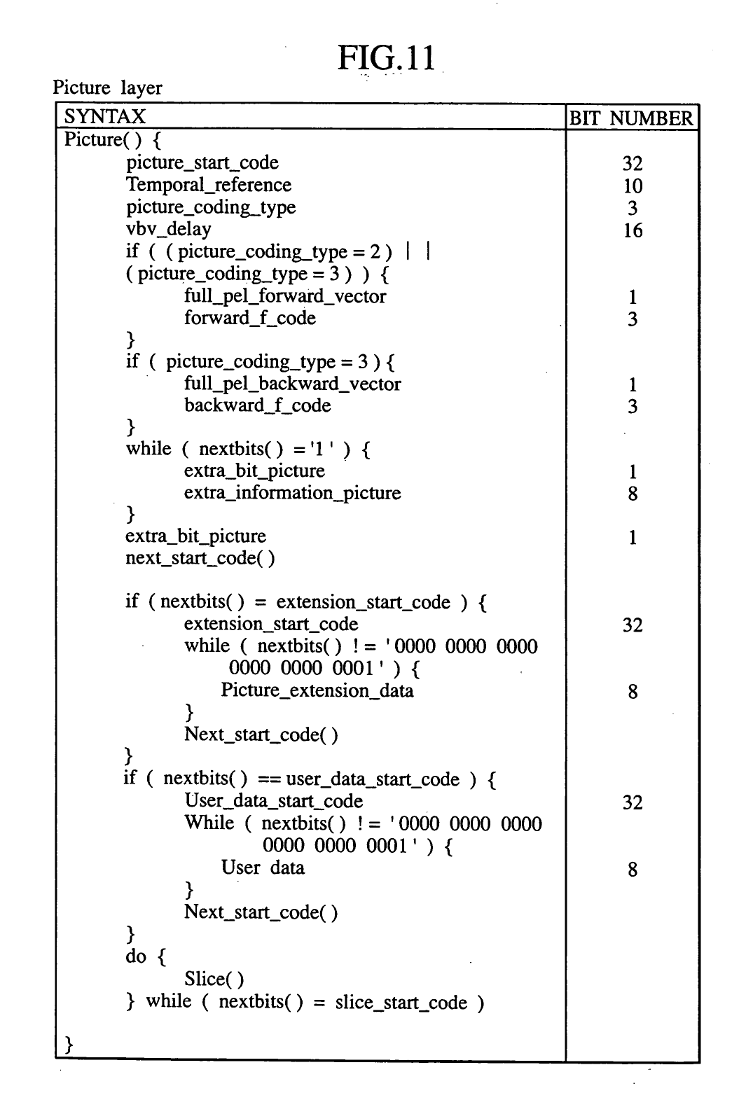

FIG. 11 shows a description format for the picture layer for encoded data. The user data can be similarly written in a half-dotted portion.

In this manner, the user data for MPEG can be written in the sequence header, the GOP layer and the picture layer. Since user_data having different contents may be written in the user_data area, the coding selection signal, which is a VLC table switching signal, is written immediately after the 32-bit header signal such as “ffee2424” using a hexadecimal expression.

That is, following the header signal, a one bit signal for selecting a VLC table such as “0” or “1” using a binary expression is written. Otherwise, the VLC table selection information is written using an eight bit byte-aligned signal.

In this manner, the coding selection signal is written in the user data area. The encoding apparatus generates encoded data that has been compressed and encoded by using a VLC table selected by the coding selection signal. The decoding of the encoded data thus obtained will be described below.

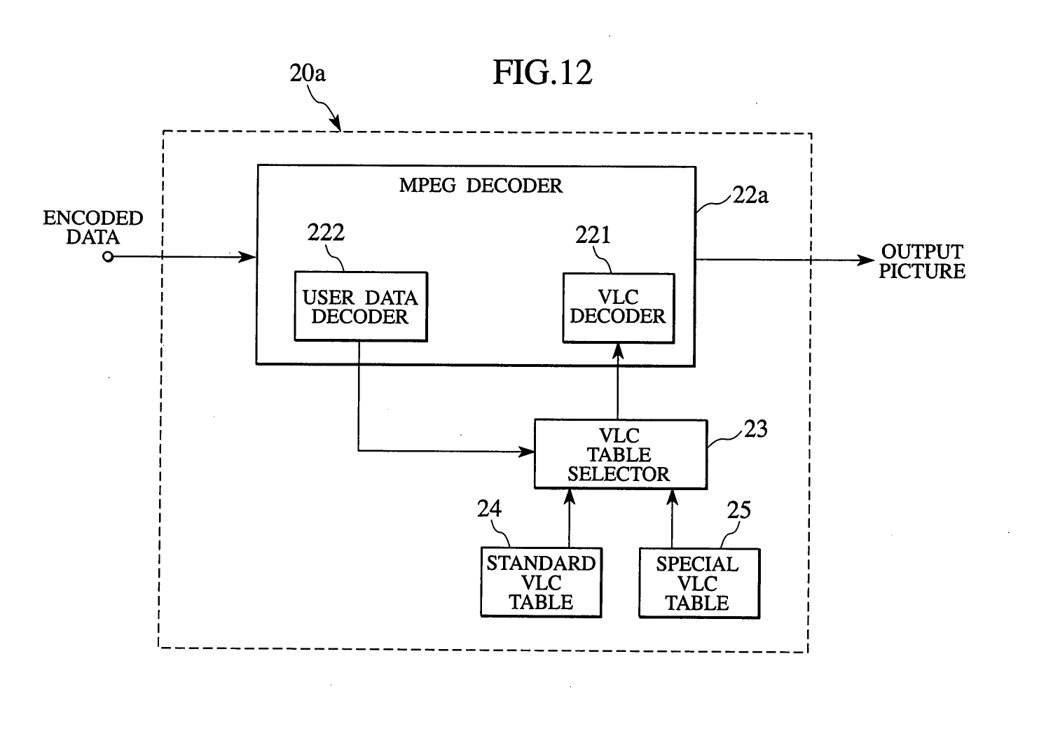

FIG. 12 is a diagram showing the configuration, according to the second embodiment, of a picture signal decoding apparatus that employs an encoded data decoding method. This configuration will be explained with refer to FIG. 12.

A picture signal decoding apparatus 20a in FIG. 12 includes an MPEG decoder 22a, a VLC table selector 23, a standard VLC table 24 and a special VLC table 25. A VLC decoder 221 and a user data decoder 222 are included in the MPEG decoder 22a. The same reference numerals as those used in the first embodiment are attached to blocks having the same functions. Hereafter, unless specifically noted, the same reference numerals are used also in other drawings to show blocks that have the same functions.

The operation of the picture signal decoding apparatus 20a thus configured will now be described.

First, data compressed and encoded by the picture signal encoding apparatus 10a is supplied to the MPEG decoder 22a. The MPEG decoder 22a decodes the signal that has been compressed and encoded in accordance with the MPEG method using the VLC table temporarily stored in the VLC decoder 221.

In the decoding process, the user data written by the user data writing unit 122 in FIG. 8 is decoded by the user data decoder 222 to obtain the coding selection signal, and the coding selection signal is used to perform encoded data decoding operation.

That is, the coding selection signal obtained in the user data decoder 222 is supplied to the VLC table selector 23. Based on this coding selection signal, which has been supplied by the CPU 16a, the VLC table selector 23 selects either the standard VLC table 24 or the special VLC table 25. The selected VLC table is then supplied to and temporarily stored in the VLC decoder 221.

The MPEG decoder 22a decodes the supplied encoded data by using the VLC table that is temporarily stored in the VLC decoder 221. Since the picture signal is decoded using the same VLC table as the one that is temporarily stored in the VLC unit 121 of the MPEG encoder 12a, little deterioration in the quality of the decoded picture signal occurs.

As is described above, the picture signal encoding apparatus 10a and the picture signal decoding apparatus 20a in the second embodiment respectively perform the compression and coding and the decoding by using the VLC table selected based on the coding selection signal that is written in the user data area defined, for example, in accordance with the MPEG standard. Therefore, high quality picture signal coding and decoding is enabled.

Hereinbefore, the configuration and the operation of the picture signal encoding apparatus and the picture signal decoding apparatus of the second embodiment through which the picture signal is transmitted while the coding selection signal is written in the user data area.

### Third Embodiment

Next, an explanation will be given of a third embodiment, where a coding selection signal is transmitted using electronic watermark data embedded by use of a quantization value defined, for example, in accordance with the MPEG standard.

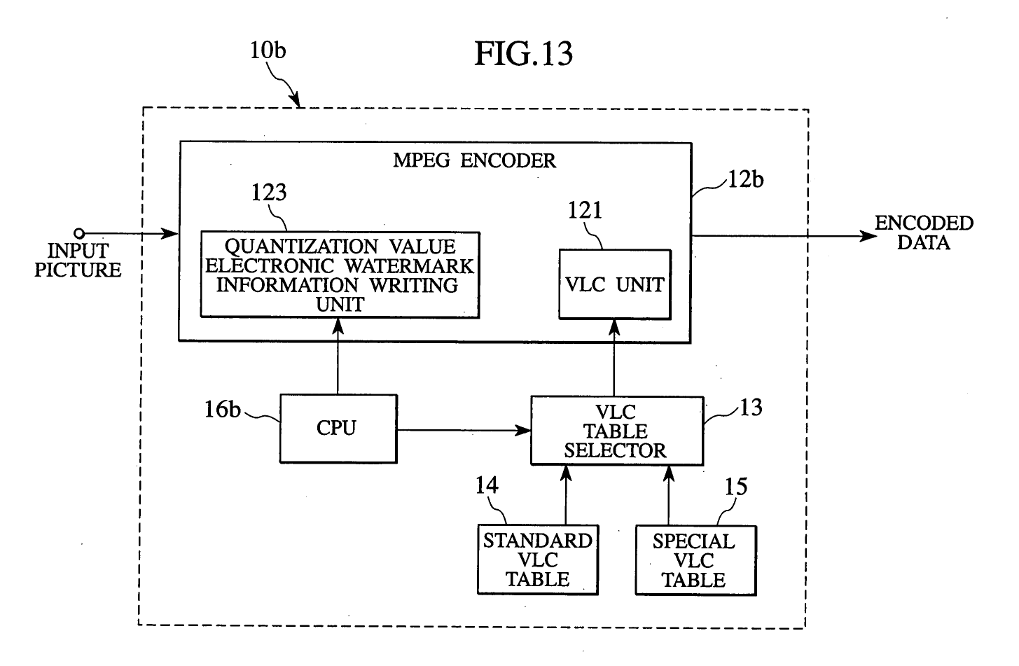

FIG. 13 shows the configuration of a picture signal encoding apparatus according to a third embodiment that employs the picture signal coding method. This configuration will be described below referring to FIG. 13.

A picture signal encoding apparatus 10b in FIG. 13 includes an MPEG encoder 12b, a VLC table selector 13, a standard VLC table 14, a special VLC table 15 and a CPU 16b. A VLC unit 121 and a quantization value electronic watermark information writing unit 123 are included in the MPEG encoder 12b.

The operation of the picture signal encoding apparatus 10b will be described mainly regarding the operation that differs from the one in the first embodiment

First, a coding selection signal supplied from the CPU 16b is supplied to the quantization value electronic watermark information writing unit 123 of the MPEG encoder 12b. Herein, a DCT transform is performed for information concerning the coding selection signal as electronic watermark information, and written as a quantization value for an input picture thus obtained.

The VLC table selector 13 selects a VLC table based on the coding selection signal supplied from the CPU 16b, and supplies the selected VLC table to the VLC unit 121. Then, the VLC table stored in the VLC unit 121 is employed for variable length coding of the input picture data in which the coding selection signal has been written and embedded by the quantization value electronic watermark information writing unit 123. Thereafter, the data thus compressed and encoded is outputted by the picture signal encoding apparatus 10b.

Next, an explanation will be given of embedding and writing of the electronic watermark information performed by the quantization value electronic watermark information writing unit 123.

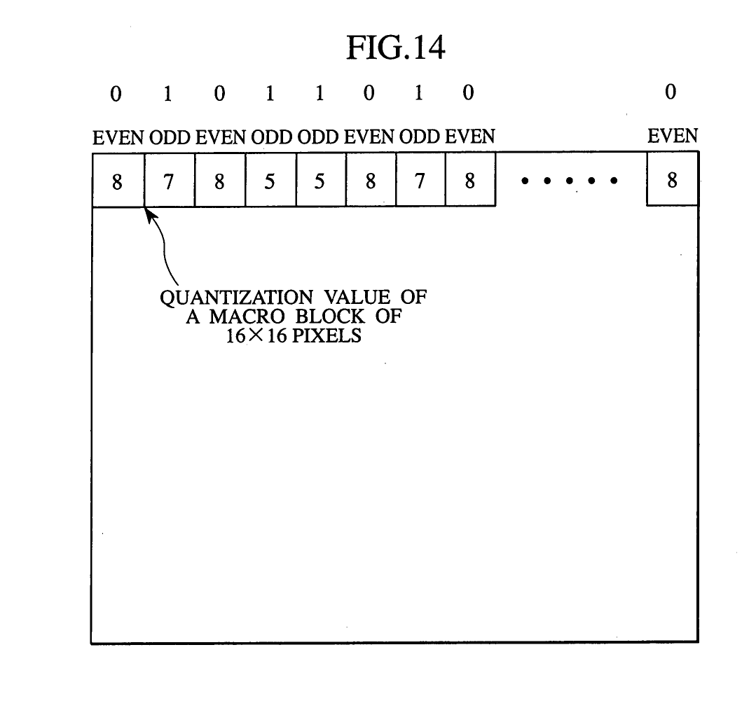

FIG. 14 shows an example where electronic watermark information is written as a quantization value obtained through the DCT transform.

In FIG. 14, an entire picture is indicated by a large square, and macro blocks of 16×16 pixels each are indicated by small squares. Numbers in the small squares represent example quantization values that are used to quantize the data for the macro blocks.

In this embodiment, when a quantization scale value, which is defined by the MPEG standard and set for each macro block, is an odd number, a “1” is embedded as the electronic watermark information, and when the quantization scale value is an even number, a “0” is embedded. That is, depending on whether the quantization value for a macro block is an odd or an even number, a “1” or a “0” can be embedded as data as much as the number of macro blocks.

The MPEG standard defines that the quantization value of a macro block be represented as a value from 1 to 31 (five bits). When a predetermined odd-numbered or even-numbered quantization value is intentionally set and a quantization value which differs by one from the value of optimal coding is used for compressing and coding, it is confirmed by experiment that the decoded picture obtained by decoding the encoded data is an image having no visual image quality deterioration.

By using the information thus embedded by the quantization value electronic watermark information writing unit 123, a coding selection signal which can be transmitted as a single bit may be transmitted by use of only the macro block that is transmitted first. Further, the same data may be transmitted by using a macro block of a specific address or by repetitively using a plurality of macro blocks.

An explanation has been given of the configuration and the operation of the picture signal encoding apparatus in the third embodiment, in which the coding selection signal is encoded by embedding it using the quantization value electronic watermark information writing unit 123.

Next, description will be made regarding the decoding of the encoded data thus generated.

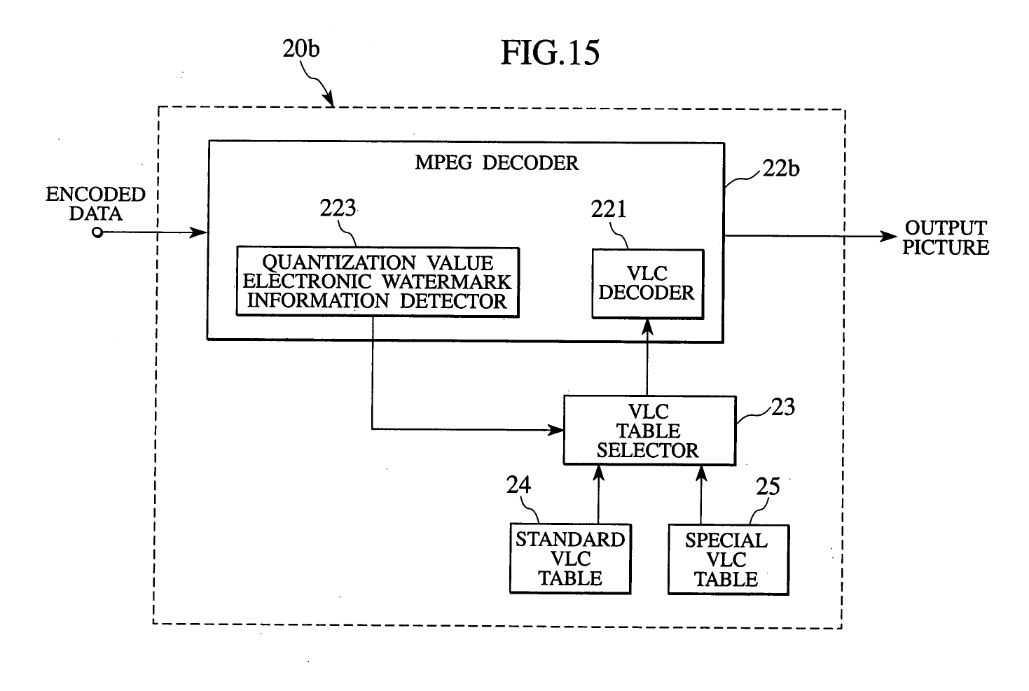

FIG. 15 shows an example of the configuration of a picture signal decoding apparatus according to the third embodiment, in which the data encoded by the picture signal encoding apparatus in the third embodiment is decoded. This configuration will be described with reference to FIG. 15.

FIG. 15 shows a picture signal decoding apparatus 20b which includes an MPEG decoder 22b, a VLC table selector 23, a standard VLC table 24, and a special VLC table 25. A VLC decoder 221 and a quantization value electronic watermark information detector 223 are included in the MPEG decoder 22b.

Next, the operation of the picture signal decoding apparatus 20b thus configured will be described mainly for the operation which differs from the one performed by the decoding apparatus 20 of the first embodiment.

First, data compressed and encoded by the picture signal encoding apparatus 10b is supplied to the MPEG decoder 22b. The MPEG decoder 22b decodes the signal that is compressed and encoded in accordance with the MPEG method by use of the value of a VLC table, which is temporarily stored in the VLC decoder 221.

Then, to obtain picture data, an inverse quantization and an inverse DCT transform are performed for part of the decoded quantization information. The remainder of the information is supplied to the quantization value electronic watermark information detector 223. The quantization value electronic watermark information detector 223 detects the information written by the quantization value electronic watermark information writing unit 123 to obtain the coding selection signal.

This coding selection signal is supplied to the VLC table selector 23. Then, based on the supplied coding selection signal, i.e. the coding selection signal outputted from the CPU 16b, the VLC table selector 23 selects the value of VLC table stored in either the standard VLC table 24 or the special VLC table 25. Thereafter, the selected VLC table value is supplied to the VLC decoder 221 to be temporarily stored.

Hereinbefore, an explanation has been given of the configuration and the operation of the picture signal encoding apparatus according to the third embodiment, in which the coding selection signal is written and transmitted by setting the quantization values for the respective macro blocks to odd numbers and even numbers, and of the configuration and the operation of the picture signal decoding apparatus that decodes the encoded data transmitted from the above encoding apparatus.

### Fourth Embodiment

An explanation will now be given of a fourth embodiment where a coding selection signal is embedded and transmitted as electronic watermark data in the value of a motion vector defined in accordance with the MPEG standard.

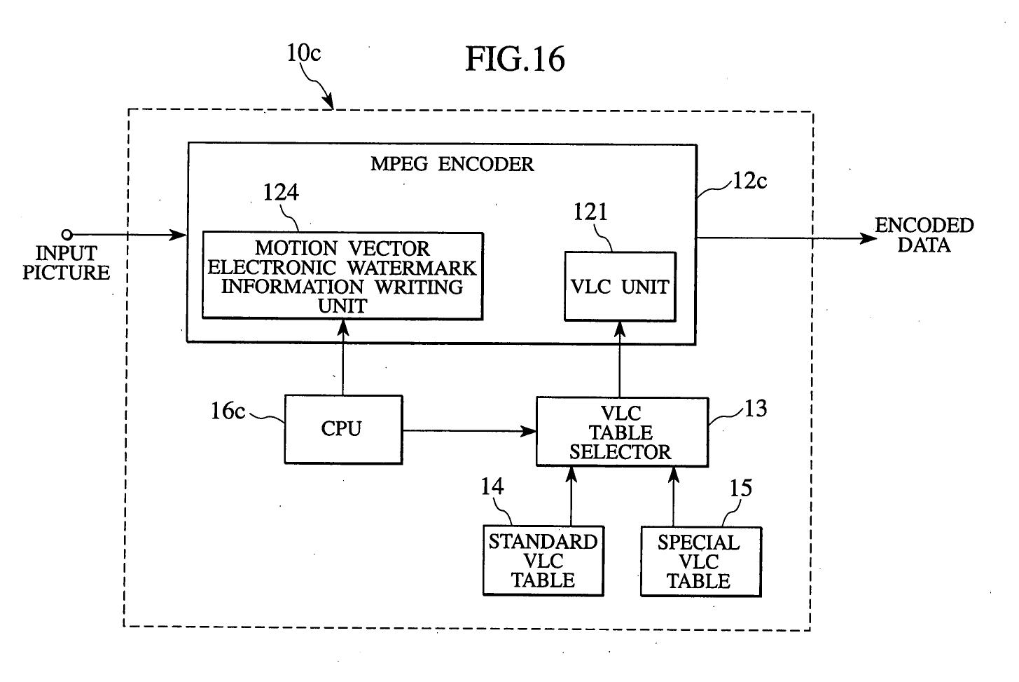

FIG. 16 is a block diagram showing the configuration of a picture signal encoding apparatus according to the fourth embodiment on which a picture signal encoding method is mounted. This configuration will now be explained referring to FIG. 16.

A picture signal encoding apparatus 10c in FIG. 16 includes an MPEG encoder 12c, a VLC table selector 13, a standard VLC table 14, a special VLC table 15 and a CPU 16c. A VLC unit 121 and a motion vector electronic watermark information writing unit 124 are included in the MPEG encoder 12c.

Next, the operation of the picture signal encoding apparatus 10c thus configured will be described mainly regarding the operation that differs from the one in the first embodiment.

In the picture signal encoding apparatus 10c, a coding selection signal supplied from the CPU 16c is supplied to the motion vector electronic watermark information writing unit 124 of the MPEG encoder 12c. The motion vector electronic watermark information writing unit 124 writes the information related to the coding selection signal as a motion vector value that is electronic watermark information used for the motion prediction encoding.

Thereafter, the VLC table selector 13 selects a VLC table based on the coding selection signal supplied from the CPU 16c, and supplies the selected VLC table to the VLC unit 121. Further, the motion vector electronic watermark information writing unit 124 generates a motion vector signal into which the coding selection signal is written and embedded. Furthermore, based on the VLC table stored in the VLC unit 121, variable length coding is performed for the quantization value of the input picture data for which the DCT transform has been performed, and encoded data is generated. The motion vector signal and the encoded data thus generated are then output by the picture signal encoding apparatus 10c.

The electronic watermarking operation of embedding and writing performed by the motion vector electronic watermark information writing unit 124 will now be described.

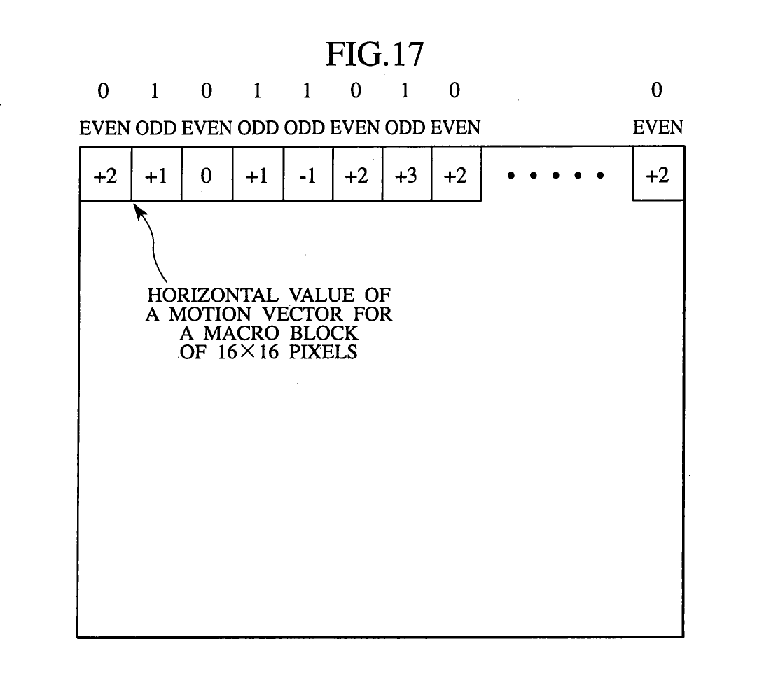

FIG. 17 is a diagram showing an example where electronic watermark information is to be written in a motion vector obtained by the motion prediction detection.

In FIG. 17, an entire picture is indicated by a large square, and macro blocks of 16×16 pixels each are indicated by small squares. The numbers in the small squares indicate the motion vector values of the individual pixels that represent horizontal motion compensation vector amounts for macro block data.

Herein, when the motion vector value, which is defined by the MPEG standard and one value is set per macro block, is for example an odd number, the embedded information is “1” while “0” for an even number, and thus information of 0 and 1 is embedded. That is, depending on whether the motion vector value for a macro block is an odd number or an even number, a “0” or a “1” is embedded as data as much as the number of macro blocks. In this manner, electronic watermark information is written.

It is defined by, for example, the MPEG standard that the motion vector value of a macro block be basically represented by a value of ±16 (VLC), with an accuracy of 0.5 pixels. When the vector value is intentionally set in accordance with an odd number or an even number, i.e. when data is compressed and encoded by employing a motion vector value that differs by one from a predetermined vector value, it is confirmed by experiment that a decoded picture obtained by decoding the encoded data based on such a vector value has no visual deterioration in image quality.

By using the information embedded by the motion vector electronic watermark information writing unit 124, a coding selection signal that can be transmitted as a single bit may be transmitted by use of only one macro block that is transmitted first. Further, the same data may be transmitted by using one macro block of a specific address, or by repetitively using a plurality of macro blocks.

Hereinbefore, an explanation has been given of the configuration and the operation of the picture signal encoding apparatus in the fourth embodiment, in which the coding selection signal is encoded by being embedded using the motion vector electronic watermark information writing unit.

The decoding of the encoded data thus generated will now be described.

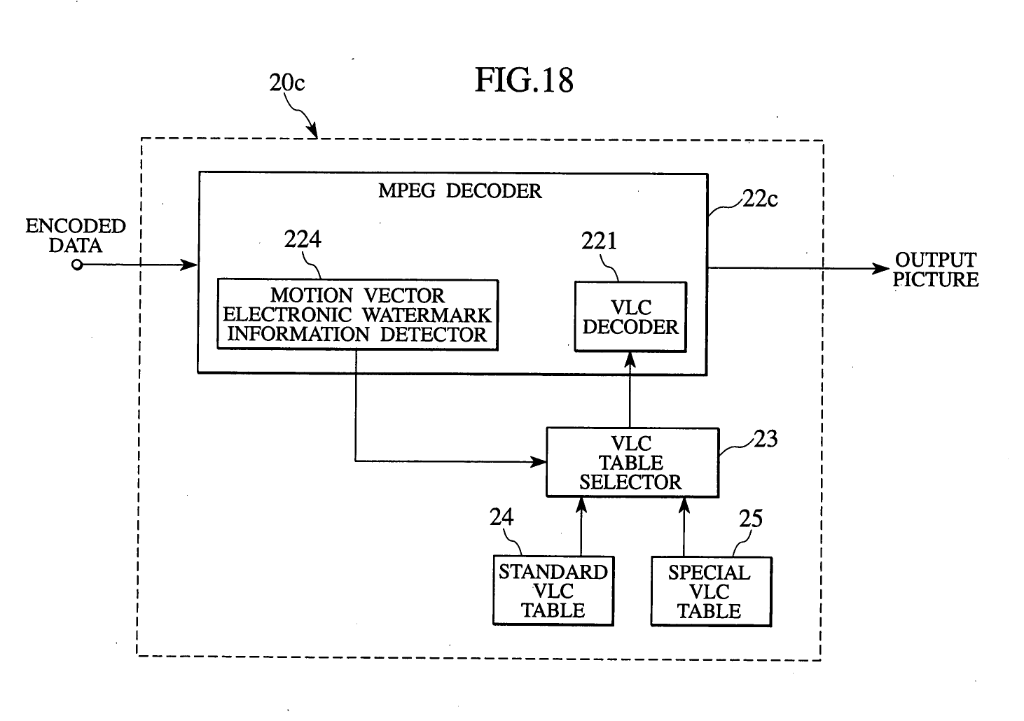

In FIG. 18, an example of the configuration of the picture signal decoding apparatus, which decodes the encoded data that is encoded by the picture signal encoding apparatus in the fourth embodiment, is shown, and will be explained with reference to the drawing.

The picture signal decoding apparatus 20c in FIG. 18 includes an MPEG decoder 22c, a VLC table selector 23, a standard VLC table 24, and a special VLC table 25. The MPEG decoder 22c includes a VLC decoder 221 and a motion vector electronic watermark information detector 224.

Next, the operation of the picture signal decoding apparatus will be described.

First, the encoded data containing motion vector information that is compressed and encoded by the picture signal encoding apparatus 10c is transmitted to the MPEG decoder 22c.

Then, the motion vector information is supplied to the motion vector electronic watermark information detector 224, which detects the coding selection signal embedded in the motion vector. Thereafter, the motion vector electronic watermark information detector 224 supplies the detected coding selection signal to the VLC table selector 23. Together with this, the transmitted motion vector information is employed to decode the signal compressed and encoded in accordance with the MPEG method. Thus, a picture signal is obtained. Then, the obtained picture signal is outputted by the picture signal decoding apparatus 20c.

As is described in the first to the fourth embodiments, the coding selection signal can be transmitted by employing a method for embedding the coding selection signal as electronic watermark information in the picture signal data, a method for writing the coding selection signal in a predetermined user data write area, a method for embedding the coding selection signal as quantization value electronic watermark information, and a method for embedding the coding selection signal as motion vector electronic watermark information.

Further, for the transmission of the coding selection signal, one of these four methods may be employed, or two or more are employed for a simultaneous transmission. Furthermore, another transmission method may be employed whereby coding selection signal value is transmitted based on electronic watermark information by writing and transmitting information through which coding selection signal information is transmitted according to user data.

In such a matter described above, the coding selection signal can be transmitted from the picture signal encoding apparatus to the picture signal decoding apparatus.

The VLC tables that are switched in accordance with the coding selection signal will now be explained.

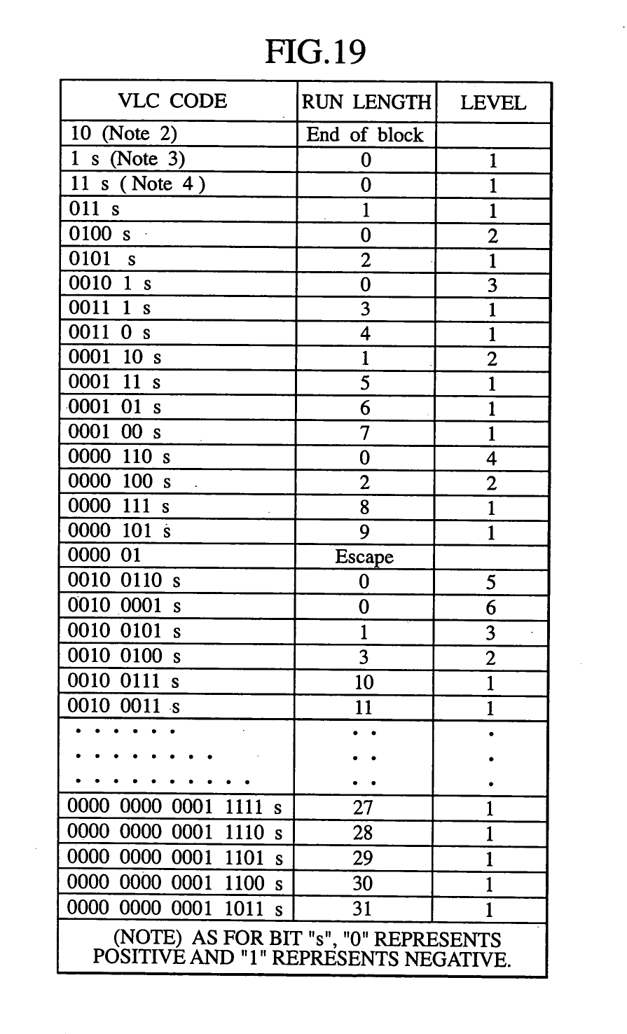

FIG. 19 is a diagram showing a standard VLC table defined by the MPEG standard.

Shown in FIG. 19 is a relationship between a run length and a level relative to a VLC code. Specifically, this table is a variable length coding table for encoding a data string that is to be transmitted and represented by using six bits numbers from “−31” to “+31.” Especially for a data string that contains many values of “0,” the number of continuous “0s” is regarded as a run length, and a value to be transmitted following these “0s” is regarded as a level. The VLC code is allocated in accordance with the number of continuous “0s” and the value of the level to be transmitted following these.

The table in which the VLC code is allocated in this manner is stored in the common MPEG decoder, and is used to decode a bit stream that is encoded using the usual MPEG method.

The picture signal encoding apparatus shown in this embodiment performs the compression and encoding using a special VLC table, so that the picture signal decoding apparatus for a general copyright holder reproduces an image that is slightly deteriorated, while the picture signal decoding apparatus for a special copyright holder, for example, the one who has entered into a contract, can reproduce a high-quality image having no deterioration.

The special VLC table will now be described below.

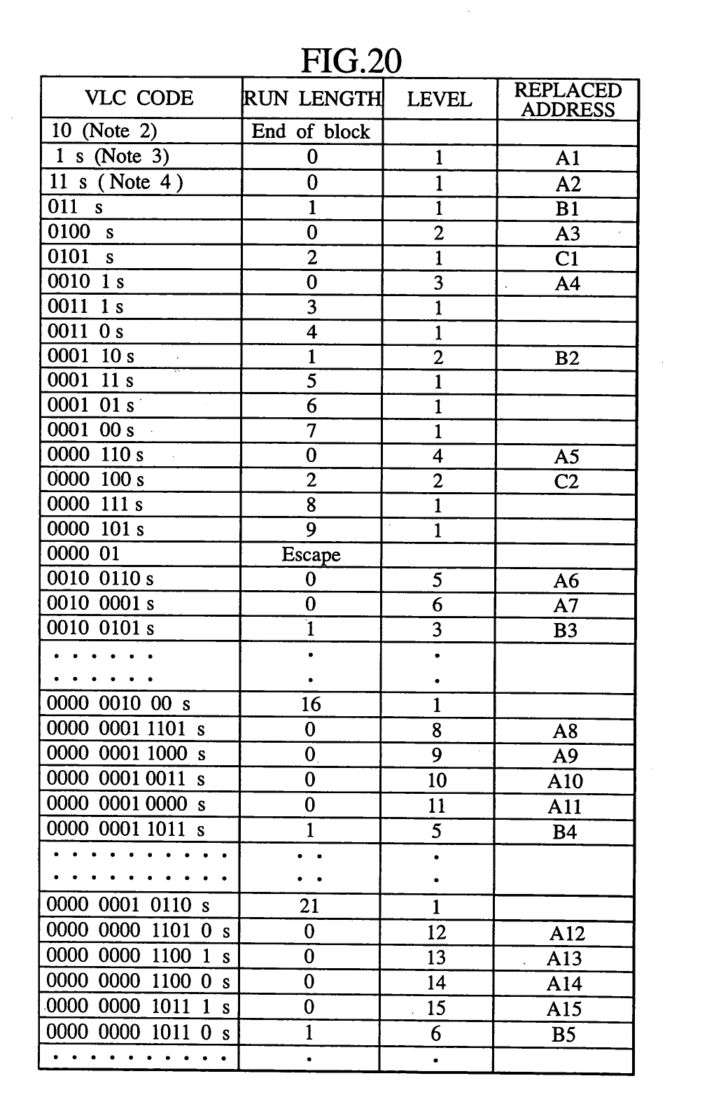

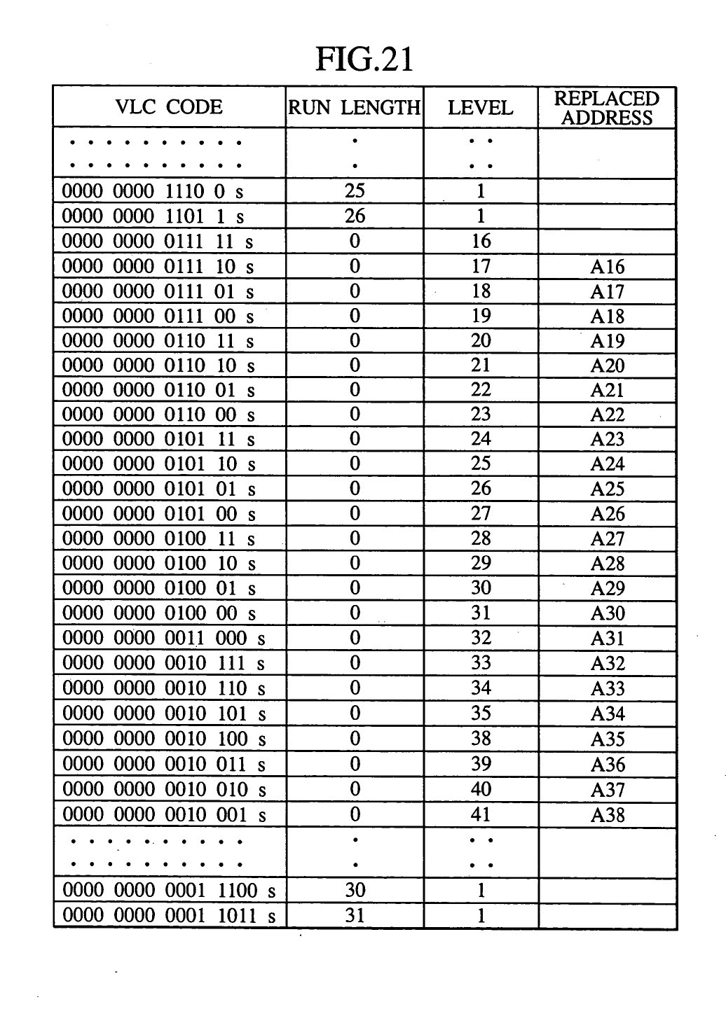

Examples of the special VLC table used in this embodiment are shown in FIGS. 20 and 21.

The VLC tables in the drawings are the special VLC tables shown by being divided into two segments.

In this table, a run length representing the total length of the continuous values of data “0” and the level representing the data value following the “0s” are provided for the defined VLC code. The addresses for replacement are shown in the rightmost column.

A1 to A38, B1 to B5 and C1 and C2 are written as the addresses for replacement. When using the table values as they are, the standard VLC table is employed for encoding. Moreover, by exchanging the addresses where the addresses for replacement are the same, the special VLC table can be generated.

The address replacement operation will now be described.

The A, B and C groups shown in the column of the addresses for replacement in this table represent the VLC categories, which are sorted into groups based on the values of the run lengths.

That is, group A represents the category for a run length of 0, B represents the category for a run length of 1 and C represents the category for a run length of 2. Here, only part of the VLC table is shown, however, groups of other run lengths are formed in the same manner.

In the special VLC table, the address values designating the VLC codes are exchanged by the VLC codes in the same category, i.e. having the same run length value.

For the compression and encoding system such as MPEG that performs the variable length coding on a coefficient value obtained by an orthogonal transform, e.g. coefficient value data obtained by zigzag scanning, the address replacement performed among the VLC codes that have the same run length is important, as an alteration that is performed while maintaining the number of data sets and the data arrangement.

That is, the total of the run lengths of the DCT coefficients in the MPEG DCT block should not exceed 63 for the intra image or 64 for the inter-image. It is because, when the total run length exceeds 63 or 64 as a result of address replacement while the VLC encoding conforms to the Huffman code system, it is assumed that an unreasonable error occurs during the decoding of an encoded signal to disable the decoding and the decoding of an encoded image fails.

Therefore, VLC codes in the categories to be exchanged should be exchanged for the same categories. In the example shown above, such exchanges are made for VLC codes represented by the same symbol of A, B or C, that is used to represent a category containing codes “having the same run length”. For example, the VLC codes for A2 and A3 can be exchanged, while the VLC codes for A2 and B2 cannot be exchanged.

As is described above, by the exchange of VLC codes within respective groups of replacement addresses A1 to A38, B1 to B5, or C1 and C2, the special VLC table can be generated based on the standard VLC table.

From among the VLC codes set by using a combination of a run length and level value and which occur often during the encoding of a normal image, when VLC codes whose level values differ greatly from each other are to be replaced, a partially disclosed image that is deteriorated by a predetermined degree is obtained by decoding. That is, in this case, a partially disclosed image means a deteriorated image, such as one that is distorted through the analog recording of a picture signal.

For example, when A1 and A4, or A2 and A3 are exchanged, an appropriately deteriorated and partially disclosed image is obtained. This also applies when B1 and B5, B2 and B4, or C1 and C2 are exchanged. Further, 32 to 64 types of exchange rules can be prepared for the combinations obtained by such exchanges, and identification signals can be employed as exchange regulations so that the image data is decoded in an image quality of a desired partially disclosed state.

The method employed for exchanging VLC codes based on replacement addresses has been described. The events for VLC codes having the same run length value are defined as those that conform to the MPEG standard. Therefore, a special decoder, on which the special VLC codes are mounted, performs an operation compatible with that of a conventional standard decoder.

Further, since VLC codes having the same run length but different level values are exchanged, when data encoded using the special VLC table is decoded by a standard decoder on which only the standard VLC table is mounted, an image is reproduced at a resolution changed due to a reduction or an increase in the high frequency signal level of a picture signal, or a reduction or an increase in the low frequency signal level.

This image resolution change will be described below.

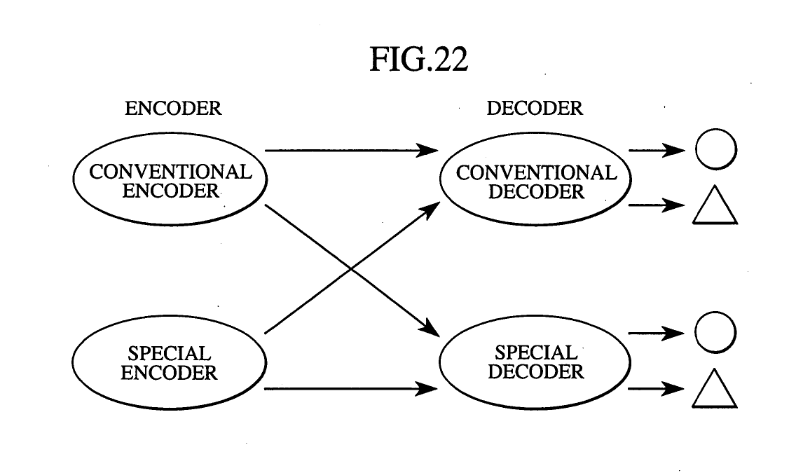

FIG. 22 is a diagram showing the encoding and decoding relationships between a conventional apparatus that uses a conventional standard VLC table and a special apparatus that includes both of a special VLC table and a standard VLC table. Referring to FIG. 22, an explanation will be given of the quality of a picture signal obtained by decoding by use of the decoder the data compressed and encoded by the encoder.

In FIG. 22, the qualities of images that are reproduced in four cases of combinations are shown, where “◯” represents that a high quality image is reproduced, and “Δ” represents that an image with a slightly deteriorated quality is reproduced.

That is, a low quality picture signal is outputted only when data is encoded using the special apparatus and the encoded data is decoded using the conventional apparatus. When data is encoded using the special apparatus and the encoded data is decoded using the special apparatus, a high quality image is reproduced, and compatibility with other conventional encoding apparatus can also be secured.

As is described above, since the quality of a reproduced image can be varied within a range where compatibility is ensured, in accordance with the will of the copyright holder of a picture signal, picture data having different qualities can be provided for the conventional decoder and the special decoder. Further, the operation of the picture signal encoding apparatus to generate a coding selection signal and embed this signal in the encoded data, and the operation of the picture signal decoding apparatus to obtain the coding selection signal and decode the encoded data are performed through the signal processing performed by a computer and controlled by a circuit section in the computer.

A method whereby a computer performs the signal processing in accordance with a program will now be described.

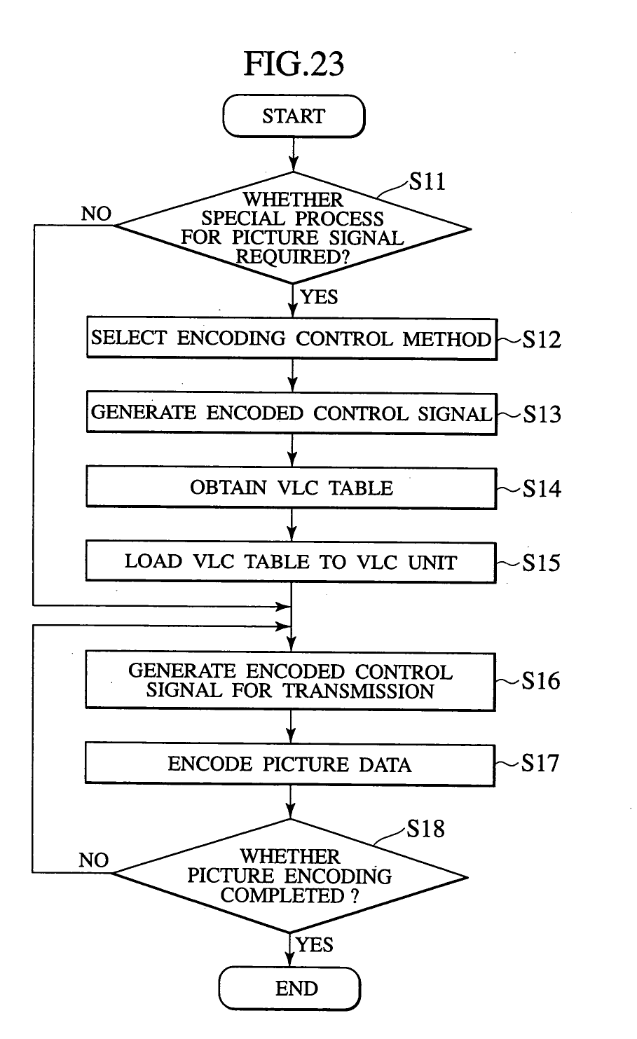

FIG. 23 is a flowchart to show a flow of a computer program that performs the encoding of a picture signal.

In FIG. 23, at step S11, a check is performed to determine whether special processing for a picture signal is to be performed so that picture data reproduced by a conventional decoder and by a special decoder will have different qualities. When special processing is performed, an encoding control method is selected at step S12 and an encoded control signal is generated by a computer at step S13.

The generated encoded control signal is supplied to the VLC table selector, and at step S14, the VLC table selector obtains the special VLC table. Then, at step S15, the obtained special VLC table is loaded onto the VLC unit of the MPEG encoder, and at step S16, an encoded control signal for transmission is generated to transmit the encoded control signal to the picture signal decoding apparatus.

The encoded control signal for transmission is generated using the method for the embedding the encoded control signal as electronic watermark information in the picture signal data, the method for writing the encoded control signal in a predetermined user data write area, the method for embedding the encoded control signal in the quantization value electronic watermark information, or the method for embedding the encoded control signal as the motion vector electronic watermark information.

The encoded control signal for transmission thus generated is transmitted with the encoded picture data. Moreover, by the MPEG encoder, for which the special VLC table is selected as a VLC table for the encoding of the picture data, at step S17, a DCT transform is performed for the picture signal and data of the quantization bits number is obtained. Then, the special VLC table is employed to perform the variable length coding on the obtained data of quantization bits number, and the encoded data is generated.

For the generation of such an encoded signal for transmission and the encoding of picture data, the processes at step S16 and S17 are repeated until the supply of picture data to be encoded is completed.

The encoded data thus obtained is decoded by the picture signal decoding apparatus. A computer program for activating the picture signal decoding apparatus will now be described.

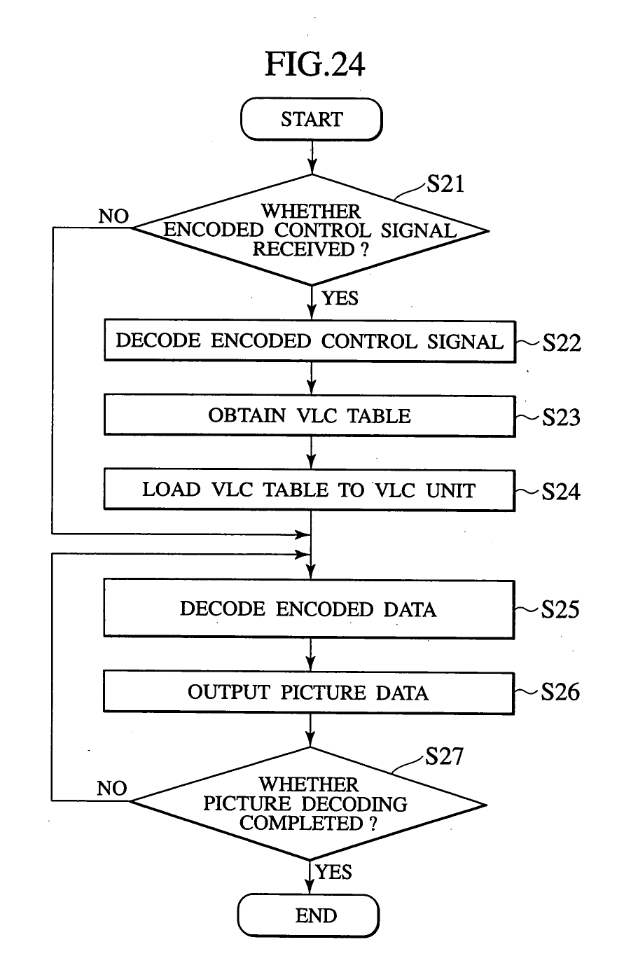

FIG. 24 is a flowchart showing a flow of the computer program that is executed to decode a picture signal.

In FIG. 24, at step S21, a check is performed to determine whether the information of the encoded control signal has been transmitted along with the encoded data to be supplied. When the encoded control signal has been included in the transmitted data, at step S22, the encoded control signal transmitted by being embedded in the encoded data is decoded and read.

Then, the control signal thus read is supplied to the VLC table selector, and at step S23, the special VLC table is obtained. Thereafter, at step S24, the obtained special VLC table is loaded onto the VLC decoder of the MPEG decoder.

Based on the loaded VLC table, the MPEG decoder performs the variable length decoding on the encoded data and the like to obtain picture data in which the supplied encoded data is decoded. Furthermore, the obtained picture data is supplied as an output signal by the picture signal decoding apparatus. The operations in step S25 and S26 are repeated until the supply of the encoded signal is completed.

As is described above in detail, when the picture signal encoding side intends to supply reproduction images of different image qualities between the decoding apparatus having the standard VLC table and the decoding apparatus having the special VLC table, it can employ a method whereby information related to the use of the special VLC table is embedded as electronic watermark information in the picture signal data, a method whereby the information is written in a predetermined user data write area, a method whereby the information is embedded as quantization value electronic watermark information, or a method whereby the is embedded as motion vector electronic watermark information.

Hereinbefore, an explanation has been given of the configurations and the operations of the picture signal encoding apparatuses and the picture signal decoding apparatuses in accordance with the first to the fourth embodiments.

Next, an explanation will be given of an example where these picture signal encoding apparatuses and decoding apparatuses are applied as transmission apparatuses and reception apparatuses.

### Fifth Embodiment

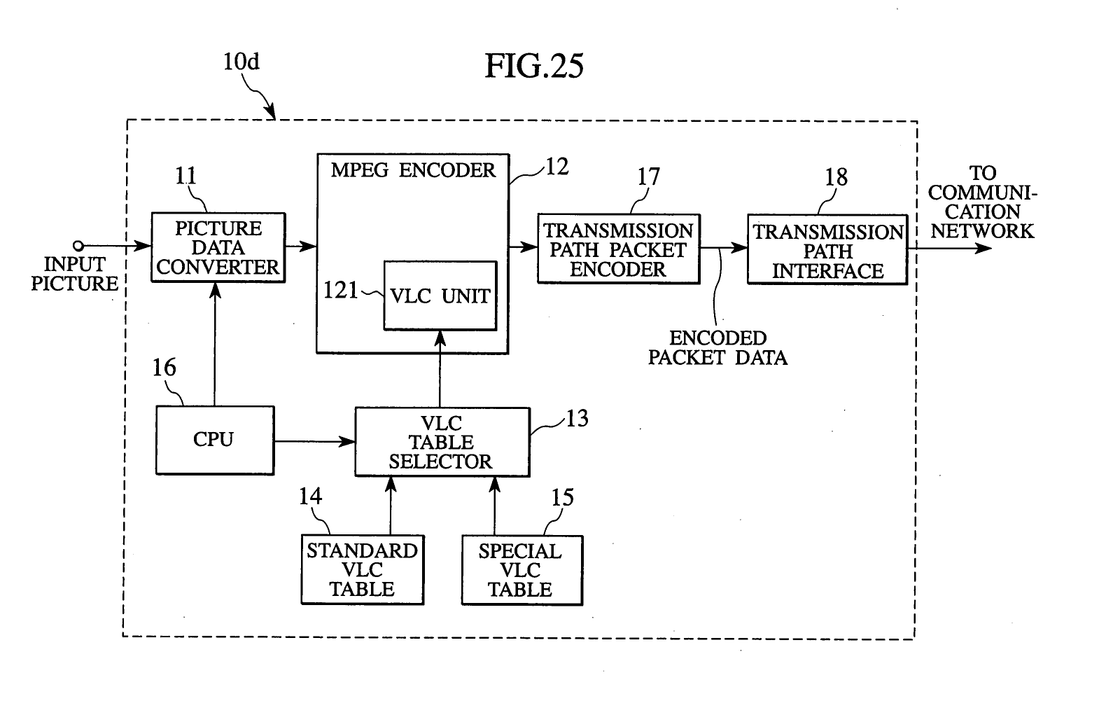

FIG. 25 shows the configuration of a picture signal encoding and transfer (transmission) apparatus according to a fifth embodiment of the invention. This configuration will now be described with reference to FIG. 25.

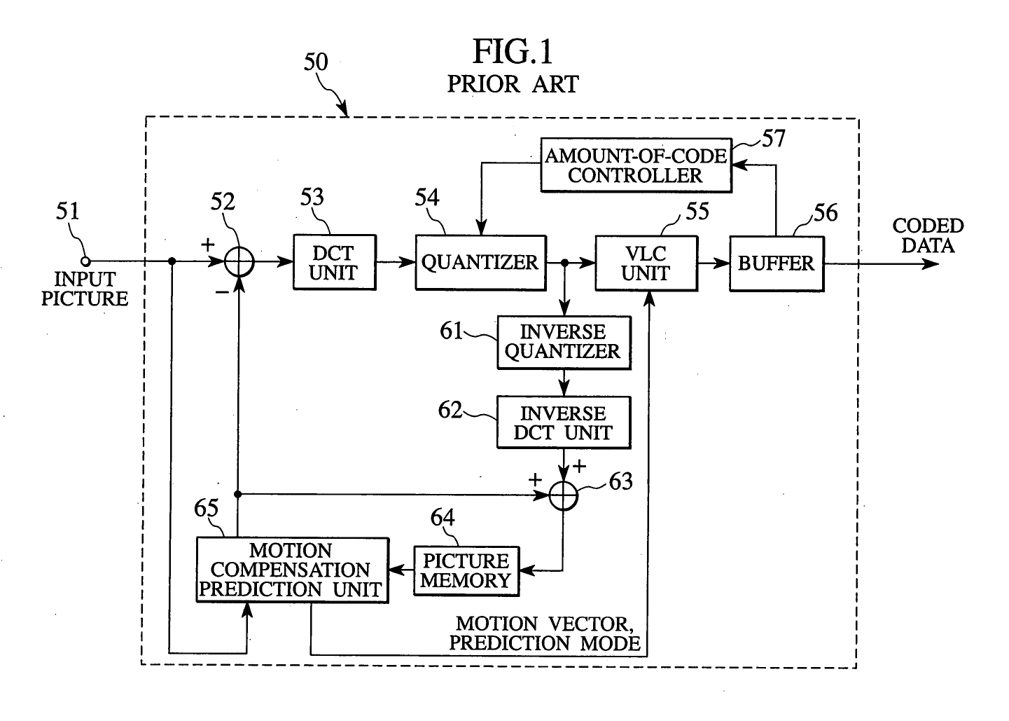

A picture signal encoding and transmission apparatus 10d in FIG. 25 differs from the picture signal encoding apparatus in FIG. 1 of the first embodiment in that a transmission path packet encoder 17 and a transmission path interface 18 are positioned following the output terminal of an MPEG encoder 12. The same reference numerals as in FIG. 1 are attached to the blocks having the same functions.

An explanation will now be given of the operation of the picture signal encoding and transmission apparatus 10d thus configured regarding points different from the first embodiment.

That is, a coding selection signal, which is a VLC table switch signal, is embedded as electronic watermark information, and a signal obtained by the MPEG encoder 12 through compression and encoding is supplied to the transmission path packet encoder 17.

The transmission path packet encoder 17 multiplexes the compressed and encoded signal so that a bit stream defined by the MPEG system, for example, can be supplied to the transmission path as a packet for each of the audio and the video information. The encoded packet data thus multiplexed is outputted through the transmission path interface 18 to a communication network by the picture signal encoding and transmission apparatus 10d. Thereafter, the transmitted multiplex signal is received by a picture signal decoding and reception apparatus.

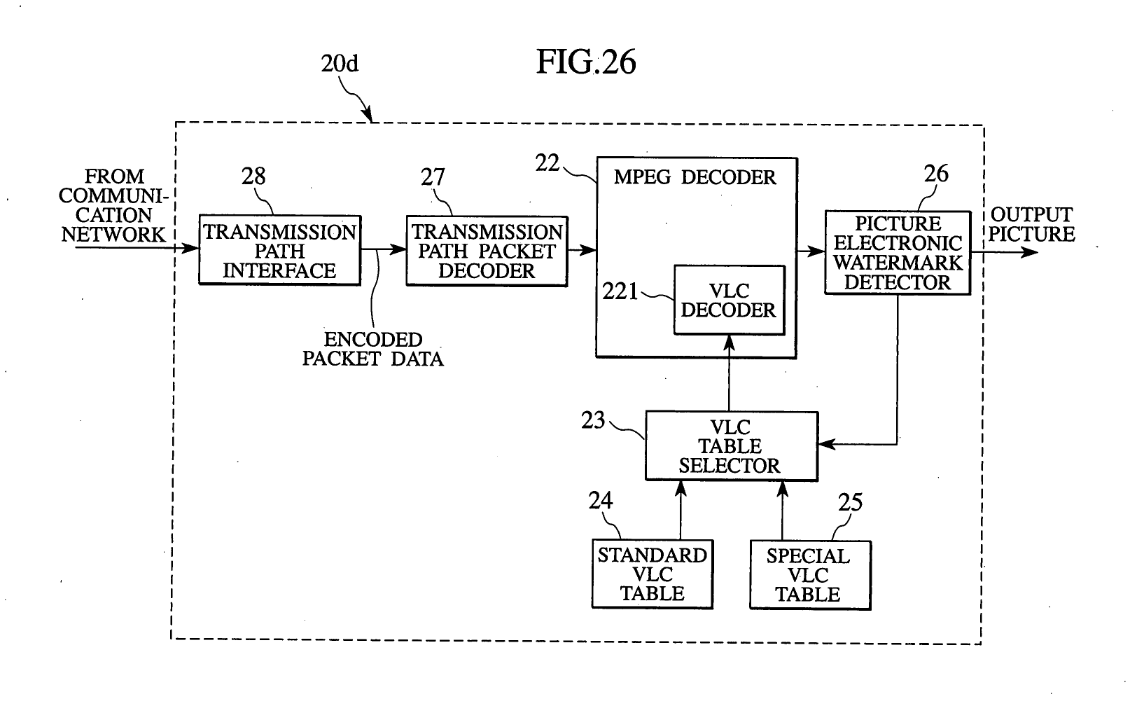

FIG. 26 shows the configuration of a picture signal decoding and reception apparatus according to the fifth embodiment. This configuration will now be described referring to FIG. 26.

A picture signal decoding and reception apparatus 20d in FIG. 26 differs from the picture signal decoding apparatus in FIG. 7 of the first embodiment in that a transmission path packet decoder 27 and a transmission path interface 28 are arranged between the input terminal and an MPEG decoder 22. The same reference numerals as in the first embodiment are also attached to the blocks having the same functions.

An explanation will now be given of the operation of the picture signal decoding and reception apparatus 20d thus configured regarding the points different from the first embodiment.

That is, a compressed and encoded signal packet (encoded packet data) is received from the communication network through a transmission path interface 28, and is supplied to the transmission path packet decoder 27.

The transmission path packet decoder 27 performs a complementary process relative to the process performed by the above described transmission path packet encoder 17, and obtains a compressed and encoded signal. This signal is supplied to the MPEG decoder 22, and is decoded in the same manner as described above. The picture signal obtained through the decoding is outputted as an output picture.

Hereinbefore, an explanation has been given of the configurations and the operations of the picture signal encoding and transmission apparatus and the picture signal decoding and reception apparatus according to the fifth embodiment. These operations may be controlled and performed in accordance with a computer program.

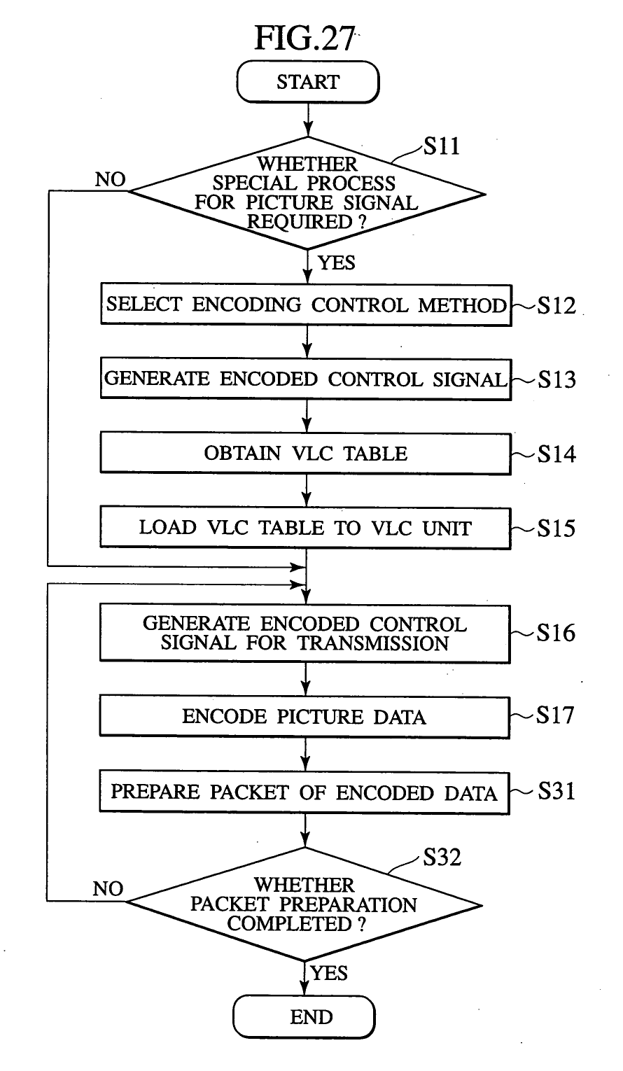

FIG. 27 is a flowchart showing a flow of a computer program according to the fifth embodiment that is executed for picture signal encoding and transmission.

In FIG. 27, the same step numbers are attached to the steps for performing the same processes as those in the flowchart of FIG. 23, and only those processes that differ from the fourth embodiment will now be described.

That is, in the fifth embodiment, the process following step S17 for picture data encoding is the process at step S31 for forming encoded data into a packet, and, at step S32, a check is performed to determine whether the packet forming process is completed.

The process at step S31 for forming encoded data into a packet corresponds to the process performed by the transmission path packet encoder 17 in FIG. 25 for generating, for example, an audio/video multiplexed bit stream. The bit stream thus generated is transmitted through the supply to the communication network. Furthermore, the packet forming process unique for the transmission path is also performed in order to transmit via the transmission path as needed, in accordance with the transmission condition defined for the transmission path.

For the generation of the encoded signal for transmission and the encoding of the picture data, the processes at steps S16, S17 and S31 are repeated until at step S32 forming of the encoded picture data into a packet is completed.

The encoded packet data thus obtained is sent out from the picture signal encoding and transmission apparatus 10d to the communication network to be received and decoded by the picture signal decoding and reception apparatus 20d.

The processing for receiving and decoding a picture signal shown as the fifth embodiment will now be described.

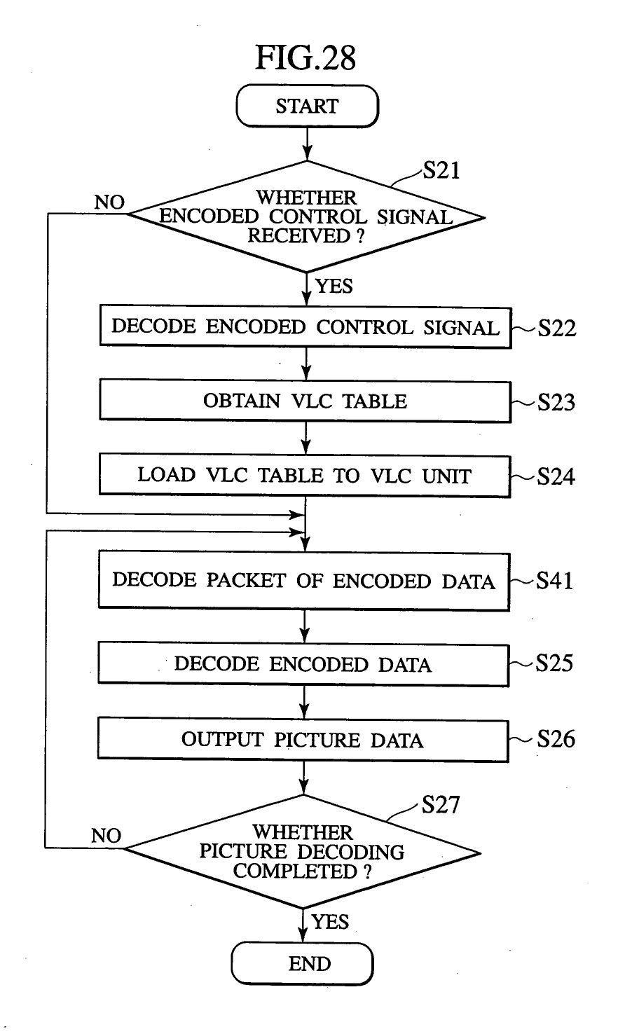

FIG. 28 is a flowchart showing the operation of a computer program according to the fifth embodiment that is executed for picture signal decoding and reception.

In FIG. 28, the same step numbers as used in the flowchart of FIG. 24 are attached to steps of the same processes, and only the different processes will be described below.

That is, in the fifth embodiment, the process following step S24 for loading the VLC table onto the VLC unit is the process at step S41 for decoding the packet of decoded data, and the data obtained through the packet decoding is passed to step S25 for decoding the encoded data.

Namely, the process at step S41 for decoding the packet of encoded data corresponds to the process performed by the transmission path packet decoder 27 in FIG. 26. For this decoding, the complementary signal processing operation relative to the operation of the transmission path packet encoder 17 in FIG. 25 is performed for the multiplexed and transmitted bit stream.

In this way, at step S25, the encoded data decoding process is performed for the signal obtained through the packet decoding. Thereafter, the processes at step S41, S25, S26 and S27 are repeated until it is determined as Yes that the picture decoding is completed at step S27.

Hereinbefore, an explanation has been given of the operations of the picture signal encoding and transmission apparatus and the picture signal decoding and reception apparatus in the fifth embodiment that are controlled and executed in accordance with the computer program.

As is described above in detail, when the decoding and reception apparatus that has only the standard VLC table and the decoding and reception apparatus that has both the standard VLC table and the special VLC table to be switched for the use are employed to decode the picture signal that is encoded by the encoding and transmission apparatus using the special VLC table, the decoding and reception apparatus can be realized as an apparatus that can reproduce images according to different desired qualities.

In addition, the information related to the use of the special VLC table can be transmitted by the method whereby the information is embedded as electronic watermark information into the picture signal data, the method for writing the information to a predetermined user data write area, the method for embedding the information as quantization value electronic watermark information, or the method for embedding the information as motion vector electronic watermark information.

Furthermore, to decode the compressed and encoded signal thus transmitted, the VLC table control signal is detected from the syntax defined by the MPEG standard which is the encoded signal transmission standard, and the VLC table used for encoding is detected based on the detected VLC table control signal. Then, the compressed and encoded signal is decoded by using the detected table so that a picture signal at a desired level of deterioration is obtained.

The VLC codes of the VLC tables which are switched for use are those present in, for example, the VLC code system defined by the MPEG standard which is the generally employed international standard. Further, a predetermined range should be maintained for the compatibility between the signal encoded by using the special VLC table and the signal encoded by using the standard VLC table. Thus, it is made possible that the VLC table is formed using these VLC codes, while the signal compatibility is secured for the apparatuses that conform to the MPEG standard popular in a large market.

Furthermore, the information related to the use of the special VLC table is transmitted by, for example, using one of, or two or more as needed, the user data defined according to the MPEG standard, the electronic watermark data mixed in the picture data, the electronic watermark data included by use of the quantization value, and the electronic watermark data embedded by such as using the motion vector value. Therefore, the picture signal encoding method has been realized, in which a plurality of security levels are set with respect to the desired contents to be encoded to perform the encoding.

An explanation has been given of, as an example of an encoding method, the MPEG2 video compression and encoding method for encoding a moving picture signal using the special VLC table instead of the standard VLC table.

Next, an explanation will be given of the compression and encoding of an audio signal using a standard VLC table and a special VLC table as similar to the above, and the decoding of the encoded data which is supplied after encoded.

First, the encoding and decoding of an audio signal by the MPEG-2 AAC (Advanced Audio Coding) method, which is a representative compression and encoding method for an audio signal, will be described.

### Sixth Embodiment

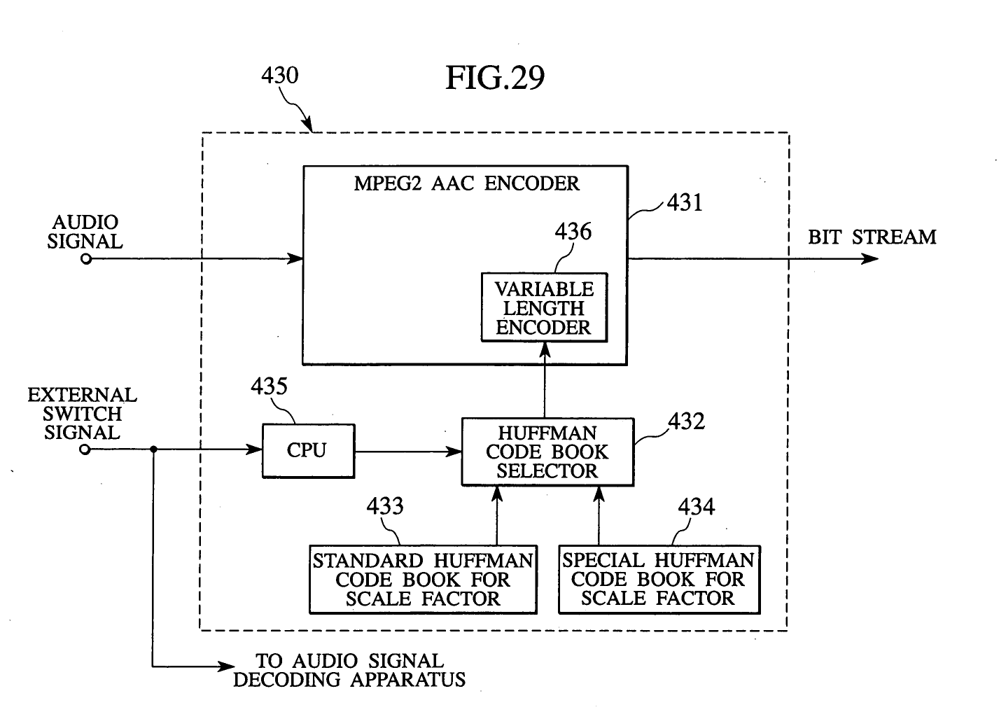

FIG. 29 is a block diagram showing the configuration of an audio signal encoding apparatus (hereinafter sometimes referred to simply as an encoding apparatus) according to a sixth embodiment of the invention. This configuration will now be explained while referring to FIG. 29.

In FIG. 29, an audio signal encoding apparatus 430 includes an MPEG-2 AAC encoder 431, a Huffman code book selector 432, a standard Huffman code book 433 for a scale factor, a special Huffman code book 434 for a scale factor and a CPU 435. The MPEG-2 AAC encoder 431 includes a variable length encoder 436 for performing variable length coding using a Huffman code book.

The MPEG-2 AAC encoder 431 has the same configuration as conventional, except in that the variable length encoder 436 receives a control signal to perform the variable length coding using a special VLC table in addition to a standard VLC table that is conventionally employed.

The Huffman encoding method is a method included in the VLC encoding system, and the Huffman code book is a coding table used for this encoding. Therefore, the concept of the Huffman code book is included in a VLC table according to a large definition.

The operation of the thus arranged audio signal encoding apparatus 430 will now be described.

An audio signal to be encoded is inputted to the MPEG-2 AAC encoder 431, and an external switch signal is inputted to the CPU 435. Upon receipt of the external switch signal, the CPU 435 generates a coding selection signal to change a Huffman code book.

That is, the CPU 435 generates a pseudo random number while employing the received external switch signal as an initial value. Or, when the external switch signal is received as one type of encrypted signal, the CPU 435 decrypts the external switch signal, and generates a coding selection signal that is a Huffman code book switch signal.

The coding selection signal outputted by the CPU 435 as the Huffman code book switch signal is supplied to the Huffman code book selector 432. When the coding selection signal received from the CPU 435 is set to, for example, “0”, the standard Huffman code book 433 for a scale factor is selected for encoding, and when the coding selection signal is set to “1”, the special Huffman code book 434 for a scale factor is selected for encoding.

That is, in accordance with the coding selection signal, the Huffman code book selector 432 selects either the standard Huffman code book 433 for a scale factor or the Huffman code book 434 for a scale factor, and supplies the selected Huffman code book to the variable length encoder 436.

The MPEG-2 AAC encoder 431 performs the variable length coding for the received audio signal based on the Huffman code book that is temporarily stored in the variable length encoder 436.

The Huffman code book for a scale factor will now be described.

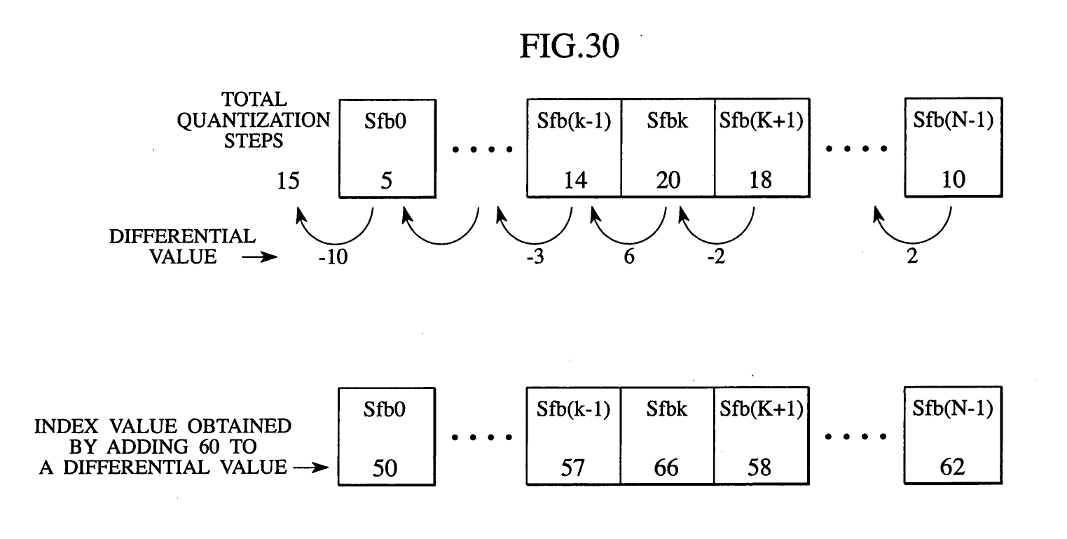

FIG. 30 is a diagram showing an example for obtaining a scale factor for a scale factor band (Sfb).

In FIG. 30, scale factors for N scale factor bands from 0 to (N−1) are shown in the upper portion, and corresponding index values are shown in the lower portion.

Specifically, the scale factors are calculated based on the auditory psychological analysis for an input audio signal by using the FFT, and coefficient value data that are obtained by the MDCT (Modified Discrete Cosine Transform). Then, a differential value between the scale factors is calculated, i.e., the (k−1)-th Sfb is subtracted from the k-th Sfb to obtain the differential value. Then, the variable length coding is performed using a value obtained by adding 60 to the offset value, so that the value (hereinafter called an index) corresponding to the Huffman code book for the scale factor is read out.

According to the Huffman code book for a scale factor, the index of 60 means the differential value between the scale factors is 0, and the Huffman code book is prepared by using a phenomenon that the appearance frequency is reduced as the absolute value of the differential value is increased.

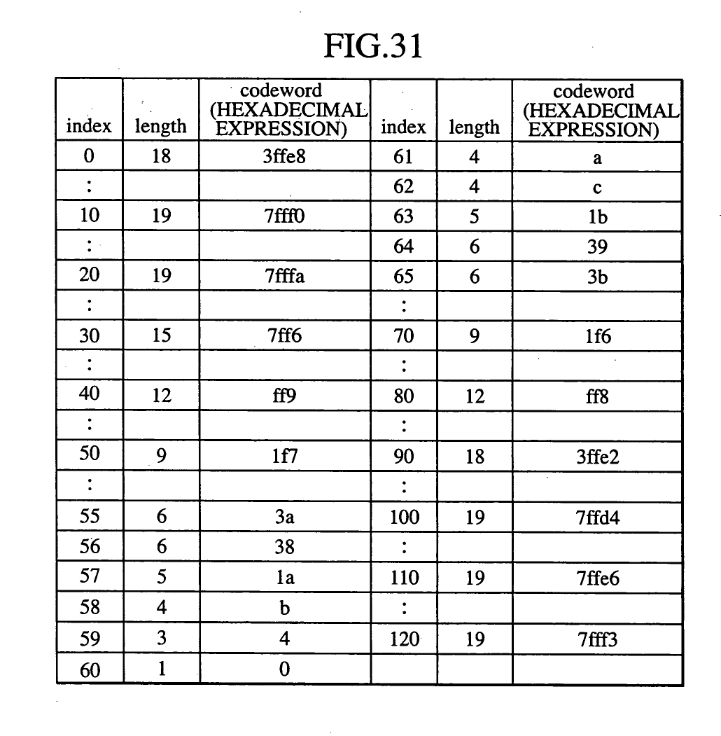

In FIG. 31, one part of the Huffman code book for a scale factor used for the MPEG-2 AAC encoding system is shown by using a table.

The Huffman code book for a scale factor provided in this table is employed as the standard Huffman code book 433. The special Huffman code book 434 for a scale factor is prepared by replacing the indexes of the standard Huffman code book 433.

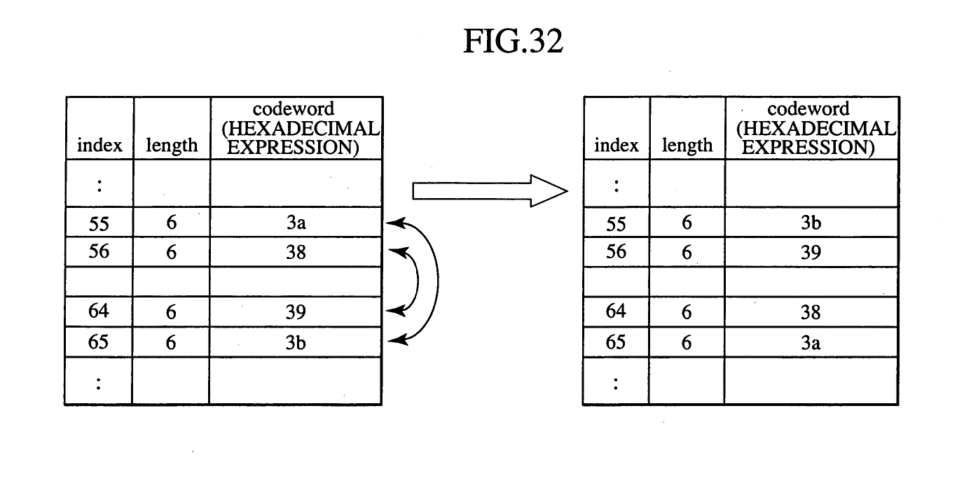

An example for an index exchanging method is shown in FIG. 32.

In FIG. 32, the table on the left shows one part of the standard Huffman code book and the exchange method, and the table on the right shows one part of the special Huffman code book prepared by exchanging the indexes.

Specifically, an index greater than index 60 and a smaller index that have the same code word length are exchanged with each other. For example, indexes 56 and 55 having the code word length of 6 are exchanged respectively with indexes 64 and 65 also having the code word length of 6, and the resultant table is used as the special Huffman code book.

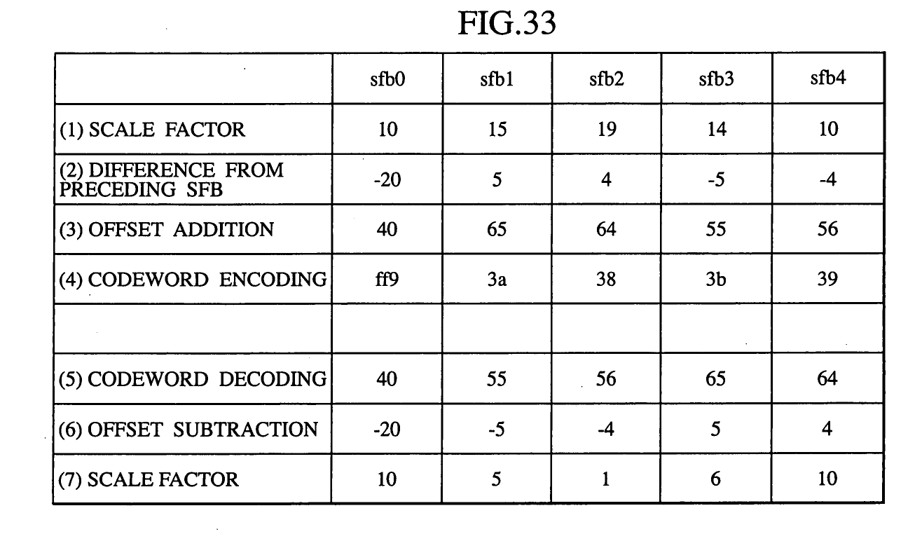

FIG. 33 is a diagram showing an example for a variable length coding for the scale factors using the above described Huffman code book.

In FIG. 33, (1) scale factors from sfb0 to sfb4 are defined as 10, 15, 19, 14 and 10, respectively. When (2) the total quantization step value is 30, differential values −20, 5, 4, −5 and −4 relative to the adjacent scale factors sfb are obtained to perform the variable length coding.

Then, (3) the offset value of 60 is added to the differential values, so that the individual scale factors are obtained as index values of 40, 65, 64, 55 and 56. At this time, since there is no preceding sfb for the first scale factor sfb0, the differential calculation is performed for the total quantization step value of 30.

When the standard Huffman code book shown in FIG. 31 is employed, code words ff9, 3b, 39, 3a and 38 are obtained. However, since the Huffman code book used in this case is the special Huffman code book where the code words have been exchanged, codewords ff9, 3a, 38, 3b and 39 in (4) are obtained. And these obtained data are employed to generate a bit stream.

The thus generated bit stream is supplied for decoding. When the normal decoder has only the standard Huffman code book of the MPEG-2 AAC encoding type, the variable length decoding is performed for the bit stream, and (5) the indexes of 40, 55, 56, 65 and 64 are obtained for the scale factors.

Following this, (6) the offset value of 60 is subtracted from these data values, and (7) 10, 5, 1, 6 and 10 are obtained as the scale factors. These values differ from the original scale factor values.

When the scale factors that differ from those used for encoding are employed to decode the encoded bit stream, a different audio signal is reproduced. Therefore, by using this method, the scramble processing can be performed to generate a semi-disclosed audio signal.

The decoding of a bit stream that is encoded in the above described manner will now be described.

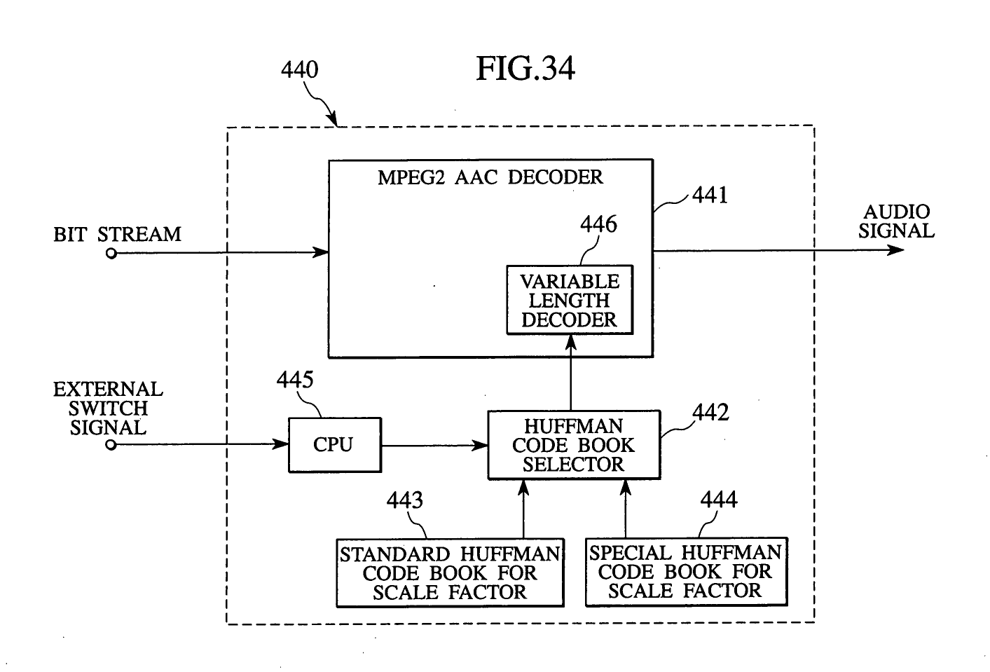

FIG. 34 is a diagram showing the configuration of an audio signal decoding apparatus (hereinafter sometimes referred to simply as a decoding apparatus) according to the sixth embodiment. This configuration will be described while referring to FIG. 34.

In FIG. 34, an audio signal decoding apparatus 440 includes: an MPEG-2 AAC decoder 441, a Huffman code book selector 442, a standard Huffman code book 443 for a scale factor, a special Huffman code book 444 for a scale factor and a CPU 445. The MPEG-2 AAC decoder 441 includes a variable length decoder 446 for performing the variable length decoding using the Huffman code book.

The MPEG-2 AAC decoder 441 has substantially the same configuration as conventional, except in that the variable length decoding is performed by using the special Huffman code book in addition to the conventional standard Huffman code book.

The operation of the thus arranged audio signal decoding apparatus 440 will now be described.

First, an external switch signal is supplied from the audio signal encoding apparatus 430 to the CPU 445.

The CPU 445 performs the same processing as performed by the CPU 435 of the audio signal encoding apparatus 430. Specifically, a coding selection signal that is a Huffman code book select signal is generated and supplied to the Huffman code book selector 442.

Next, a bit stream that has been compressed and encoded by the audio signal encoding apparatus 430 is supplied to the MPEG-2 AAC decoder 441. The MPEG-2 AAC decoder 441 decodes the signal compressed and encoded according to the MPEG-2 AAC using the value of the Huffman code book that is temporarily stored in the variable length decoder 446.

Next, based on the coding selection signal received from the CPU 445, the Huffman code book selector 442 selects the value of either the standard Huffman code book 443 for a scale factor or the special Huffman code book 444 for a scale factor, and supplies the selected Huffman code book value to the variable length decoder 446. The value of the Huffman code book is temporarily stored in the variable length decoder 446.

The MPEG-2 AAC decoder 441 decodes the received bit stream using the Huffman code book that is temporarily stored. Since the same Huffman code book as the one temporarily stored in the variable length encoder 436 of the MPEG-2 AAC encoder 431 is employed for decoding, the audio signal having high fidelity can be obtained through decoding.

However, when the special Huffman code book for a scale factor is not provided for the audio signal decoding apparatus, the standard Huffman code book for a scale factor that is prepared for the normal MPEG-2 AAC decoder is employed to decode the bit stream. Therefore, the decoded audio signal includes a distortion element based on the difference between the two Huffman code books.

An explanation has been given for the configurations and the operations of the audio signal encoding apparatus and the audio signal decoding apparatus according to the sixth embodiment that employ the standard Huffman code book and the special Huffman code book to perform the variable length coding for scale factors.

### Seventh Embodiment

An explanation will now be given for the configurations and the operations of an audio signal encoding apparatus and an audio signal decoding apparatus according to a seventh embodiment of the invention that employ a standard Huffman code book and a special Huffman code book to perform the variable length coding on a spectrum signal.

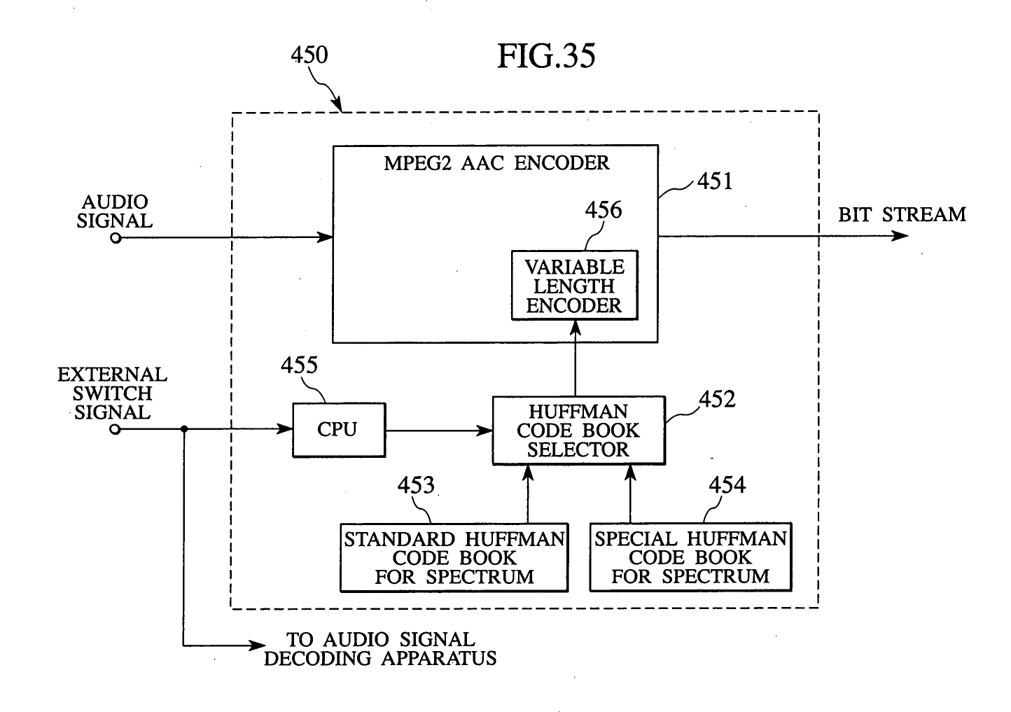

FIG. 35 is a block diagram showing the configuration of the audio signal encoding apparatus according to the seventh embodiment, and this configuration will be described hereafter while referring to FIG. 35.

In FIG. 35, the audio signal encoding apparatus 450 includes an MPEG-2 AAC encoder 451, a Huffman code book selector 452, a standard Huffman code book 453 for a spectrum, a special Huffman code book 454 for a spectrum and a CPU 455. The MPEG-2 AAC encoder 451 includes a variable length encoder 456 for performing variable length coding by using a Huffman code book.

The audio signal encoding apparatus 450 thus arranged differs from the audio signal encoding apparatus in FIG. 29 for the sixth embodiment in that, while a standard Huffman code book is employed for a scale factor, standard and special Huffman code books for a spectrum are employed for the variable length coding of an MDCT audio signal.

The operation of this audio signal encoding apparatus 450 will now be described.

First, an audio signal to be encoded is supplied to the MPEG-2 AAC encoder 451, and at the same time, an external switch signal is input to the CPU 455. While the external switch signal is supplied also to an audio signal decoding apparatus 460 that performs the complementary decoding operation relative to the audio signal encoding apparatus 450, which will be described later.

Based on the supplied external switch signal, the CPU 455 generates a coding selection signal that is a Huffman code book select signal. For example, the CPU 455 generates a pseudo random number while employing the external switch signal as an initial value. Or, when the external switch signal is supplied as one type of encrypted signal, the CPU 455 decrypts the external switch signal, and generates a coding selection signal that is a Huffman code book select signal.

Thereafter, the CPU 455 supplies the coding selection signal that is the Huffman code book select signal to the Huffman code book selector 452. When the coding selection signal supplied by the CPU 455 is set to “0”, for example, the standard Huffman code book for a spectrum is selected for encoding, and when the coding selection signal is set to “1”, the special Huffman codebook for a spectrum is selected for encoding.

In accordance with this coding selection signal, the Huffman code book selector 452 selects either the standard Huffman code book 453 for a spectrum or the special Huffman code book 454 for a spectrum, and supplies the selected Huffman code book to the variable length encoder 456.

The MPEG-2 AAC encoder 451 employs the Huffman code book temporarily stored in the variable length encoder 456 to perform the variable length coding on the spectrum signal of the input MDCT audio signal.

The Huffman code book for a spectrum will now be explained.

In performing variable length coding on the quantization value of a spectrum, based on the quantization values obtained for every two or four spectra in the sfb, a code word corresponding to the Huffman code book is read while referring to the index. There are eleven Huffman code books for a spectrum, and from them, a set of tables is selected for which the total amount of codes that are generated is minimum.

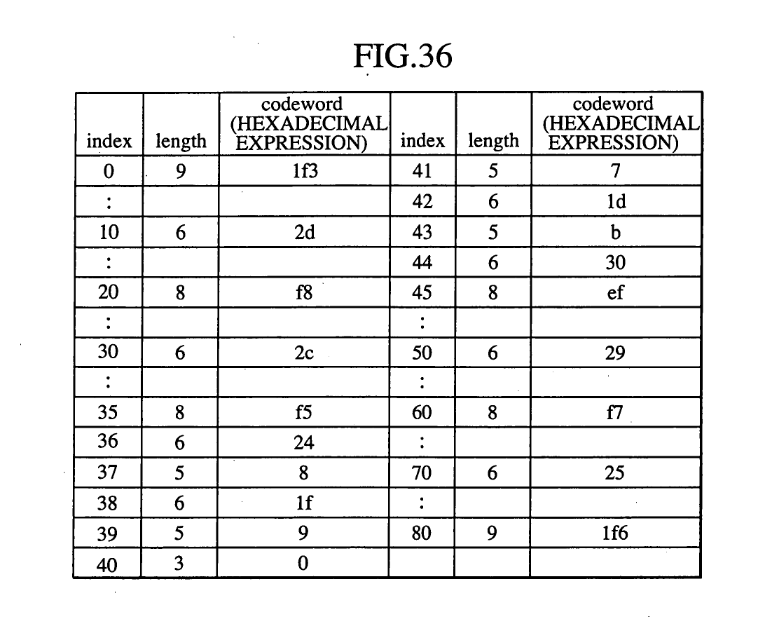

In FIG. 36, one part of the standard Huffman code book for a spectrum is shown by using a table.

The standard Huffman code book for a spectrum in FIG. 36 is one part of the code book used for the MPEG-2 AAC encoding system, and this code book shown in FIG. 36 is employed as the standard Huffman code book 453 for a spectrum. The special Huffman code book 454 is prepared by exchanging the indexes in the standard Huffman code book 453 for a spectrum.

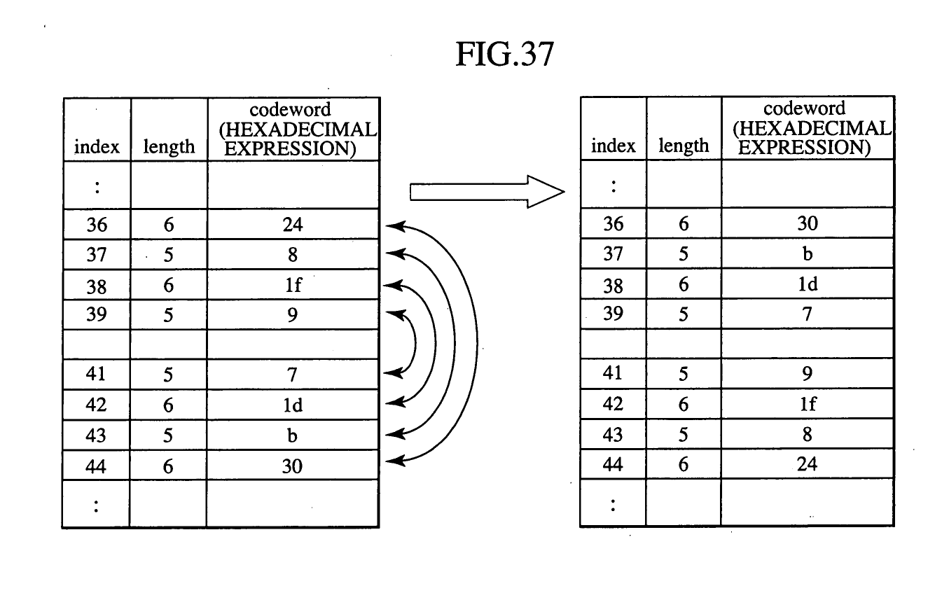

FIG. 37 is a diagram showing an example where the special Huffman code book is prepared by exchanging the code words in the standard Huffman code book.

The Huffman code book for a spectrum shown in FIG. 37 is one part of the second code book defined according to the AAC standard.

In this code book, a plurality of indexes having the same code word lengths are present above and below index 40. Therefore, for example, indexes 36 to 39 are exchanged with indexes 44 to 41 to prepare a new Huffman code book, and this code book is employed as the special Huffman code book.

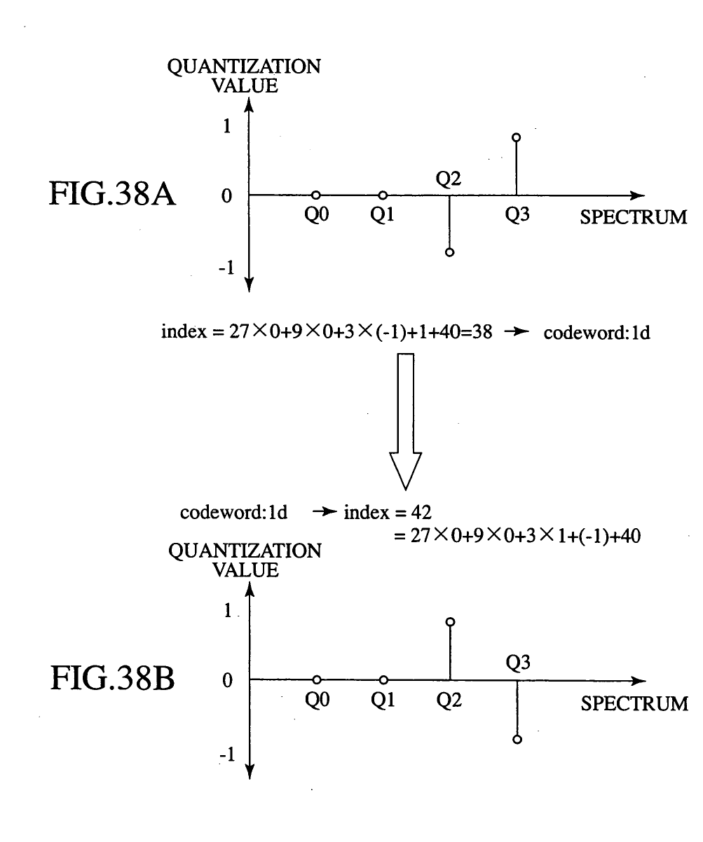

FIGS. 38A and 38B are diagrams showing an example of variable length coding on quantization values for a spectrum using the above described Huffman code book.

In FIGS. 38A and 38B, four quantization values are 0, 0, −1 and 1 respectively, and the transform of these values into an index will be explained.

When the second Huffman code book according to the AAC standard is employed, the following equation (1) is used for the transform of four spectra Q0 to Q3 into an index (IDX):

IDX=27×Q0+9×Q1+3×Q2+Q3+40 (1)

The values of 0, 0, −1 and 1 are substituted into Q0 to Q3.

Then, the index value of the spectra in FIG. 38A is

IDX=27×0+9×0+3×(−1)+1+40=38,

and a corresponding code word is read out from the new second Huffman code book that is obtained by exchanging the indexes based on this index value.

That is, the code word is 1d for the index value of 38 in the special Huffman code book, and this value is read out. Based on this value, a bit stream is generated by encoding the audio signal, and is output from the audio signal encoding apparatus 450.

Thereafter, the bit stream is supplied to and decoded by the audio signal decoding apparatus.

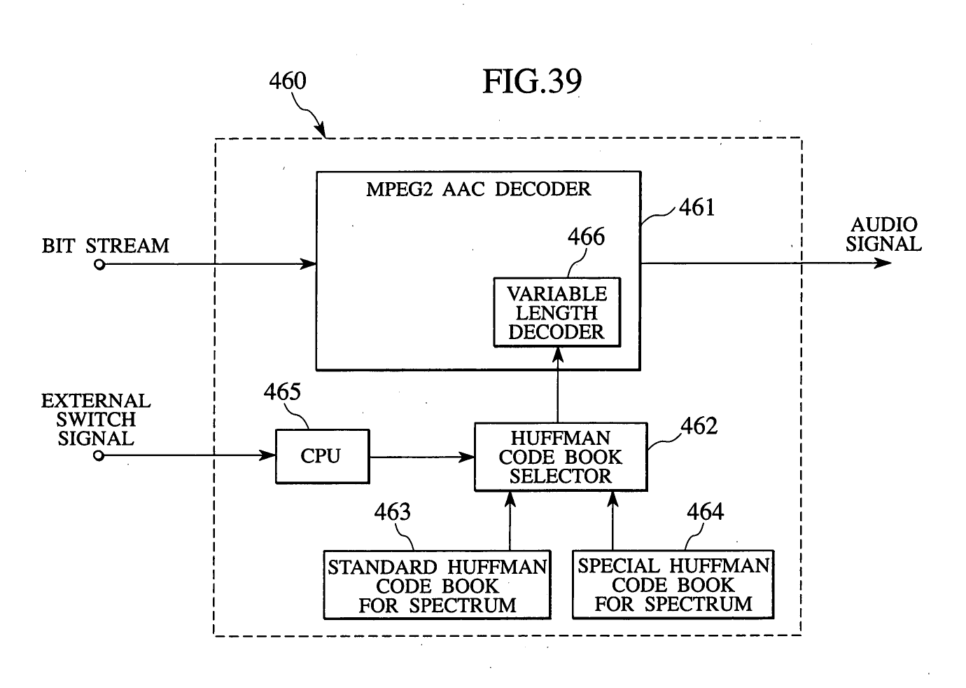

FIG. 39 is a block diagram showing the configuration of the audio signal decoding apparatus according to the seventh embodiment, and this configuration will be described while referring to FIG. 39.

The audio signal decoding apparatus 460 includes an MPEG-2 AAC decoder 461, a Huffman code book selector 462, a standard Huffman code book 463 for a spectrum, a special Huffman code book 464 for a spectrum and a CPU 465. The MPEG-2 AAC decoder 461 includes a variable length decoder 466 for performing variable length decoding by using the Huffman code book.

The audio signal decoding apparatus 460 thus arranged differs from the audio signal decoding apparatus 440 in FIG. 34 for the sixth embodiment in that, while the standard Huffman code book is employed for a scale factor, both standard and special Huffman code books are employed for a spectrum.

The operation of this audio signal decoding apparatus 460 will now be described.

First, a bit stream compressed and encoded by the audio signal encoding apparatus 450 is supplied to the MPEG-2 AAC decoder 461.

An external switch signal transmitted from the audio signal encoding apparatus 450 is supplied to the CPU 465. The CPU 465, as well as the CPU 455 of the audio signal encoding apparatus 450, performs the processing on the supplied signal, and then, generates a coding selection signal that is a Huffman code book select signal. This signal is supplied to the Huffman code book selector 462.

Based on the coding selection signal supplied from the CPU 465, the Huffman code book selector 462 selects the value of either the standard Huffman code book 463 for a spectrum or the special Huffman code book 464 for a spectrum, and supplies the selected Huffman code book to the variable length decoder 466. The value of the Huffman code book is temporarily stored in the variable length decoder 466.

Then, the MPEG-2 AAC decoder 461 decodes the supplied bit stream by using the Huffman code book that is temporarily stored in the variable length decoder 466.

Since the same Huffman code book as temporarily stored in the variable length encoder 456 of the MPEG-2 AAC encoder 451 is employed for decoding, a high-quality audio signal can be obtained through decoding.

However, when the audio signal decoding apparatus does not include the special Huffman code book for a spectrum, the standard Huffman code book provided for the common MPEG-2 AAC decoder is employed to decode the bit stream. Therefore, the decoded audio signal includes a distortion component that is consonant with the difference between the two Huffman code books.

For example, as is described above, a value of 38 is obtained as an index relative to the four quantization values of 0, 0, −1 and 1. When the variable length coding is performed on this index value by using the special Huffman code book and the variable length decoding is performed using the standard Huffman code book, the index value of 42 is obtained.

This decoding process is shown in FIG. 38B. In this case, the index value 42 is obtained through the calculation using Q0=0, Q1=0, Q2=1 and Q3=−1. That is, the four quantization values are obtained as 0, 0, 1 and −1, which differ from those values of the original quantization of the spectra.

When the inverse quantization and the IMDCT (Inverse Modified Discrete Cosine Transform) are performed on the quantization values thus obtained to decode the audio signal, the original signal can not be reproduced. That is, the audio signal thus decoded is reproduced as the one for which the pseudo audio scramble process has been performed.

An explanation has been given for the configurations and operations of the audio signal encoding apparatus and the audio signal decoding apparatus according to the seventh embodiment that employ the standard Huffman code book and the special Huffman code book to perform the variable length coding on the MDCT audio signal.

In addition, in this embodiment, the second Huffman code book for a spectrum according to the AAC standard has been employed as an example. There are eleven types of Huffman code books for a spectrum, and the special Huffman code book may be prepared for each of these code books, or for arbitrary Huffman code books, to perform variable length coding.

Further, from among the eleven Huffman code books, Huffman code books 1 and 2, Huffman code books 3 and 4, Huffman code books 5 and 6, Huffman code books 7 and 8, and Huffman code books 9 and 10 are prepared as pairs, and the numbers of code words included in the code books belonging to each pair are same to each other. Therefore, since the same equation for the transform into the index is employed for each pair, the Huffman code books in a pair can be employed as the standard and the special Huffman code books, e.g., Huffman code book 2 is used as the special Huffman code book relative to the code book 1. This method may also be employed to provide the standard and special Huffman code books.

An explanation has been given for the configurations and operations of the apparatuses that switch between the standard and special Huffman code books in accordance with the external switch signal to perform the encoding. It is also necessary for this embodiment that the external switch signal should be supplied from the audio signal encoding apparatus to the audio signal decoding apparatus so that a user is inhibited to freely operate the scramble for the audio signal. That is, in order to ensure the execution of the scramble, the external switch signal generated by the audio signal encoding apparatus should be encrypted.

Then, when the encrypted signal generated by the audio signal encoding apparatus is decoded by the CPU in the audio signal decoding apparatus, the obtained external switch signal can be employed to perform the variable length decoding.

There is another method. In the method, firstly, the audio signal encoding apparatus embeds the external switch signal into the MPEG-2 AAC bit stream as electronic watermark information. Then, the audio signal decoding apparatus extracts the electronic watermark information from the supplied MPEG-2 AAC bit stream, and generates a Huffman code book select signal based on the electronic watermark information.

Furthermore, to avoid separately transmitting the external switch signal and the bit stream, the electronic watermarking used for the picture signal encoding apparatus and decoding apparatus described above may be employed. With this method, for example, the electronic watermark data to be supplied are embedded by rounding off the value of the scale factor or the spectrum to an even number or an odd number.

According to this method, by using an electronic watermark, for example, a coding selection signal is embedded as a signal acting as the external switch signal into an audio signal that is located at the first position of every predetermined interval. Then, the MPEG-2 AAC bit stream compressed and encoded by the MPEG-2 AAC encoder is obtained.

For decoding of this encoded signal, it is only necessary that the coding selection signal embedded as the electronic watermark information is detected to obtain a Huffman code book select signal selecting an appropriate Huffman code book based on this detected signal.

An explanation has been given for the method whereby the external switch signal is supplied as a coding selection signal encrypted by electronic watermarking. As an example method that does not employ the electronic watermark, data based on the external switch signal are encrypted and written into data_stream_element which is defined according to the MPEG-2 AAC encoding system.

Then, according to this method, the audio signal decoding apparatus decodes data_stream_element to obtain the information, and employs this information to generate a Huffman code book select signal.

In this case, data related to the external switch signal written to the data_stream_element need only to be matched between the encoding side and the decoding side, the transmission and the reception of the external switch signal may be performed to set an appropriate encryption system for the encoding side and decoding side.

An explanation has been given for the variable length data encoding method and the variable length data decoding method for both the picture signal and the audio signal, whereby the standard variable length table and the special variable length table are employed to perform the variable length coding for the coefficient value signal that is obtained through the orthogonal transform, and thus, the picture signal and the audio signal with slight distortion can be reproduced. The addition of the distortion to the picture signal and/or the audio signal can be individually determined using the standard or the special variable length table.

Next, an explanation will now be given about a preferable embodiment for a business model that can be used for broadcasting, communication or a data recording medium while employing the variable length data encoding method and the decoding method, and especially, encoding of picture data will be mainly described.

### Eighth Embodiment

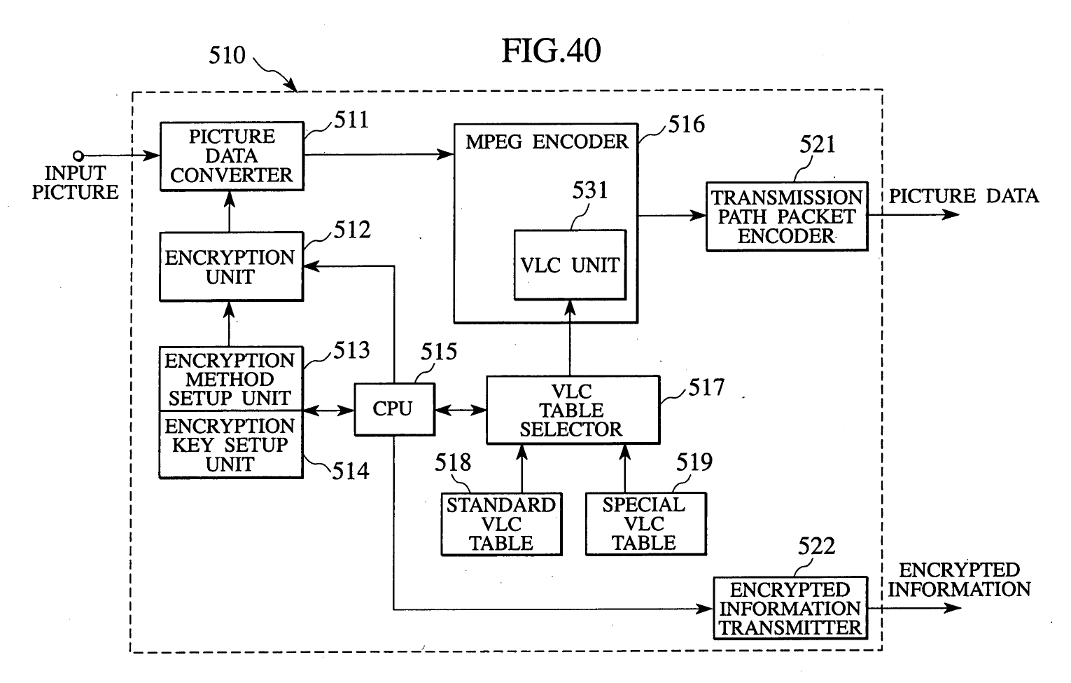

FIG. 40 shows a configuration of a variable length encoded data transmitter (hereinafter may be referred to simply as a transmitter) according to an eighth embodiment on which a variable length data encoding method used for broadcasting or communication and for half-disclosure is mounted. Description will be made by referring to this drawing.

A variable length encoded data transmitting apparatus 510 shown in the drawing includes a picture data converter 511, an encryption unit 512, an encryption method setup unit 513, an encryption key setup unit 514, a CPU 515, an MPEG encoder 516, a VLC table selector 517, a standard VLC table 518, a special VLC table 519, a transmission path packet encoder 521, and an encrypted information transmitter 522. The MPEG encoder 516 includes a VLC unit 531.

Next, description will be made of an operation of the variable length encoded data transmitting apparatus 510 configured in the foregoing manner.

First, an input picture signal is supplied to the picture data converter 511, where an identification signal is embedded as electronic watermark information in the picture signal by the aforementioned method.

The picture signal in which the electronic watermark information has been embedded is supplied to the MPEG encoder 516, where a VLC table temporarily stored in the VLC unit 531 is used to generate a compressed and encoded signal by variable length coding or the like.

Then, the compressed and encoded signal is multiplexed with an audio signal (not shown), other auxiliary signals or the like at the transmission path packet encoder 521 in accordance with an MPEG system standard. Thus, the packetted signal is outputted as a transmission signal from the variable length encoded data transmitting apparatus 510.

At this time, the CPU 515 generates an identification signal for identifying which of the standard VLC table and the special VLC table is selected by the VLC table selector 517, and encrypted information regarding an encryption method for the identification signal and an encryption key for decrypting the encryption based on a coding selection signal supplied to the VLC table selector 517.

At the VLC table selector 517, based on the coding selection signal supplied from the CPU 515, either one of the standard VLC table and the special VLC table is selected, and the selected VLC table is supplied to the VLC unit 531 of the MPEG encoder 516.

At the encryption unit 512, identification information regarding the VLC table selected by the VLC table selector 517, and information regarding the encryption method set by the encryption method setup unit 513 and the encryption key set by the encryption key setup unit 514, all of the information being supplied through the CPU 515, are encrypted, and the encrypted pieces of information are supplied to the picture data converter 511.

Further, at the CPU 515, information as encrypted information indicating that encryption has been executed, the information regarding the encryption method set by the encryption method setup unit, and the information regarding the encryption key set by the encryption key setup unit are supplied to the encrypted information transmitter 522, and outputted as an encrypted information signal therefrom.

Accordingly, the picture signal in which the encrypted identification signal has been embedded by the electronic watermarking is supplied to the MPEG encoder 516. Then, the picture signal is subjected to compression and coding by using the VLC table specified by the coding selection signal corresponding to the embedded identification signal.

For example, when a coding selection signal supplied from the CPU 515 to the VLC table selector 517 is “0,” the standard VLC table is selectively obtained by the VLC table selector 517. The standard VLC table is supplied to the VLC unit 531 of the MPEG encoder 516 to be temporarily stored therein.

At this time, a bit string of 64 bits “0101 . . . 0101” indicating that the standard VLC table is selected is supplied as identification information from the CPU 515 to the encryption unit 512. Then, at the encryption unit 512, data encryption standard (DES: International Defacto Standard Data Encryption Standard) codes set by the encryption method setup unit 513, and encryption key 64 bits (8 bits of which are parity bits) set by the encryption key setup unit 514 are used to encrypt the identification information.

Then, the encrypted identification information is embedded as electronic watermark information in the input picture signal to be supplied to the MPEG encoder 516. Herein, the supplied signal is subjected to compression and coding by using the standard VLC table temporarily stored in the VLC unit 531.

When a coding selection signal is “1,” the special VLC table is obtained by the VLC table selector 517. The table is supplied to the VLC unit 531 of the MPEG encoder 516 to be temporarily stored therein. At this time, a bit string of 64 bits “1010 . . . 1010” indicating that the special VLC table is selected is supplied as identification information from the CPU 515 to the encryption unit 512.

Then, at the encryption unit 512, DES codes set by the encryption method setup unit 513, and a DES encryption key of 64 bits set by the encryption key setup unit 514 are used to encrypt the identification information. Then, the encrypted identification information is embedded as electronic watermark information in the input picture signal, and subjected to coding by using the special VLC table temporarily stored in the VLC unit 531.

In this case, encrypted information is set to “0” when the identification information is not encrypted, and set to “1” when it is encrypted. If an encryption system can be selected from four, for example, a DES code is set to “00” and other three codes are set to “01,” “10,” and “11,” respectively. For the encryption key, encryption keys of 64 bits such as a key A, a Key B, a Key C, and a Key D which are preset keys are defined to be used.

Then, “00” is allocated to the Key A, “01” to the Key B, “10” to the Key C, and “11” to the Key D. Thus, the encrypted information is represented by a bit string of 5 bits “1 00 10” when the identification information is encrypted in DES codes by using the Key C.

Hereinbefore, the configuration and the operation of the variable length encoded data transmitter of the eighth embodiment have been described.

In the described case, the encrypted information may contain information regarding an encryption mode, information regarding a key length of the encryption key or the like to be transmitted.

Next, description will be made of a variable length encoded data receiver (hereinafter may be referred to simply as a receiver) which receives and decodes encoded data generated and transmitted in the foregoing manner.

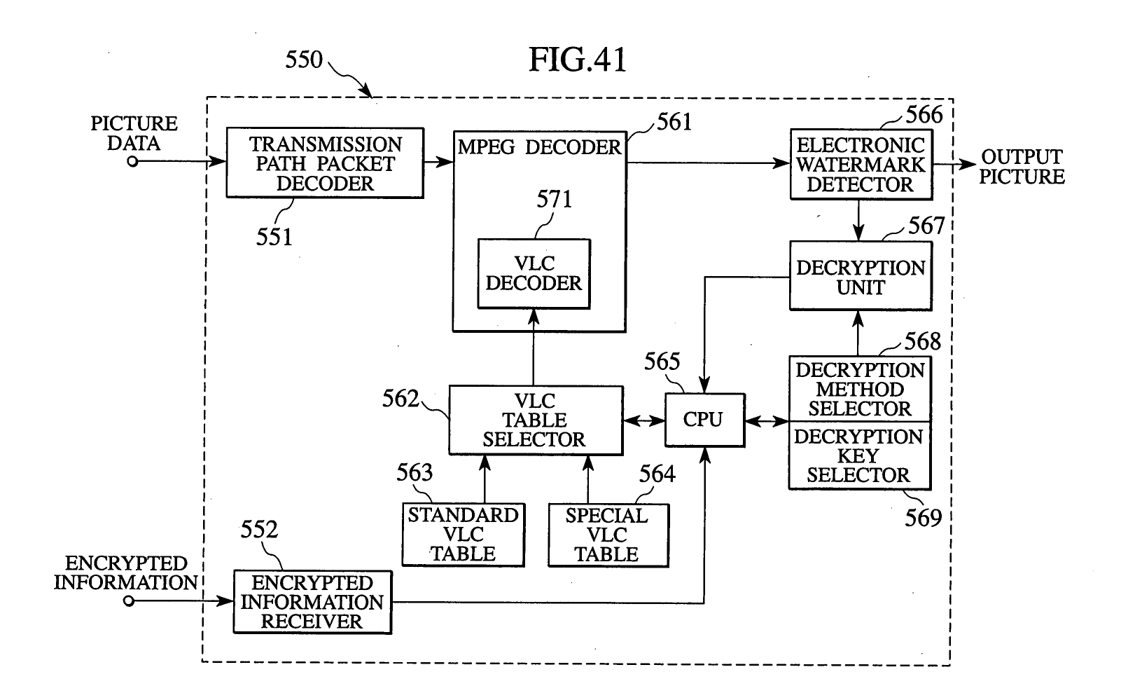

FIG. 41 shows a configuration of the variable length encoded data receiver of the eighth embodiment, and description will be made by referring to this drawing.

A variable length encoded data receiving apparatus 550 shown in the drawing includes a transmission path packet decoder 551, an encrypted information receiver 552, an MPEG decoder 561, a VLC table selector 562, a standard VLC table 563, a special VLC table 564, a CPU 565, an electronic watermark detector 566, a decryption unit 567, a decryption method selector 568, and a decryption key selector 569. The MPEG decoder 561 includes a VLC decoder 571.

Next, description will be made of an operation of the variable length encoded data receiving apparatus 550 configured in the foregoing manner.

First, the transmission path packet decoder 551 subjects packet encoded data structured by multiplexing to packet decoding by a complementary operation with the transmission path packet encoder 521. The compressed and encoded picture data obtained by the decoding is supplied to the MPEG decoder 561.

A signal compressed and encoded by the MPEG system is decoded by using a value of the VLC table temporarily stored in the VLC decoder 571, and by a method complementary to that of the MPEG encoder 516. Then, the picture signal obtained by the decoding is supplied to the electronic watermark detector 566.

The electronic watermark detector 566 detects the identification signal embedded as the electronic watermark information and encrypted by the picture data converter 511 of FIG. 40, and supplies it to the decryption unit 567.

Then, if it is determined based on the encrypted information received by the encrypted information receiver 522 that the detected electronic watermark information has been encrypted, the CPU 565 supplies information regarding an encryption method to the decryption method selector 568, and information regarding an encryption key to the decryption key selector 569.

The decryption method selector 568 selects a decryption method based on the information regarding the encryption method, and the decryption key selector 569 selects a decryption key based on information regarding the encryption key. Information of the decryption method and the decryption key that have been selected are used to decrypt the encrypted identification information at the decryption unit 567, and a signal obtained by the decryption is supplied to the CPU 565. The CPU 565 generates a coding selection signal corresponding to the decrypted identification information, and a signal thereof is supplied to the VLC table selector 562.

At the VLC table selector 562, either one of the standard VLC table and the special VLC table is selected based on the supplied coding selection signal to be supplied to the VLC decoder 571. The VLC table is temporarily stored in the VLC decoder 571.

For example, if encrypted information is obtained as a bit string of 5 bits “1 00 10,” at the variable length encoded data receiving apparatus 550, a bit string of 64 bits “b63b62b61 . . . b1b0” is first detected by the electronic watermark detector 566, and a signal of the detected bit string is supplied to the decryption unit 567.

Then, the CPU 565 determines that the identification information has been encrypted based on a most significant bit “1.” of the encrypted information of 5 bits “1 00 10” received by the encrypted information receiver 552. Then, based on lower 4 bits “00 10” of the encrypted information, a DES code is selected by the decryption method selector 568 and a Key C is selected by the decryption key selector 569 to be supplied to the decryption unit 567.

Moreover, at the decryption unit 567, the Key C is used in the DES code to decode the bit string of 64 bits “b63b62b61 . . . b1b0,” whereby data of “0101 . . . 0101” or “1010 . . . 1010” is obtained.

The CPU 565 generates coding selection signals “0” and “1” respectively for decoding results “0101 . . . 0101” and “1010 . . . 1010,” and the generated signals are supplied to the VLC table selector 562. The VLC table selector supplies the standard VLC table when the coding selection signal is “0” and the special VLC table when it is “1” to the VLC decoder 571.

Thus, the VLC table temporarily stored in the VLC decoder 571 is used, and the supplied encoded data is decoded at the MPEG decoder 561. The decoding is carried out by using the same VLC table as that temporarily stored in the VLC unit 531 of the MPEG encoder 516 of FIG. 40. Thus, a picture signal with no deterioration is decoded.

The method has been described which embeds the encrypted identification signal as the electronic watermark in the picture data and transmits it, and receives the transmitted signal by the variable length encoded data transmitting apparatus 510 and the variable length encoded data receiving apparatus 550 of the eighth embodiment.

The method for embedding the encrypted identification signal in the picture signal has been described above. However, the embedding of the identification signal is not limited to the picture signal. It may be embedded as electronic watermark data in an audio signal by the aforementioned method. Additionally, a method may be employed to embed identification signals as independent identification data in picture data and audio data to transmit them.

Next, description will be made of a variable length encoded data receiver when the signal transmitted from the variable length encoded data transmitting apparatus 510 of the eighth embodiment is charged to be received.

### Ninth Embodiment

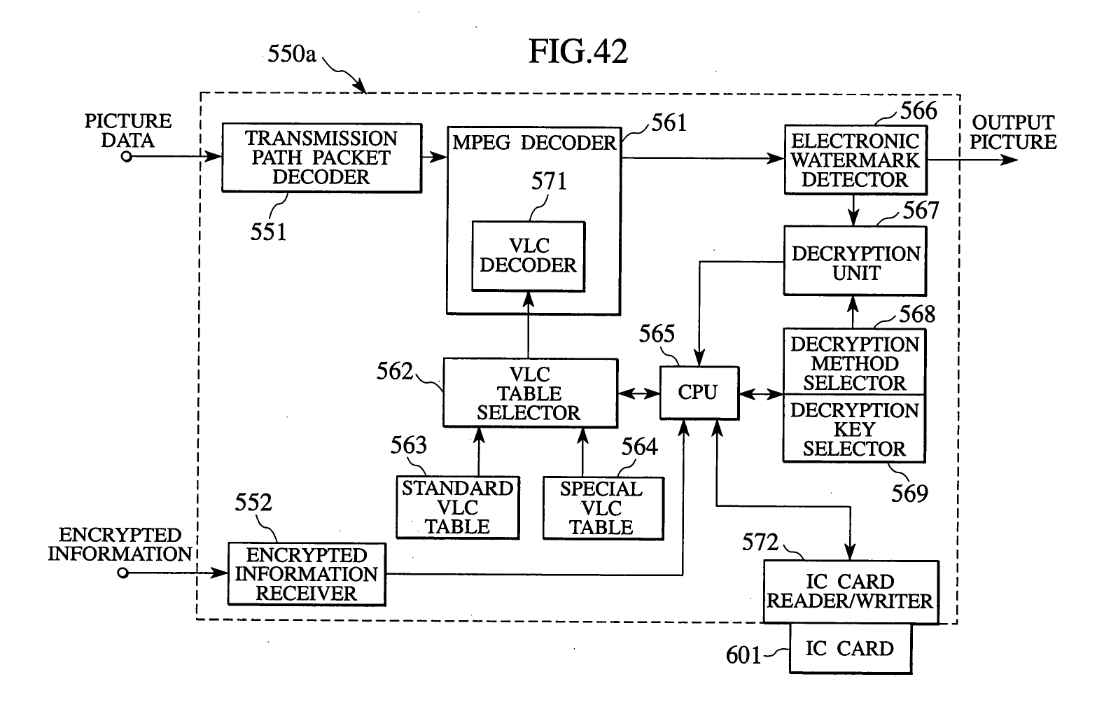

FIG. 42 shows a configuration of a variable length encoded data receiver of a ninth embodiment, and description will be made by referring to this drawing.

A variable length encoded data receiving apparatus 550a shown in the drawing is different from the variable length encoded data receiving apparatus 550 in that many IC card readers/writers 572 are arranged.

Portions having the same functions those of FIG. 41 are denoted by the same reference numerals. The IC card reader/writer 572 is connected to a CPU 565, and an IC card 601 is inserted therein.

Next, regarding the variable length encoded data receiving apparatus 550a configured in the foregoing manner, description will be made of an operation different from that of the variable length encoded data receiving apparatus 550.

First, an electronic watermark detector 566 detects the identification signal embedded as the electronic watermark information and encrypted by the picture data converter 511 of the variable length encoded data transmitting apparatus 510, and supplies it to a decryption unit 567.

Then, if it is determined based on encrypted information received by an encrypted information receiver 522 that the detected electronic watermark information has been encrypted, the CPU 565 supplies information regarding an encryption method to a decryption method selector 568, and information regarding an encryption key to a decryption key selector 569.

In this case, the CPU 565 decides whether or not to carry out decoding based on money value information recorded on an IC card through an IC card reader/writer 572 and charging information at the time of reproduction. Then, based on the result, a coding selection signal obtained by the decryption unit 567 corresponding to the identification information is supplied to a VLC table selector 562, or a coding selection signal not corresponding to the identification signal is supplied to the VLC table selector 562.

For example, it is assumed that the IC card is a prepaid type, and money value information of 6000 yen has been recorded in advance. When charging is carried out at a rate of, e.g. 1 yen/minute, during decoding of information to be transmitted, the CPU 565 reduces the money value information in the IC card by 1 yen each time the decryption unit 567 decodes encrypted information for 1 minute.

At a time point when the money value information in the IC card 601 becomes 0 yen, the CPU 565 supplies “1” when a coding selection signal corresponding to identification information obtained after decoding of a code by the decryption unit 567 is “0,” and “0” when it is “1” to the VLC table selector 562.

At the VLC table selector 562, a standard VLC table or a special VLC table is selected based on the supplied coding selection signal, and the selected table is supplied to a VLC decoder 571. Accordingly, when the money value information becomes 0 yen in the IC card, a VLC table different from that during encoding is supplied to the VLC decoder 571 thereafter and high-quality images are not reproduced.

As information recorded on the IC card 601, information for identifying a user is recorded in addition to the money value information. The CPU 565 supplies a correct coding selection signal to the VLC table selector only for a specific user.

Further, information regarding various reproduction conditions preferred by the user may be recorded on the IC card 601. Thus, the CPU 565 may supply a correct coding selection signal to the VLC table selector only when the reproduction conditions from the IC card 601 are satisfied.

Alternatively, information (seed) as a basis for a decoding key necessary for decoding the encrypted identification information, or information regarding an encryption algorithm may be recorded on the IC card 601. Accordingly, only when the IC card 601 is used, the identification information may be correctly decoded, and a correct coding selection signal may be supplied from the CPU 565.

Furthermore, money value information, user information or reproduction condition information may be obtained from the outside of the variable length encoded data receiving apparatus 550a through the Internet by using a modem other than the IC card 601, or by an input operation of a user himself who uses an operation remote control button of the variable length encoded data receiving apparatus 550a. Then, based on such conditions, a correct coding selection signal may be supplied to the VLC table selector 562.

According to the variable length encoded data receiving apparatus 550a of the ninth embodiment, only when predetermined conditions are satisfied, the same VLC table as that during encoding is supplied to the VLC decoder 571 in the MPEG decoder 561 to decode the encoded picture data. Thus, a high-quality picture signal can be obtained from the receiver.

If the receiver has no function of detecting picture electronic watermark information, if it has no function of decoding the electronic watermark information, or if it has no special VLC table, the standard VLC table is used to decode the encoded data. Thus, a picture signal which contains a distortion component based on a difference between the VLC tables is decoded in this case.

Moreover, even if the receiver has a function of reading the electronic watermark information, decoding it by a proper method, and decoding the encoded data based on a predetermined VLC table, unless set conditions of charging and the like are satisfied, a VLC table different from that during the encoding is supplied. Consequently, the decoded picture signal contains a distortion component based on a difference between the VLC tables.

Thus, when a copyright holder who has a copyright of contents supplies different quality picture signals to a special receiver which has a contract relation regarding the held contents, and a general receiver which has no contract relation with a receiver which satisfies specific conditions, or a receiver which does not satisfy specific conditions, a picture electronic watermark detector, an identification information decoder, and a special VLC table are mounted on the special receiver, and a controller capable of supplying a VLC table proper for decoding to the decoder is disposed. Thus, different quality picture signals can be supplied to a general user and a special user.

The configuration and the operation of the variable length encoded data receiver of the ninth embodiment have been described above.

### Tenth Embodiment

Next, description will be made of a variable length encoded data transmitter and a variable length encoded data receiver of a tenth embodiment.

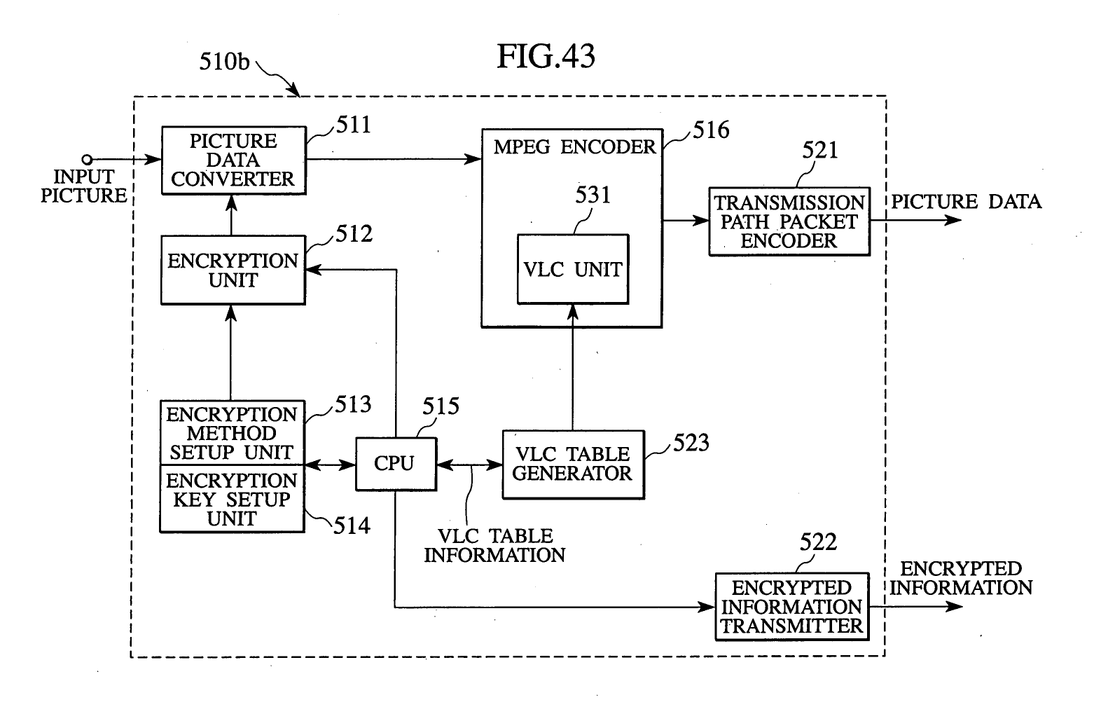

FIG. 43 shows a configuration of the variable length encoded data transmitter of the tenth embodiment, and description will be made by referring to this drawing.

A variable length encoded data transmitting apparatus 510b shown in the drawing is different from the variable length encoded data transmitting apparatus 510 of the eighth embodiment shown in FIG. 40 in that a VLC table selector 517, a standard VLC table 518, and a VLC table generator 523 are arranged in place of the special VLC table 519.

Components having the same functions are denoted by the same reference numerals.

Next, description will be made of an operation of the variable length encoded data transmitting apparatus 510b configured in the foregoing manner.

First, an input picture signal is supplied to an picture data converter 511, where an encrypted identification signal is embedded as electronic watermark information to be supplied to an MPEG encoder 516. Then, compression and encoding are carried out based on a VLC table temporarily stored in a VLC unit 531, and the signal is subjected to packetting intrinsic to a transmission path at a transmission path packet encoder 521 to be outputted.

Then, at a VLC table generator 523, a VLC table is generated to be supplied to the VLC unit 531 of the MPEG encoder 516. The generated VLC table is encrypted at an encryption unit 512 by using an encryption method set by an encryption method setup unit 513 and an encryption key set by an encryption key setup unit 514. The encrypted code table is supplied to the picture data converter 511.

A CPU 515 supplies information as encrypted information indicating that encryption has been executed, information regarding the encryption method set by the encryption method setup unit 513, and information regarding the encryption key set by the encryption key setup unit 514 to an encrypted information transmitter 522. Then, an encrypted information signal is outputted therefrom.

In this case, as the encrypted information, for example, “0” is set when the VLC table is not encrypted, and “1” is set when it is encrypted. If four encryption systems can be selected, a DES code is set to “00”, three other codes are set to “01,” “10,” and “11,” and 64-bit encryption keys of a Key A, a key B, a Key C and a Key D are preset for these codes.

Then, if the Key A is “00,” the Key B is “001,” the Key C is “10” and the Key D is “11,” encrypted information is represented by a bit string of 5 bits “1 00 10” when the VLC table information is encrypted in the DES code by using the Key C.

Thus, a picture signal in which information regarding the encrypted VLC table has been embedded by the electronic watermarking method is supplied to the MPEG encoder 516. Then, the picture signal is subjected to compression and encoding by using the embedded VLC table.

Next, description will be made of the variable length encoded data receiver which receives and decodes the encoded data generated and transmitted in the foregoing manner.

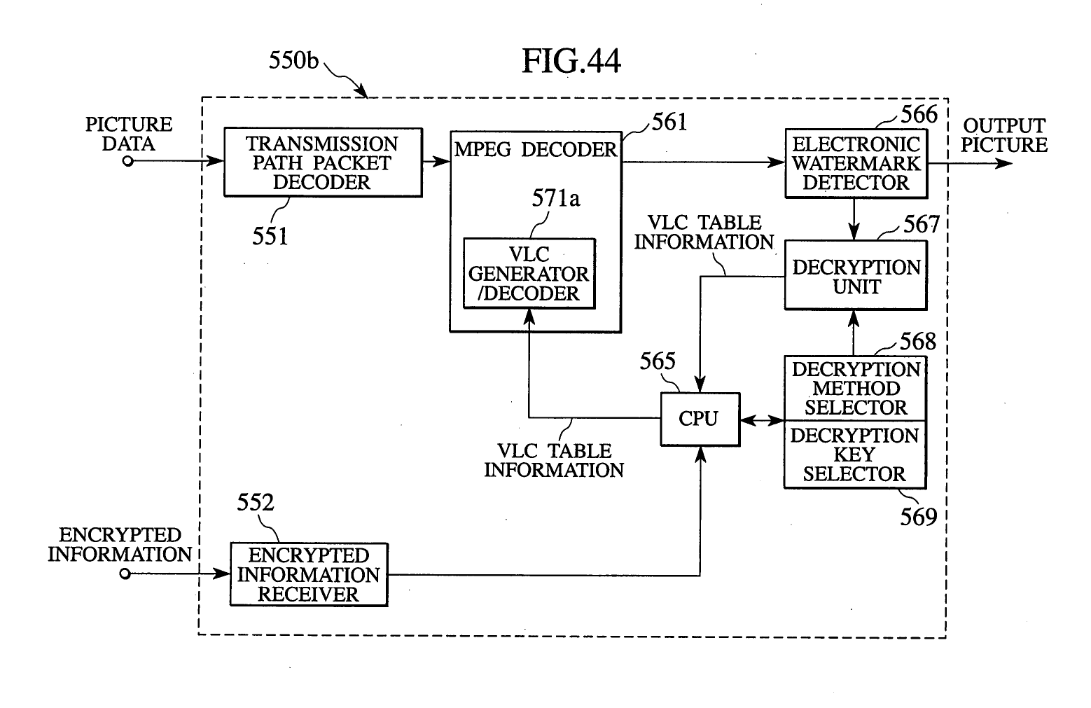

FIG. 44 shows a configuration of a variable length encoded data receiving apparatus 550b of the tenth embodiment, and description will be made by referring to this drawing.

The variable length encoded data receiving apparatus 550b shown in the drawing is different from the variable length encoded data receiving apparatus 550 of the eighth embodiment shown in FIG. 41 in that the VLC table selector 562, the standard VLC table 563, and the special VLC table 564 are not disposed.

A VLC generator/decoder 571a is disposed in place of the VLC decoder 571. Note that the same reference numerals are attached to the same functional blocks.

Next, description will be made mainly of an operation of the variable length encoded data receiving apparatus 550b different from that of the eighth embodiment.

First, electronic watermark information detected by an electronic watermark detector 566 is supplied to a decryption unit 567. Then, when it is determined based on encrypted information received by an encrypted information receiver 552 that the detected electronic watermark information has been encrypted, a CPU 565 supplies information regarding an encryption method to a decryption method selector 568, and information regarding an encryption key to a decryption key selector 569.

The decryption method selector 568 selects a predetermined decoding method based on the information regarding the encryption method, and the decryption key selector 569 selects a predetermined decoding key based on the information regarding the encryption key. Information of the decoding method and the decoding key that have been selected are supplied through the CPU 565 to the VLC generator/decoder 571a.

The VLC generator/decoder 571a generates the same VLC table as that generated at the VLC table generator 523 based on the supplied information. Then, at the MPEG decoder 561, the VLC table generated by the VLC generator/decoder 571a is used to decode the encoded data.

Thus, according to the variable length encoded data transmitting apparatus 510b and the variable length encoded data receiving apparatus 550b of the tenth embodiment, the information regarding the encrypted VLC table is embedded as the electronic watermark in the picture data to be transmitted and received.

Next, description will be made of another variable length encoded data receiver which receives a signal transmitted by the variable length encoded data transmitting apparatus 510b of the tenth embodiment.

### Eleventh Embodiment

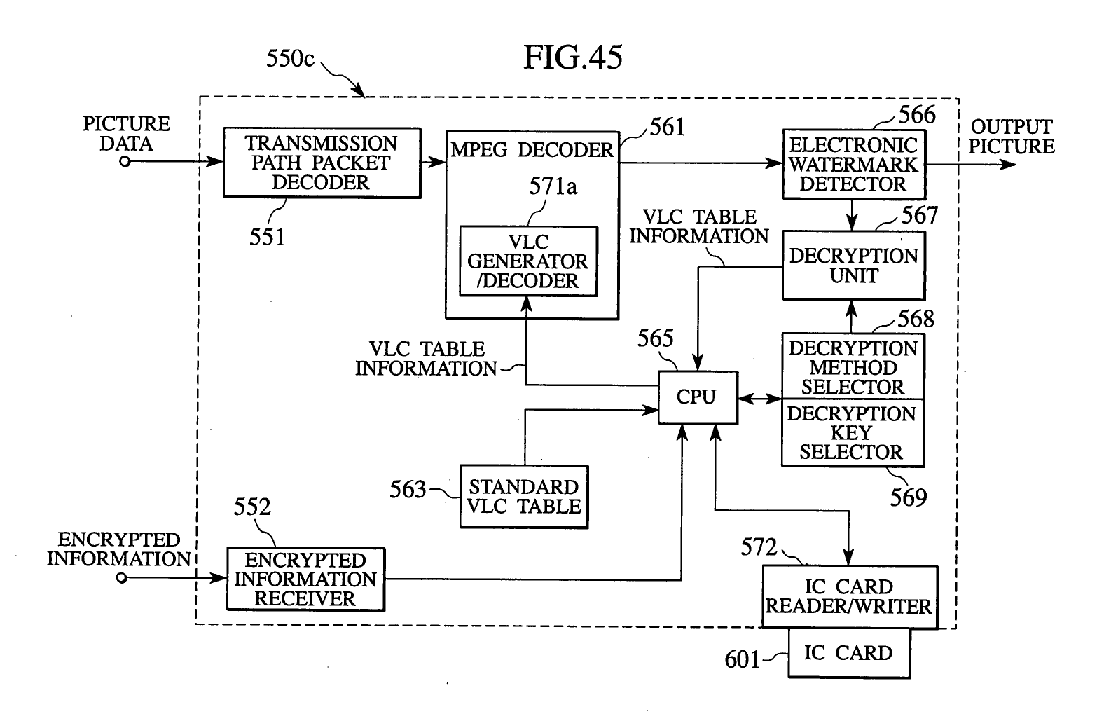

FIG. 45 shows a constitution of a variable length encoded data receiver of an eleventh embodiment, and description will be made of its operation by referring to this drawing.

A variable length encoded data receiving apparatus 550c shown in the drawing is different from the variable length encoded data receiving apparatus 550 shown in FIG. 41 in that the VLC table selector 562 and the special VLC table 564 are not arranged.

A VLC generator/decoder 571a is arranged in place of the VLC decoder 571. Another difference is that an IC card reader/writer 572 is arranged, and an IC card 601 is inserted therein. Portions having functions similar to those of FIG. 41 are denoted by similar reference numerals.

Next, description will be made mainly of an operation of the variable length encoded data receiving apparatus 550c constructed in the foregoing manner different from that of the eighth embodiment.

First, an electronic watermark detector 566 detects embedded electronic watermark information, and supplies it to a decryption unit 567. If the detected electronic watermark information has been encrypted, a CPU 565 supplies information regarding an encryption method to a decryption method selector 568, and information regarding an encryption key to a decryption key selector 569.

In this case, the CPU 565 obtains money value information and information regarding reproduction conditions from an IC card through an IC card reader/writer 572, and decides whether or not to execute decoding or not based on the obtained information. If the decoding is executed, a VLC table obtained by decoding a code is supplied to the VLC decoder 571.

In this case, a reproduction operation including an IC prepaid card is similar to that of the ninth embodiment. Since a standard VLC table 563 is connected to the CPU 565, during normal reproduction, a table stored in the standard VLC table 563 is supplied to the VLC generator/decoder 571a to decode compressed and encoded picture data.

Then, if decoding executed by using a special VLC table is permitted, the VLC generator/decoder 571a creates a special VLC table based on input VLC table information to decode an image without quality deterioration.

The constitutions and the operations of the variable length encoded data transmitting apparatus and the variable length encoded data receiver of the eleventh embodiment have been described.

Next, description will be made of a constitution and an operation of a variable length encoded data reproducer which records and reproduces a signal generated by a variable length encoded data recorder on a recording medium.

### Twelfth Embodiment

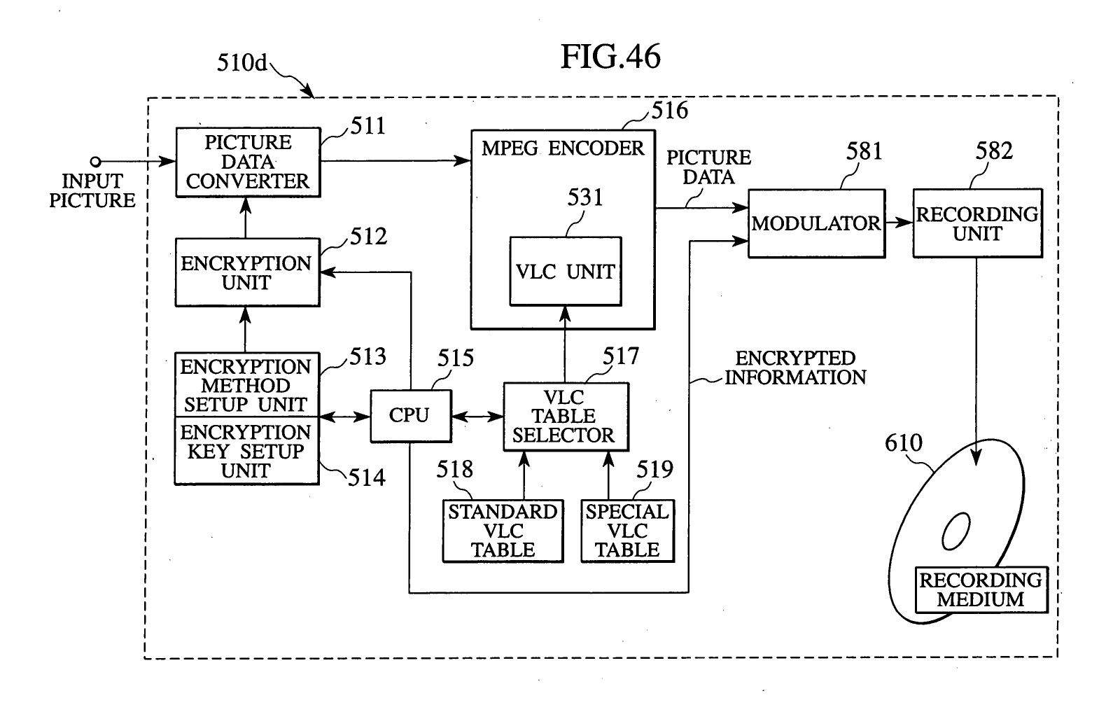

FIG. 46 shows a constitution of a variable length encoded data recorder of a twelfth embodiment, and description will be made by referring to this drawing.

A variable length encoded data recording apparatus 510d shown in the drawing is different from the variable length encoded data transmitting apparatus of the eighth embodiment shown in FIG. 40 in that a modulator 581 and a recording unit 582 are arranged in place of the transmission path packet encoder 521 and the encrypted information transmitting apparatus 522. Additionally, a recording medium 610 is inserted into the variable length encoded data recording apparatus 510d.

Similar functional portions are denoted by similar reference numerals.

Next, description will be made mainly of a portion of an operation of the variable length encoded data recorder (may simply be referred to as a recorder, hereinafter) constructed in the aforementioned manner different from that of the eighth embodiment.

First, an input picture signal is inputted to a picture data converter 511, and an encrypted identification signal is embedded as electronic watermark information. Then, the picture signal in which the electronic watermark information has been embedded is supplied to an MPEG encoder 516, and subjected to compression and encoding based on a VLC table temporarily stored in a VLC unit 531. The encoded picture data and encrypted information outputted from a CPU 515 are inputted to the modulator 581.

Then, digital modulation is carried out to record the picture data and the encrypted information on the recording medium 610. An error correction signal for correcting error signals is added when necessary. Then, the digitally modulated signal is supplied to the recording unit 582, where a signal is generated for recording on the recording medium 610 by, e.g., light intensity modulation of a laser beam. The signal is radiated to the recording medium 610 such as a DVD, and recorded.

Accordingly, on the recording medium 610, encrypted information regarding an encryption method and an encryption key in which an identification signal for identifying which of a standard VLC table 518 and a special VLC table 519 is selected by the VLC table selector 517 is encrypted, and compressed and encoded picture data are recorded.

In this case, the encrypted information may be time-division multiplexed with the encoded data of the modulated picture signal to be recorded. Such signals may be recorded in different areas on the recording medium, or they may be recorded on a plurality of recording media.

Next, description will be made of the variable length encoded data reproducer which reproduces and decodes the data recorded on the recording medium in the foregoing manner.

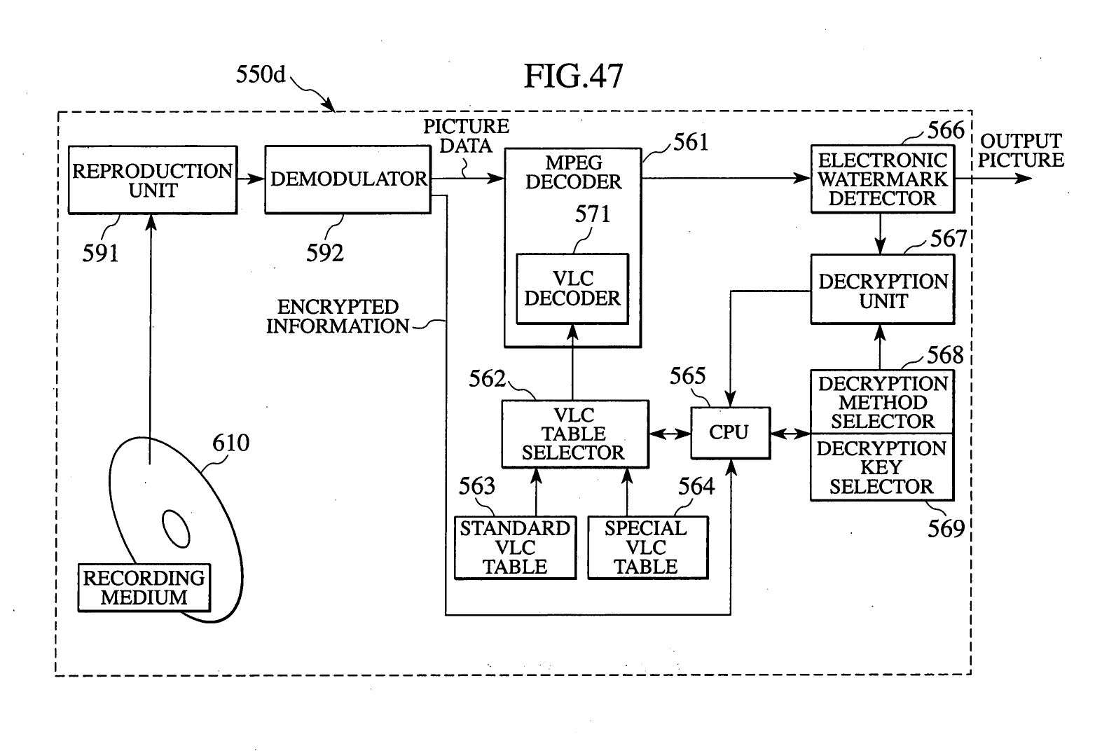

FIG. 47 shows a constitution of a variable length encoded data reproducer of a twelfth embodiment, and description will be made by referring to this drawing.

A variable length encoded data reproducing apparatus 550d shown in the drawing is different from the variable length encoded data receiver of the eighth embodiment shown in FIG. 41 in that a reproduction unit 591 and a demodulator 592 are arranged in place of the transmission path packet decoder 551 and the encrypted information receiver 552. Additionally, a recording medium 610 is inserted into the variable length encoded data reproducing apparatus 550d.

Similar functional portions are denoted by similar reference numerals.

Next, description will be made mainly of a portion of an operation of the variable length encoded data reproducer (may simply be referred to as a reproducer, hereinafter) constructed in the foregoing manner different from that of the eighth embodiment.

First, the recording medium 610 on which data has been recorded by the recording apparatus 510d is loaded on a loading portion (not shown) of the reproducing apparatus 550d. The recording medium 610 is radiated with, e.g., a laser beam, to read the recorded signal therefrom by the reproduction unit 591.

The read signal is supplied to the demodulator 592, where signal processing complementary to that of the modulator 581 is carried out, and compressed and encoded picture data and encrypted information are demodulated to be obtained.

Then, the encrypted information is supplied to a CPU 565, and the compressed and encoded picture data is supplied to an MPEG decoder 561.

An operation thereafter is similar to that of the variable length encoded data receiver of the ninth embodiment shown in FIG. 42.

The constitutions and the operations of the recorder and the reproducer of the twelfth embodiment have been described. Next, other embodiments of the reproducer will be described.

### Thirteenth Embodiment

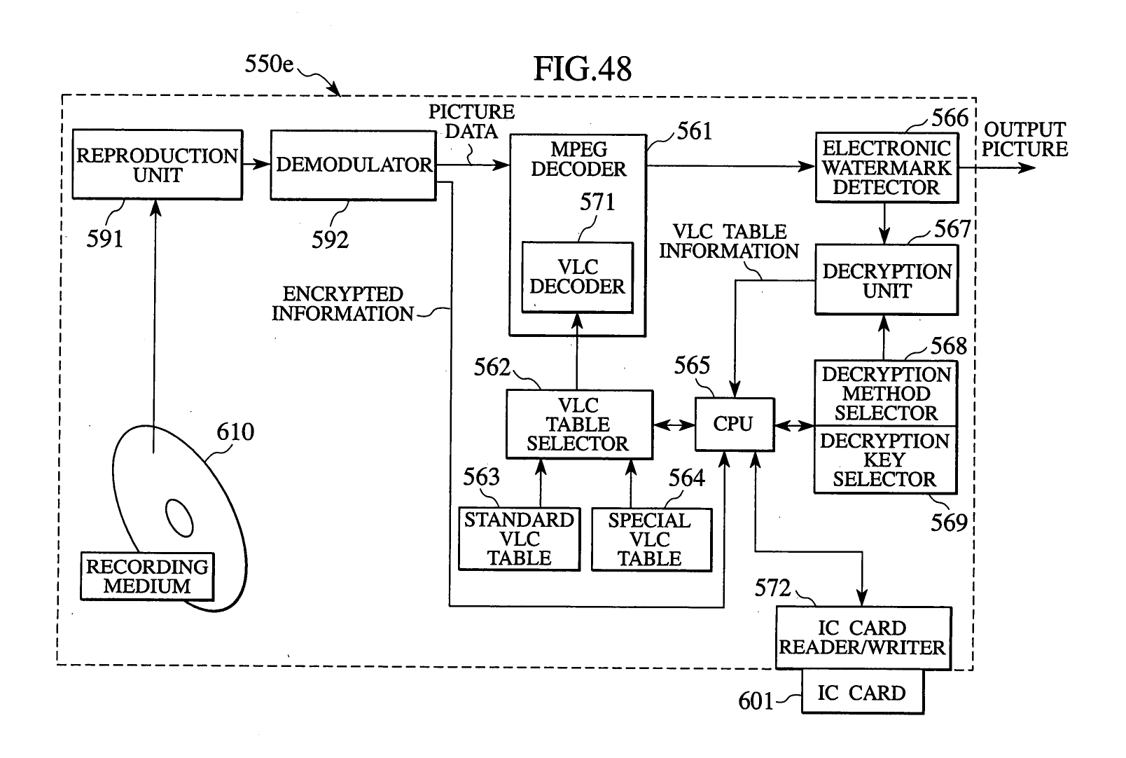

FIG. 48 shows a constitution of a reproducer of a thirteenth embodiment used in combination with the recorder of the twelfth embodiment.

A variable length encoded data receiving apparatus 550e shown in the drawing is different from the receiving apparatus 550b of the tenth embodiment shown in FIG. 44 in that an IC card reader/writer 572 and an IC card 601 inserted therein are arranged. Similar functional blocks are denoted by similar reference numerals.

Next, description will be made mainly of a portion of an operation of the reproducing apparatus 550e constructed in the aforementioned manner different from that of the reproducing apparatus 550d.

That is, in the reproducing apparatus 550e, functions realized by the IC card reader/writer 572 and the IC card 601 inserted therein which have been described above with reference to the eleventh embodiment of FIG. 45 are added.

Thus, when a predetermined chargeable money value is stored in the IC card 601 and predetermined reproduction conditions are satisfied, a VLC table identical to that during the encoding by the MPEG encoder 516 of the recording apparatus 510d is supplied to a VLC decoder 571 in an MPEG decoder 561. Since input decided picture data are decoded by using this table, a high-quality picture signal is obtained in this case.

Then, contents such as picture data of which a copyright holder has the copyright can be supplied as different quality picture signals. The signals can be supplied to a special reproducer which has a contract relation and a reproducer which satisfies specific conditions, or to a general reproducer which has no contract relation and a reproducer which does not satisfy specific conditions such as a shortage of charging information.

Additionally, a picture electronic watermark detector, an identification information decoder, and a special VLC table are mounted on the special reproducer, and a controller is disposed to be able to supply a VLC table proper for decoding to the decoder. Thus, recording media which are identical but from which different quality picture signals are reproduced can be supplied to a general user and a special user.

The constitution and the operation of the variable length encoded data receiving apparatus 550e of the thirteenth embodiment have been described.

Next, description will be made of a recorder and a reproducer which switch VLC tables for an MPEG encoder and an MPEG decoder by using VLC table information.

### Fourteenth Embodiment

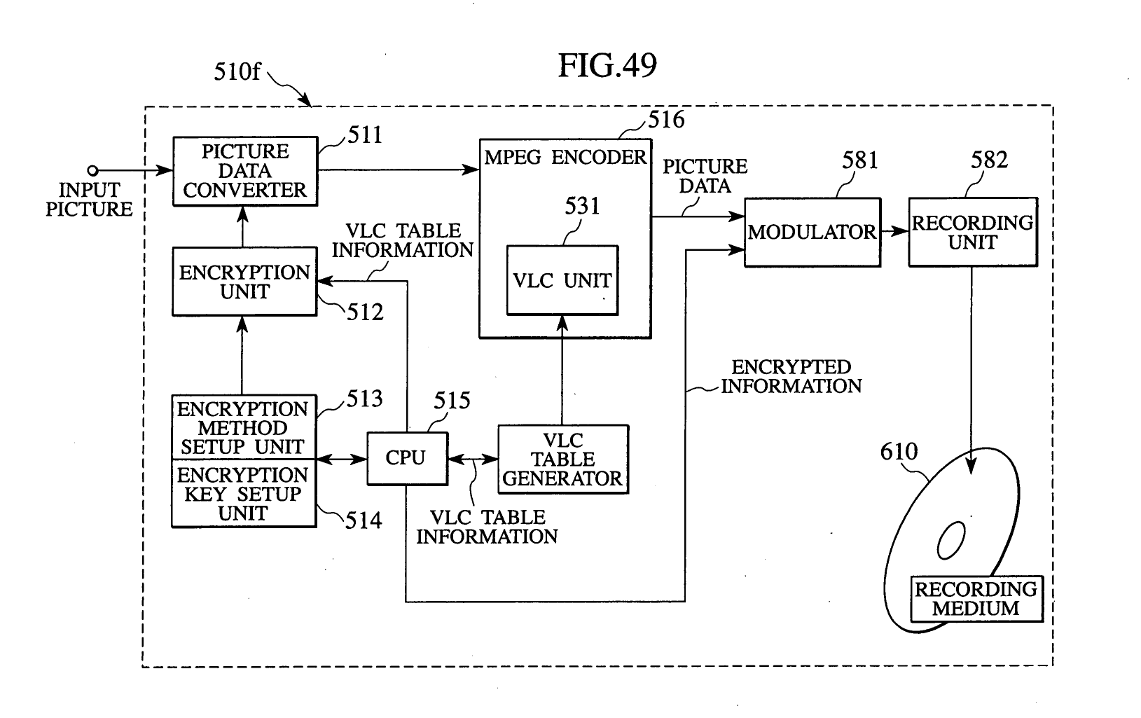

FIG. 49 shows a configuration of a variable length encoded data recording apparatus of a fourteenth embodiment, and description will be made thereof by referring to this drawing.

A variable length encoded data recording apparatus 510f shown in the drawing is different from the transmitting apparatus 510b of the tenth embodiment shown in FIG. 43 in that a modulator 581 and a recording unit 582 are arranged in place of the transmission path packet encoder 521 and the encrypted information transmitter 522. Additionally, a recording medium 610 is inserted into the variable length encoded data recording apparatus 510f.

The portions having the same functions are denoted by the same reference numerals.

Next, description will be made mainly of a portion different from that of the tenth embodiment regarding an operation of the variable length encoded data recording apparatus 510f configured in the foregoing manner.

First, an input picture signal is inputted to a picture data converter 511, where an encrypted identification signal is embedded as electronic watermark information. The picture signal in which the electronic watermark information has been embedded is supplied to an MPEG encoder 516, and subjected to compression and encoding based on a VLC table temporarily stored in a VLC unit 531. The encoded picture data and encrypted information outputted from a CPU 515 are inputted to the modulator 581.

For the picture data and the encrypted information that have been inputted to the modulator 581, an operation similar to that of the twelfth embodiment shown in FIG. 41 such as recording on the recording medium 610 is carried out.

Next, description will be made of the variable length encoded data reproducer which reproduces and decodes the data recorded on the recording medium in the foregoing manner.

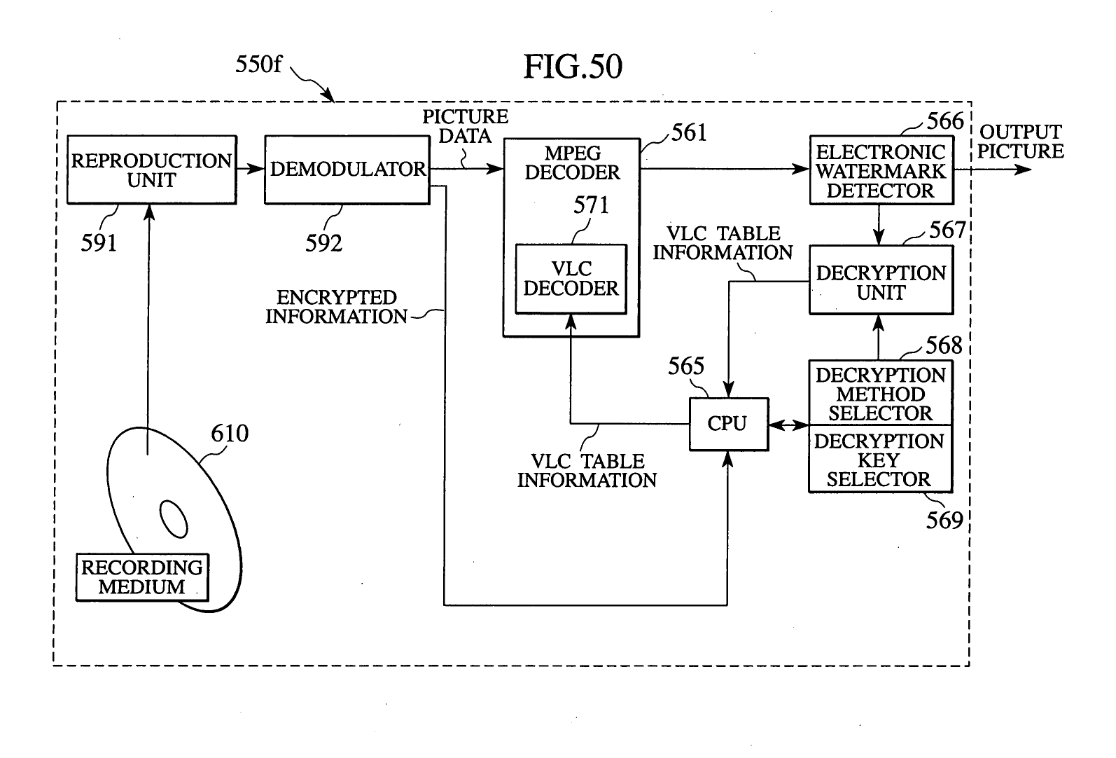

FIG. 50 shows a constitution of a variable length encoded data reproducing apparatus of a fourteenth embodiment, and description will be made by referring to this drawing.

A variable length encoded data reproducing apparatus 550f shown in the drawing is different from the variable length encoded data receiving apparatus 550b of the tenth embodiment shown in FIG. 44 in that a reproduction unit 591 and a demodulator 592 are arranged in place of the transmission path packet decoder 551 and the encrypted information receiver 552. Additionally, a recording medium 610 is inserted into the variable length encoded data reproducing apparatus 550f.

The portions having the same functions are denoted by the same reference numerals.

Next, description will be made mainly of a portion different from that of the tenth embodiment regarding an operation of the variable length encoded data recording apparatus configured in the foregoing manner.

First, the recording medium 610 on which data has been recorded by the recording apparatus 510f is loaded on a loading portion (not shown) of the reproducing apparatus 550f. The data is reproduced from the recording medium 610 by the reproduction unit 591 and the demodulator 592 to obtain compressed and encoded picture data and encrypted information.

Then, the encrypted information is supplied to a CPU 565, and the compressed and encoded picture data is supplied to an MPEG decoder 561.

An operation thereafter is similar to that of the variable length encoded data receiving apparatus 550b of the tenth embodiment shown in FIG. 44.

The configurations and the operations of the recording apparatus and the reproducing apparatus of the fourteenth embodiment have been described. Next, other embodiments with respect to the reproducing apparatus will be described.

### Fifteenth Embodiment

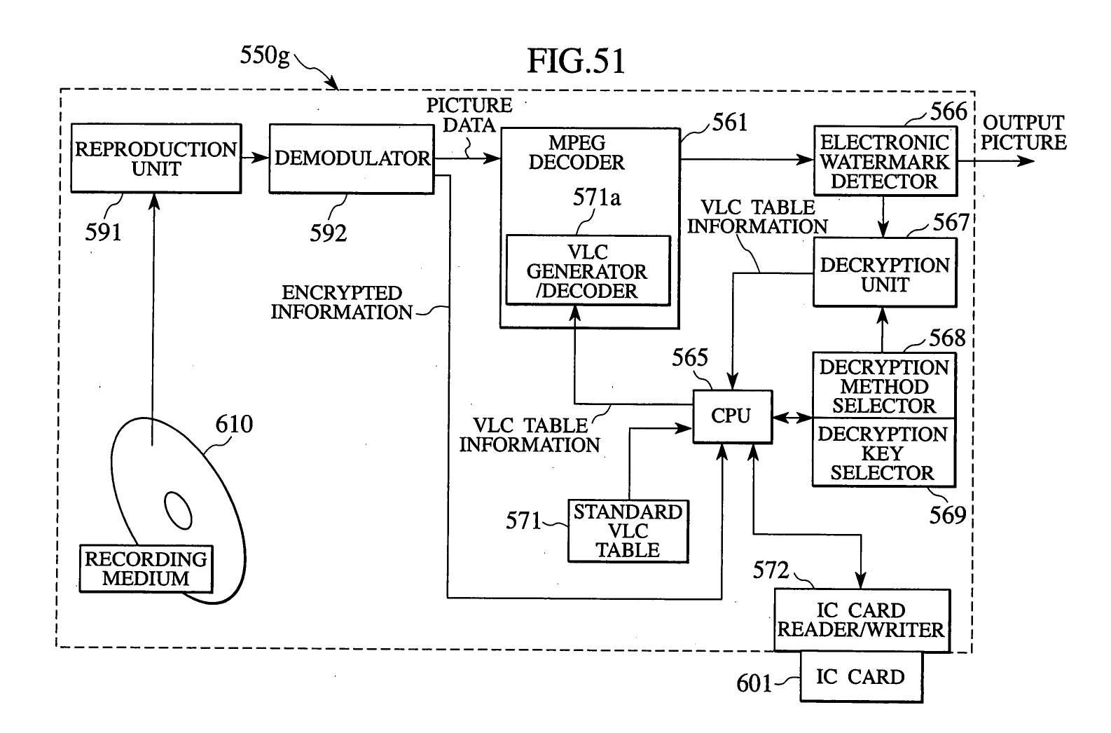

FIG. 51 shows a constitution of a reproducing apparatus of a fifteenth embodiment used in combination with the recording apparatus of the fourteenth embodiment.

A variable length encoded data reproducing apparatus 550g shown in the drawing is different from the receiving apparatus 550f of the fourteenth embodiment shown in FIG. 50 in that an IC card reader/writer 572 and an IC card 601 inserted therein are arranged, and a VLC generator/decoder 571a is arranged in place of the VLC decoder 571. Similar functional blocks are denoted by similar reference numerals.

Next, description will be made mainly for a portion of an operation of the reproducing apparatus 550g constructed in the aforementioned manner different from that of the reproducing apparatus 550f.

That is, in the reproducing apparatus 550g, functions realized by the IC card reader/writer 572 and the IC card 601 inserted therein which have been described above with reference to the thirteenth embodiment of FIG. 48 are added.

Thus, a predetermined chargeable money value is recorded in the IC card 601 and, when predetermined reproduction conditions are satisfied, a CPU 565 supplies VLC table information to the VLC generator/decoder 571a.

Then, if decoding executed by using a special VLC table is permitted, the VLC generator/decoder 571a creates a special VLC table, and the MPEG decoder 561 decodes an image without any quality deterioration.

The constitution and operation of the receiving apparatus of the fifteenth embodiment have been described.

Thus, different quality picture signals can be supplied to a reproducing apparatus which has a contract relation with a copyright holder who has the copyright of contents, and a reproducing apparatus which has no contract relation.

Additionally, only by supplying contents recorded on identical recording media by the copyright holder, recording media from which the contents can be reproduced as different quality picture signals can be supplied to a general user and a special user.

Regarding the encoding system which is carried out by the MPEG and which obtains a coefficient value signal by subjecting the picture signal and the acoustic signal to orthogonal transform, and subjects the obtained coefficient value signal to run length coding to execute encoding, the constitution and the operation of the decoder for reproducing information of contents with high-quality and the decoder for reproducing half-disclosed contents reproduced with distortion have been described by the first to fifteenth embodiments.

To reproduce such different quality contents, the present invention can be applied to an encoding system similar to the above which subjects the coefficient value signal obtained by the orthogonal transform to run length coding.

That is, as long as the system is a type which transforms a contents signal so as to concentrate information energy on predetermined information, and subjects information of a place in which energy of numerical value information obtained by the conversion is not concentrated to run length coding to execute compression and encoding, a method for encoding a run length regarding a numeral other than “0” may be employed.

Further, as the rule for exchanging the codes of the same code category with one another among the code tables of variable length codes, information including the run length and the level of the AC component in the case of the image, and the scale factor and the spectrum in the case of the audio has been described. However, in the case of a parameter or a syntax for changing the quality of the picture or the audio, any type of information is selected to be processed by the run length table created by the exchange of code information during encoding.

That is, even in the case of fixed length coding for information containing the run length or the level of the AC component for the image, and the scale factor or the spectrum for the audio, different quality picture signals can be supplied to the special reproducing apparatus which has a contract relation regarding contents held by the copyright holder who has the copyright of contents or the reproducing apparatus which satisfies specific conditions, and the general reproducing apparatus which has no contract relation or the reproducing apparatus which does not satisfy specific conditions.

Further, the method in which there are two or a plurality of code tables and the variable length coding is performed by selecting one of the tables has been described. Other than the method in which code tables are selected and used, the foregoing operation can be executed by a method in which there is only one code table and a part of written contents of the table is exchanged.

The coding selection signal for identifying the exchange of the code table can be implemented only by transmitting the number information for specifying a exchange rule, e.g., an algorithm number. Thus, the method realized by switching the tables is one of a plurality of means for realizing the aforementioned operation.

For the run length coding, any encoding method can be employed as long as encoding is carried out by, when an event of a small occurrence possibility is written by a redundancy-eliminated method in accordance with an occurrence possibility of numerical value information, accurately calculating the number of bits of numerical value information, and selecting a correct value or a value of approximate thereto as a numerical value written after the number information, for example similarly to Huffman coding.

Furthermore, the embodiment in which the invention is applied to variable length coding has been described mainly. However, the invention can be similarly applied to encoding which uses fixed length coding in place of the variable length coding. That is, although improvement on encoding efficiency is limited in the case of the fixed length coding, the aforementioned method can be used as a method for providing a plurality of different quality contents.

In such a case, the picture electronic watermark detector, the identification information decoder, and the function which has an algorithm for transforming a parameter or a syntax subjected to the fixed length coding by a special rule are mounted on the reproducing apparatus specified as special by the copyright holder.

Then, by providing the reproducing apparatus with the control function of supplying information regarding the parameter or the syntax for decoding the specially encoded signal to the special decoder, services of picture and audio signals, in which picture and audio signals are rendered to the general user and the special user with different quality while the signals are identical encoded data, can be available.

Thus, disclosure and half disclosure of contents are carried out for both cases of application to the fixed length coding and the variable length coding. That is, for example, even in the decoder of picture and audio signals compliant with the MPEG general standard, decoding is not interrupted by absurd errors such as a VLC error and, for the general reproducer, encryption transmission which has half-disclosure indication and sound generation effects for picture and audio signals can be carried out.

Then, the contents including at least any one of image and sound held by the copyright holder who has a copyright of contents can be supplied with different quality to different reproducing apparatuses: the special reproducing apparatus which has a contract relation or the reproducing apparatus which satisfies specific conditions and the general reproducing apparatus which has no contract relation or the reproducing apparatus which does not satisfy specific conditions.

Moreover, by mounting the picture electronic watermark detector, the identification information decoder, and the special VLC table on the special reproducing apparatus and providing the special reproducing apparatus with the control device capable of supplying the VLC table proper for decoding to the decoder, contents rendering services, in which picture and audio signals are rendered to the general user and the special user with different quality while the signals are identical encoded data, can be realized.

That is, a business model can be realized. In the business model, the contents are distributed and transmitted in a half-disclosed state by using the device, the method and the computer control program, and advertisement effects are promoted to increase user's willingness to buy. In the case of purchase, a reproduction method capable of identifying the special VLC table is provided, and the contents can be reproduced with high-quality.

Regarding the recording medium from which contents can be reproduced in the half-disclosed state, the recording medium of DVD mainly has been described. As long as the contents information can be recorded, the recording medium is not limited to the DVD-ROM, the DVD-RAM, the DVD-RW or the DVD-R. A digital recording medium such as a magneto-optical disk, a magnetic disk or a magnetic tape can be used.

Regarding the contents signal encoding system, the case has been described in which the transformed data obtained by subjecting the contents signal to orthogonal transform is quantized to obtain the coefficient value data, and the obtained coefficient value data are arrayed in the predetermined order to obtain the time-sequential data. For this encoding system, for example, other than the case of obtaining the coefficient value data by subjecting the contents to the orthogonal transform as in the case of the MPEG system, even in the case of the transform system which includes a technology other than orthogonal transform as in the case of the fractal encoding system, the functions similar to those of the embodiment can be realized.

That is, if encoding of the contents signal is carried out without dividing one picture into small blocks as in the case of, e.g., wavelet transform, compared with the method which uses orthogonal transform for dividing the picture into blocks to carry out DCT transform, there is an advantage that no distortion occurs on a block divided portion.

The wavelet transform is an encoding system which combines sub-band encoding for dividing a picture signal based on frequencies, and sampling the divided frequency band portions based on different sampling frequencies to execute encoding with the orthogonal transform.

As another encoding system, there is a method of vector quantization which divides a picture into small blocks, and encodes each divided block by a vector value.

If the picture data is transformed by any one of the aforementioned methods to obtain time-sequential data, and the time-sequential data can be generated as a compressed and encoded signal in which the amount of information is compressed by variable length coding, any method can be employed to transform the picture data into the time-sequential data.

That is, if information which is included in a contents signal such as a picture signal or an sound signal is transformed by a predetermined method, and energy (entropy) of the transformed contents is concentrated in a predetermined area, variable length coding can be carried out to write time-sequential data represented with the concentrated energy based on the number of numerical values of the data, and a level of a subsequent numerical value.

In all the encoding systems, it is possible to realize contents encoding and decoding methods by which the contents is represented as half-disclosed contents signals or by high fidelity so that the contents can be recorded and reproduced by an analog consumer device by using the plurality of variable length coding tables.

According to the variable length encoded data decoding method and the variable length encoded data decoder of the present invention, a coding selection signal specifying which of the variable length coding table and the exchange variable length coding table is used during the compression and encoding is detected, and the compressed and encoded signal is decoded by using the encoding table specified by the coding selection signal. Thus, it is possible to carry out decoding, to a high-quality contents signal, the compressed and encoded signal for certain with a security level being secured.

According to the variable length encoded data decoding method and the variable length encoded data decoder of the present invention, the coding selection signal specifying which of the variable length coding table and the exchange variable length coding table is used during the compression and encoding is detected and, when the coding selection signal specifies the exchange variable length table, an encoding table used for decoding is selected from the variable length coding table and the exchange variable length table. Thus, the following effects are provided.

(1) In the case of carrying out variable length decoding by using the exchange variable length coding table specified by the coding selection signal, high-quality contents are reproduced.

(2) In the case of carrying out variable length decoding not by using the exchange variable length coding table specified by the coding selection signal but by using the variable length coding table, contents are reproduced with a forcibly reduced quality (contents containing a distortion component are reproduced).

Thus, according to the variable length encoded data decoding method and the variable length encoded data decoder of the invention, decoding of contents with an ensured security level can be surely carried out.

Furthermore, according to the variable length data encoding method, the variable length data encoder, the variable length encoded data decoding method, and the variable length encoded data decoder of the present invention, the variable length coding which uses the exchange variable length coding table to decode predetermined contents with an ensured security level is carried out for desired contents to be encoded while preventing deterioration in encoding efficiency and the generation of error signals due to absurd operations during the decoding. Meanwhile, the variable length coding table is a generally used encoding table. Thus, it is possible to provide the variable length data encoding method and configuration of the variable length data encoder consistent with a market.

It should be understood that many modifications and adaptations of the invention will become apparent to those skilled in the art and it is intended to encompass such obvious modifications and changes in the scope of the claims appended hereto.

What is claimed is:

1. A variable length data encoding method for performing data transform, quantization and arrangement on a contents signal including at least any of a picture signal and a sound signal based on a predetermined method to obtain time series data, and obtaining a compressed and encoded signal by encoding the obtained time series data, the variable length data encoding method comprising:
a first step of obtaining a variable length coding table in which predetermined code words are written and allocated to a plurality of data values for the time series data;
a second step of generating an exchanged variable length coding table by exchanging, among code words written in the variable length coding table, the code words to which a same number of the time series data are allocated and differ from each other;
a third step of generating a coding selection signal for specifying an encoding table from any of the variable length coding table and the exchanged variable length coding table to be used for variable length coding; and
a fourth step of generating the compressed and encoded signal by the variable length coding on the time series data by use of the specified encoding table.

2. A variable length data encoding apparatus for performing data transform, quantization and arrangement on a contents signal including at least any of a picture signal and a sound signal based on a predetermined method to obtain time series data, and generating a compressed and encoded signal by encoding the obtained time series data, the variable length data encoding apparatus is configured by comprising:
variable length coding table obtaining means for obtaining a variable length coding table in which predetermined code words are written and allocated to a plurality of data values for the time series data;
exchanged variable length coding table generating means for generating an exchanged variable length coding table by exchanging, among code words written in the variable length coding table, the code words to which a same number of the time series data are allocated and differ from each other;
coding selection signal generating means for generating a coding selection signal for specifying an encoding table from any of the variable length coding table and the exchanged variable length coding table to be used for variable length coding; and
variable length coding means for generating the compressed and encoded signal by the variable length coding on the time series data by use of the specified encoding table.

3. A variable length encoded data decoding method for performing data transform, quantization and arrangement on a contents signal including at least any of a picture signal and a sound signal based on a predetermined method to obtain time series data, performing variable length coding to generate a compressed and encoded signal on which variable length decoding is performed to obtain the time series data, and decoding the obtained time series data to obtain the contents signal,
wherein the compressed and encoded signal is generated by performing the variable length coding on the time series data by use of an encoding table specified by a coding selection signal for specifying the encoding table from any of two encoding tables of a variable length coding table, in which predetermined code words are written and allocated to a plurality of data values for the time series data, and an exchanged variable length coding table, in which code words which have a same number as the time series data and are different from each other among the code words written in the variable length coding table are exchanged to be written therein, the variable length encoded data decoding method comprising:
a first step of detecting the coding selection signal;
a second step of obtaining the time series data by performing the variable length decoding on the compressed and encoded signal by using the encoding table specified based on the detected coding selection signal; and
a third step of obtaining the contents signal by decoding the time series data obtained in the second step.

4. A variable length encoded data decoding method for performing data transform, quantization and arrangement on a contents signal including at least any of a picture signal and a sound signal based on a predetermined method to obtain time series data, performing variable length coding to generate a compressed and encoded signal on which variable length decoding is performed to obtain the time series data, and decoding the obtained time series data to obtain the contents signal,
wherein the compressed and encoded signal is generated by performing the variable length coding on the time series data by use of an encoding table specified by a coding selection signal for specifying the encoding table from any of two encoding tables of a variable length coding table, in which predetermined code words are written and allocated to a plurality of data values for the time series data, and an exchanged variable length coding table, in which code words which have a same number as the time series data and are different from each other among the code words written in the variable length coding table are exchanged to be written therein, the variable length encoded data decoding method comprising:
a first step of detecting the coding selection signal;
a second step of selecting whether to perform the variable length decoding on the compressed and encoded signal by using the encoding table specified based on the detected coding selection signal or to perform the variable length decoding on the compressed and encoded signal by using the variable length coding table in disregard for use of the exchanged variable length coding table when the use of the table is specified by the detected coding selection signal;
a third step of obtaining the time series data by performing the variable length decoding on the compressed and encoded signal by use of the encoding table in accordance with a result of the selection in the second step; and
a fourth step of obtaining the contents signal by decoding the time series data obtained in the third step.

5. A variable length encoded data decoding apparatus for performing data transform, quantization and arrangement on a contents signal including at least any of a picture signal and a sound signal based on a predetermined method to obtain time series data, performing variable length coding to generate a compressed and encoded signal on which variable length decoding is performed to obtain the time series data, and decoding the obtained time series data to obtain the contents signal,
wherein the compressed and encoded signal is generated by performing the variable length coding on the time series data by use of an encoding table specified by a coding selection signal for specifying the encoding table from any of two encoding tables of a variable length coding table, in which predetermined code words are written and allocated to a plurality of data values for the time series data, and an exchanged variable length coding table, in which code words which have a same number as the time series data and are different from each other among the code words written in the variable length coding table are exchanged to be written therein, the variable length encoded data decoding apparatus comprising:
coding selection signal detecting means for detecting the coding selection signal;
variable length decoding means for performing the variable length decoding on the compressed and encoded signal by use of the encoding table specified based on the detected coding selection signal to obtain the time series data; and
contents signal decoding means for decoding the time series data obtain the variable length decoding means to obtain the contents signal.

6. A variable length encoded data decoding apparatus for performing data transform, quantization and arrangement on a contents signal including at least any of a picture signal and a sound signal based on a predetermined method to obtain time series data, performing variable length coding to generate a compressed and encoded signal on which variable length decoding is performed to obtain the time series data, and decoding the obtained time series data to obtain the contents signal,
wherein the compressed and encoded signal is generated by performing the variable length coding on the time series data by use of an encoding table specified by a coding selection signal for specifying the encoding table from any of two encoding tables of a variable length coding table, in which predetermined code words are written and allocated to a plurality of data values for the time series data, and an exchanged variable length coding table, in which code words which have a same number as the time series data and are different from each other among the code words written in the variable length coding table are exchanged to be written therein, the variable length encoded data decoding apparatus comprising:
coding selection signal detecting means for detecting the coding selection signal;
variable length coding table selecting means for selecting whether to perform the variable length decoding on the compressed and encoded signal by using the encoding table specified based on the detected coding selection signal or to perform the variable length decoding on the compressed and encoded signal by using the variable length coding table in disregard for use of the exchanged variable length coding table when the use of the table is specified by the detected coding selection signal;
variable length decoding means for obtaining the time series data by performing the variable length decoding on the compressed and encoded signal by use of the encoding table in accordance with a result of the selection by the variable length coding table selecting means; and
contents signal decoding means for obtaining the contents signal by decoding the time series data obtained by the variable length decoding means.
